(19) United States
(12) Patent Application Publication
(10) Pub. No.: US 2026/0104590 A1
(43) Pub. Date: Apr. 16, 2026

(54) SYSTEM AND METHOD FOR HEAD MOUNT DISPLAY REMOVAL PROCESSING

(71) Applicant: CANON U.S.A., INC., Melville, NY (US)

(72) Inventors: Xiwu Cao, Irvine, CA (US); Floyd Albert Maseda, Irvine, CA (US); Rui Xu, Irvine, CA (US); Quentin Florian Dietz, Irvine, CA (US); Bradley Scott Denney, Irvine, CA (US); Brian Ton, Irvine, CA (US); Winston Do, Irvine, CA (US); Ryuhei Konno, Irvine, CA (US); Peng Sun, Irvine, CA (US); Zi Zhang, Irvine, CA (US); Isabela Figueira, Irvine, CA (US)

(21) Appl. No.: 19/120,720

(22) PCT Filed: Oct. 20, 2023
(86) PCT No.: PCT/US2023/077428

§ 371 Date: Apr. 11, 2025

Related U.S. Application Data
(60) Provisional application No. 63/380,452, filed on Oct. 21, 2022.
(60) Provisional application No. 63/383,583, filed on Nov. 14, 2022.

(51) Int. Cl. G02B 27/01; G02B 27/00; G06T 7/33; G06T 7/73

(52) U.S. Cl. CPC G02B 27/0172; G02B 27/0093; G06T 7/337; G06T 7/74; G02B 2027/014; G06T 2207/10016; G06T 2207/10024; G06T 2207/20084; G06T 2207/20224; G06T 2207/30201

(57) ABSTRACT

A method and apparatus for performing image replacement is provided and includes one or more memories storing instructions, and one or more processors that, upon execution of the instructions, are configured to receive first images of a user during a precapture process, receive second images of a user, the second images of the user having a portion thereof blocked by a wearable device, determine orientation and position of the wearable device to identifying a location of the wearable device in the received second images, perform region swapping on the second images by replacing the blocked portion of the user with corresponding regions obtained from the first images; and generate, for output to a display on the wearable device, third images comprised of the second images and the first images.

### CROSS-REFERENCE TO RELATED APPLICATIONS

This application claims the benefit of U.S. Provisional Patent Application Ser. No. 63/380,452 filed on Oct. 21, 2022 and U.S. Provisional Patent Application Ser. No. 63/383,583 filed on Nov. 14, 2022, both of which are incorporated herein in their entirety.

### BACKGROUND

### Technical Field

The present disclosure relates generally to video image processing in a virtual reality environment.

### Description of Related Art

Given the progress that has been recently made in mixed reality, it is becoming practical to use a headset or Head Mounted Display (HMD) to join a virtual conference or a get-together meeting and be able to see each other with 3D faces in real-time. The need for these gatherings has been made more important because, in some scenarios such as a pandemic or other disease outbreaks, people cannot meet together in person.

Headsets are needed so we are able to see the 3D faces of each other using virtual and/or mixed reality. However, with the headset positioned on the face of a user, no one can really see the entire 3D face of others because the upper part of the face will be blocked by the headset. Therefore, to find a way to remove the headset and recover the blocked upper face region from the 3D faces is critical to the overall performance in virtual and/or mixed reality.

### SUMMARY

An embodiment of the present disclosure provides an apparatus and method that includes receiving first images of a user during a precapture process, receiving second images of a user, the second images of the user having a portion thereof blocked by a wearable device, determining orientation and position of the wearable device to identifying a location of the wearable device in the received second images, performing region swapping on the second images by replacing the blocked portion of the user with corresponding regions obtained from the first images, and generating, for output to a display on the wearable device, third images comprised of the second images and the first images.

In another embodiment, which may include any other embodiments described herein, the received first images include one or more items of face information, and the region swapping is performed by using the determined orientation and position of the wearable device in the received second images to determine a correspondence between the orientation and position of the wearable device and one or more of the one or more items of face information from the first images.

In another embodiment, which may include any other embodiments described herein, the one or more items of face information include orientation in one or more of a Yaw orientation, a Pitch orientation and/or a Roll orientation, one or more facial expressions, or eye blink.

In another embodiment, which may include any other embodiments described herein, the apparatus and method also includes generating the third images by combining one or more two dimensional images of the region in the first images that corresponds to the blocked portion of the second images into the third images for output to a display on the wearable device.

In another embodiment, which may include any other embodiments described herein, the apparatus and method also includes providing the received first images, in real time, to a first image processing channel that uses alignment and position information of the wearable to device to select respective ones of the first images as candidate replacement images based on face information associated with the first images, providing the received second images, in real-time, to a second image processing channel that extracts a region of the second images corresponding to the blocked region, and performing the region swapping by using a portion of the candidate replacement image that corresponds to the extracted region from the second images based on an orientation, facial expression or eye blink information extracted in the second images.

In another embodiment, which may include any other embodiments described herein, the apparatus and method also includes extracting the region of the second images by providing, the second images to a trained machine learning model having been trained, based on a plurality of images of general users wearing the wearable device, that classifies the region in the second images indicative of the wearable device.

In another embodiment, which may include any other embodiments described herein, the candidate replacement images include an eye or nose region, and also includes performs region swapping by inpainting eye or nose regions of the first images into the extracted region from the second images.

In another embodiment, which may include any other embodiments described herein, the generated third image includes the inpainted eye and nose regions from first images having orientation, facial expression or eye blinks substantially similar to orientation, facial expression or eye blinks of the second images.

According to an embodiment, which may include any other embodiments described herein, an apparatus and method is provided and includes obtaining an image of a human face, detecting landmarks in the obtained image of the human, obtaining landmarks of a reference image of a human face, aligning the obtained landmarks in the image of the human face with landmarks of the reference image of the human face, generating features based on the aligned landmarks and classifying the obtained image of the human face using a trained machine learning model to identify presence and absence of respective facial activation units in the obtained image of the human face based on the generated features.

In another embodiment, which may include any other embodiments described herein, the reference image of a human face is either the one generated from the obtained image of the human face or the one different from the obtained image of the human face.

In another embodiment, which may include any other embodiments described herein, determining, after obtaining the image of a human face, whether a reference image of the human face in the obtained image is stored in memory, and in response to determining that no reference image corresponding to the obtained image is stored, obtaining a canonical image of a human face to be used as the reference image for alignment, and in response to determining that a reference image corresponding to the obtained image is stored, using the stored reference image for alignment.

In another embodiment, which may include any other embodiments described herein, the apparatus and method also includes using the stored reference image for alignment in response to determining that the stored reference image was generated based on a threshold number of image frames of the human face in the obtained images.

In another embodiment, which may include any other embodiments described herein, the apparatus and method includes determining, after obtaining the image of a human face, whether a reference image of the human face in the obtained image is stored in memory, and in response to determining that the reference image is not stored, using a canonical image of a human face for alignment for predetermined number of obtained image frames that include the image of the human face for alignment, and storing obtained images of the human face from successive frames to generate a user-specific reference image by averaging the stored images.

In another embodiment, which may include any other embodiments described herein, the apparatus and method also includes providing classified images having particular facial activation units present to an image processing application in response to the image processing application determining that a live captured image includes the particular facial activation units, wherein the image processing application replaces a portion of the live captured image with a corresponding portion of the provided classified images.

According to another embodiment, which may include any other embodiments described herein, an apparatus and method are provided and includes obtaining, from a sequence of images of a face, information representing positions of an upper eye and lower eye lid, obtaining, from the sequence of images of the face, information representing a position of an upper face and a lower face to determine a height of the face, determining an occurrence of a blink by a user in the sequence of images based on a relative positions of the upper eyelid and lower eye relative to the height of the face, extracting, from the sequence of images, first frames that include a blink and second frames that do not include a blink, and replacing, in a second sequence of images, regions of the face with first or second frames based on predetermined replacement rules.

In another embodiment, which may include any other embodiments described herein, the apparatus and method also includes determining an occurrence of an eye blink by removing, from the sequence of images, baseline data representing differences in relative positions greater than a predetermined distance, comparing the sequence of images having the baseline removed with a first threshold indicating a likelihood of an eye blink occurring, and comparing the sequences images having the baseline removed with a second threshold, lower than the first threshold, representing a duration of an eye blink, and identifying segments from within the sequence of images that exceed both the first and second thresholds as eye blink segments.

In another embodiment, which may include any other embodiments described herein, the apparatus and method also includes determining a principle of eye blink occurrence based one or more features associated with the determined occurrence of a blink for a user, and replacing, in a second sequence of images, regions of the face with first or second frames based on the determined eye blink principle.

In another embodiment, which may include any other embodiments described herein, the eye blink principle is determined using a statistical analysis of eye blink occurrence within at least one sequence of images for the user.

In another embodiment, which may include any other embodiments described herein, the one or more features include at least one of or both of a time interval between determined occurrences of a blink and a duration of a blink during the determined occurrences of a blink.

In another embodiment, which may include any other embodiments described herein, for the second sequence of images, identifying an eye region based on one or more facial landmarks, generating an eye mesh for the identified eye region, and replacing, in response to a determination that blink might occur, the eye mesh in the second sequence of images with the first frames, and replacing, in response to a determination that a blink might not occur, the eye mesh in the second sequence of images with the second frames.

In another embodiment, which may include any other embodiments described herein, the apparatus and method also includes storing, in a memory device, the extracted first frames and second frames, and acquiring from the memory device, the extracted first and second frames to replace the regions in the second sequence of images.

According to another embodiment, which may include any other embodiments described herein, a method and apparatus are provided that includes receiving position and orientation information from a wearable device being worn by a user having a first time signatures, capturing images of the user wearing the wearable device using an image capture device having a second time signature, determining an offset between the first and second time signature using the position and orientation information of the wearable device and orientation and position information extracted from the captured images, and using the determined offset as a reference time to sync the timing between the image capture device and the wearable device.

In another embodiment, which may include any other embodiments described herein, the method and apparatus also includes generating, for each of the captured images of the user wearing the wearable device, a bounding box surrounding the wearable device in the capture images, obtaining coordinates of the generated bounding box within the capture images, and determining the offset using the received position and orientation information from the wearable device and the obtained coordinates of the bounding box in the capture images.

In another embodiment, which may include any other embodiments described herein, the method and apparatus also includes determining the offset by performing a cross-correlation processing using the received orientation information of the wearable device and the position information of the wearable device within the captured images.

In another embodiment, which may include any other embodiments described herein, the orientation information is first orientation information of the wearable device and the position of the wearable device within the captured image is based on a particular coordinate associated with a bounding box surrounding the wearable device in the captured images.

In another embodiment, which may include any other embodiments described herein, the first orientation information of the wearable device is a pitch value of the wearable device and the particular coordinate associated with the bounding box within the captured image is the Y-coordinate value.

In another embodiment, which may include any other embodiments described herein, the first orientation information of the wearable device is a yaw value of the wearable device and the particular coordinate associated with the bounding box within the captured image is the X-coordinate value.

In another embodiment, which may include any other embodiments described herein, the method and apparatus includes generating, over a predetermined number of captured image frames, a cross correlation coefficient between a signal representing the received position and orientation information from the wearable at the first time stamp and the captured images of the user wearing the wearable at the second time stamp, and using the generated cross correlation coefficient as the offset value to sync the time stamps.

In another embodiment, which may include any other embodiments described herein, the method and apparatus includes shifting frames of the captured images a predetermined number of frames forward or a predetermined number of frames backwards based on the determined offset.

In another embodiment, which may include any other embodiments described herein, the method and apparatus includes determining the offset by performing a mutual correlation processing using a plurality of received position and orientation information items of the wearable device and a plurality of position information items of the wearable device within the captured images.

In another embodiment, which may include any other embodiments described herein, the plurality orientation information items include at least two or more of pitch value, yaw value, roll value, X-value, Y-value and Z-value received from the wearable device and the plurality of position items of the wearable device within the captured image is based on at least two coordinate values associated with a bounding box surrounding the wearable device in the captured images.

In another embodiment, which may include any other embodiments described herein, the apparatus and method also includes generating a first data set including the plurality of received position and orientation data items having a single dimension, generating a second data set including the at least two position items of the wearable device within the captured image having a single dimension, determining a relative entropy between the first and second data sets, and obtain the offset values based on the highest determined relative entropy values.

In another embodiment, which may include any other embodiments described herein, the apparatus and method also includes receiving a series of images of a user wearing a wearable device, determining a position and orientation of the wearable device based on position and orientation information obtained from one or more sensors of the wearable device and a location and orientation of the wearable device determined from the received series of images, and estimating a pose of the user in the received series of images based on the determined position, location and orientation.

In another embodiment, which may include any other embodiments described herein, the apparatus and method also includes determining the position and orientation of the wearable device based on information positioned on the wearable device.

In another embodiment, which may include any other embodiments described herein, the apparatus and method also includes determining the location and orientation of the wearable device by estimating one or more landmarks of a user being occluded by the wearable device, and obtaining location and orientation information based on the one or more estimated landmarks.

In another embodiment, which may include any other embodiments described herein, the apparatus and method includes generating a bounding box surrounding the wearable device within each image of the series of images, inpainting, into the generated bounding box in each image, estimating the one or more landmarks of a face that are being occluded by the wearable device, obtaining coordinate and orientation information representing the one or more landmarks inpainted into the image.

In another embodiment, which may include any other embodiments described herein, the apparatus and method also includes inpainting one or more features of a user being occluded by the wearable device, providing the inpainted images to a trained machine learning model trained to predict facial landmarks, estimating the pose of the user by predicting landmarks on a user in an area not covered by the wearable device, and verifying the estimated pose by providing the inpainted images to a trained machine learning model trained to predict facial landmarks.

In another embodiment, which may include any other embodiments described herein, the apparatus and method includes generating an input image by inpainting, into each image of the series of images, one or more features of a user being occluded by the wearable device. providing the generated input image to a trained machine learning model that is trained to generate facial landmarks, obtaining, estimated facial landmarks, using output from the trained machine learning model, obtaining, from each image in the series of images, projected facial landmarks on face of a user in an area not occluded by the wearable device, and estimating a head pose of a user based on the estimated facial landmarks and projected facial landmarks.

In another embodiment, which may include any other embodiments described herein, the apparatus and method also includes generating a user interface displayable in the wearable device indicating a target position for the wearable device in a virtual reality environment, directing, via display within the generated user interface of one or more image elements, the user to move such that the wearable device is at the target position, using coordinates of the target position and the position and orientation information obtained from one or more sensors of the wearable device to estimate the pose of the user.

In another embodiment, which may include any other embodiments described herein, the target position is determined based a predetermined first target area displayed within the user interface and a second target area corresponding to a bounding box that surrounds the wearable device.

In another embodiment, which may include any other embodiments described herein, the apparatus and method also includes generating one or more image elements to direct the user to move to a substantial center point of both of the first target area and second target area using a current position of the wearable device as determined by the received position and orientation of the wearable device.

In another embodiment, which may include any other embodiments described herein, the target position is determined based an orientation of the wearable device as determined by the received orientation from the wearable device.

In another embodiment, which may include any other embodiments described herein, the apparatus and method also includes obtaining the series of images of the user wearing the wearable device, estimating positions of one or more facial landmarks in a face occluded by the wearable device and extracting actual facial landmarks in a face area not occluded by the wearable device, use a predetermined three dimensional model of a human face wearing the wearable device, the predetermined three dimensional model including known positions of facial landmarks in the area occluded by the wearable device and known positions of the facial landmarks in a face area not occluded by the wearable device, obtaining head pose information by aligning the estimated positions of one or more facial landmarks in a face area not occluded by the wearable device with the known positions of facial landmarks in the area not occluded by the wearable device from the three dimensional model.

According to another embodiment, which may include any other embodiments described herein, an apparatus and method are provided that includes determining, in a target image, one or more regions to be recolored using a corresponding one or more regions of a source image, performing, on a source image, a color transform from a first color space to a second color space, performing, on a target image, a color transform from the first color space to the second color space, performing recolor processing of the one or more regions in the target image using the color transformed source image in the second color space when it is determined that there is a correspondence between one or more features in the one or more regions of the source image and the one or more regions of the target image, and performing, on a target image, a color transform from the second color space to the first color space.

In another embodiment, which may include any other embodiments described herein, the apparatus and method also includes using a reference image that has been color transformed from the first color space to the second color space when it is determined that the one or more features in the one or more regions of source image do not correspond with the one or more features in the one or more regions of targe images, performing a first recolor processing using the one or more regions of both the source and the reference images in the second color space, and performing a second recolor processing using the one or more regions of the target image with the one or more regions of the recolored reference image.

In another embodiment, which may include any other embodiments described herein, the apparatus and method also includes identifying the one or more shared regions of the source image and the target image, obtaining a reference image correlated with the source image and target image, performing a color transform on the source image based on at least one shared region in the source image that is common to the reference image, replacing the one regions in the target image with the color transformed source image that was transformed based on commonality of features between the source image and reference image.

In another embodiment, which may include any other embodiments described herein, the source image is previously captured image captured by an image capture device and is used for replacing at least a portion of a target image.

In another embodiment, which may include any other embodiments described herein, the target image is a live captured image of a user wearing a wearable device that occludes at least part of a face of the user.

In another embodiment, which may include any other embodiments described herein, the source image includes segment information identifying a plurality of segments each having respective color values, and further includes identifying one or more segments in a live captured target image, performing recolor processing in the target image using segment information form the source image that corresponds to identified one or more segments in the live captured target image.

In another embodiment, which may include any other embodiments described herein, the apparatus and method further includes obtaining the source image, obtaining the target image, obtaining a reference image, converting the source image from a first color space to a second color space, converting the target image from the first color space to the second color space, converting the reference image from the first color space to the second color space, performing a color transfer on a region of the target image in the second color space based, at least in part, on the reference image in the second color space, and performing a color transfer on a region of the source image in the second color space based, at least in part, on the reference image in the second color space.

According to another embodiment, which may include any other embodiments described herein, an apparatus and method are provided that includes obtaining an image of user wearing a head mounted display device that a partially occluded a region of a face of the user, inferring facial landmarks in the partially occluded region of the obtained image based on a model of a face and a head mounted display device being worn on a face, generating an image including the inferred facial landmarks and actual facial landmarks obtained from a region of the face not occluded by the head mounted display device.

In another embodiment, which may include any other embodiments described herein, the apparatus and method also includes inferring the facial landmarks in the partially occluded region based on orientation and position of the head mounted display.

In another embodiment, which may include any other embodiments described herein, the model includes a three dimensional point cloud of face and a three dimensional point cloud of a head mounted display projected onto an image plane to obtain a two dimensional point cloud representing a face wearing a head mounted display.

In another embodiment, which may include any other embodiments described herein, the apparatus and method also includes generating a first bounding box in the obtained image that surrounds the head mounted display using image segmentation processing, generating a second bounding box of a head mounted display based on the model by projecting a three dimensional model point cloud from the model into a two dimensional image plane, aligning the first and second bounding boxes to generate a target image including the inferred facial landmarks in the region occluded by the head mounted display device.

In another embodiment, which may include any other embodiments described herein, the apparatus and method also includes obtaining a 3D model of a face, obtaining a 3D model of a head-mounted display, obtaining a 3D model of a face that is wearing a head-mounted display, obtaining an orientation of the face in the image, generating a first bounding box of the face in the image, projecting the 3D model of the face and the model of the head-mounted display onto an image plane, generating a second bounding box of the projected model of the head-mounted display, generating a transform based on the first bounding box and the second bounding, and inferring landmarks in the image of the face based on the transform.

According to another embodiment, which may include any of the above embodiments described herein, a method and apparatus is provided that includes obtaining an image frame to be encoded and communicated via a network to an external apparatus, encoding the image frame for network communication by including, in color space information of the image frame, transparency information, and transmitting the encoded image frame to the external apparatus that uses the color space information and transparency information to render the image frame.

According to another embodiment, which may include any of the above embodiments described herein, the encoding includes determining, for each pixel in the image frame, whether the pixel is a foreground pixel or a background pixel, and for pixels determined to be foreground pixels, set the transparency information above a predetermined threshold indicating, to the external apparatus, to display the determine foreground pixels using the color space information associated with the pixel, and for pixels determined to be background pixels, set the transparency information below a predetermined threshold indicating, to the external apparatus, to display the determined background pixels as transparent.

According to another embodiment, which may include any of the above embodiments described herein for the pixels determined to be foreground pixels, generating the transparency information by scaling down the foreground pixel such that the transparency information and color space information do not overlap.

According to another embodiment, which may include any of the above embodiments described herein, the encoding further includes dividing the image frame into a first tensor including color space information and second tensor including transparency information, wherein, upon the dividing, time stamp information is appended to each of the first tensor, transmitting, the first tensor and second tensor, separately, to the external apparatus that uses the first and second tensor, and the associated time stamp to synchronize transparency information and color space information for display.

In another embodiment, an apparatus is provided that includes one or more memories storing instructions and one or more processors that, upon execution of the stored instructions, configures the one or more processors to perform operations in accordance with any of the embodiments described herein.

In another embodiment, a server is provided that includes one or more memories storing instructions and one or more processors that, upon execution of the stored instructions, configures the one or more processors to perform operations in accordance with any of the embodiments described herein.

In another embodiment, a non-transitory computer readable storage medium is provided that stores instructions that, when executed by one or more processors, configures an apparatus or device to perform one or more methods of any of the embodiments described herein.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a virtual reality capture and display system according the present disclosure.

FIG. 2 shows an embodiment of the present disclosure.

FIG. 3 shows a virtual reality environment as rendered to a user according to the present disclosure.

FIG. 4 illustrates a block diagram of an exemplary system according to the present disclosure.

FIG. 5 illustrates a 3D perception of a 2D human image in a 3D virtual environment according to the present disclosure.

FIGS. 6A & 6B illustrate HMD removal processing according to the present disclosure.

FIG. 7 is a flow diagram illustrating exemplary HMD removal processing according to the present disclosure.

FIG. 8 illustrates exemplary orientations during image precapture processing according to the present disclosure.

FIG. 9 illustrates exemplary IMU alignment on time shift and orientation according to the present disclosure.

FIG. 10 illustrates exemplary 3D geometry configuration of human head, HMD and camera system according to the present disclosure.

FIG. 11 is a flow diagram of the real-time HMD removal processing performed according to the present disclosure.

FIG. 12 is a flow diagram of the real-time HMD removal processing performed according to the present disclosure.

FIG. 13 is a flow diagram for processing to determine a position of a user within a series of captured image frames.

FIG. 14 illustrates defined boundaries against which a user's position in image frames are determined.

FIG. 15 is a graph illustrating state vectors associated with user position in an image frame.

FIG. 16 illustrates a user ready for image capture wearing an HMD device.

FIG. 17 illustrates a user wearing an HMD in a position to be guided to face an image capture device according to the present disclosure.

FIG. 18 illustrates an overview of the canonical face classifier used according to the present disclosure.

FIG. 19 illustrates an exemplary algorithm that is used to determine the canonical face according to the present disclosure.

FIG. 20 is an exemplary balancing algorithm according to the present disclosure.

FIG. 21 is an exemplary balancing algorithm according to the present disclosure.

FIG. 22 illustrates the eye blink detection processing according to the present disclosure.

FIG. 23 graphically illustrates the scaled determinations of eye blinks in a series of image frames according to the present disclosure.

FIG. 24 is a flow diagram of the eye blink detection processing according to the present disclosure.

FIG. 25 illustrates three stages of eye blink detection processing according to the present disclosure.

FIG. 26 illustrates histograms of artificial generation of a new sequence of user's eye blink according to the present disclosure.

FIG. 27 is a flow diagram detailing the generation of video with desired eyeblinks according to the present disclosure.

FIG. 28 illustrates the results of the processing performed in FIG. 27 according to the present disclosure.

FIG. 29 is a graphical plot illustrating correlation between signals from an HMD device and information from a video frame being displayed within the HMD device according to the present disclosure.

FIG. 30 is a graphical plot illustrating the highest offset between signals according to the present disclosure.

FIG. 31 is a flow diagram detailing the first alignment processing performed according to the present disclosure.

FIG. 32 illustrates a histogram resulting from the second alignment processing performed according to the present disclosure.

FIG. 33 is a flow diagram detailing the second alignment processing performed according to the present disclosure.

FIG. 34 is a schematic of an alignment process for aligning the HMD with images captured by an image capture device.

FIG. 35 of an alignment process for aligning the HMD with images captured by an image capture device according to the present disclosure.

FIG. 36 illustrates exemplary approaches to estimate offset constants according to the present disclosure.

FIG. 37 depicts images processed according the alignment processing in FIGS. 34-36 according to the present disclosure.

FIG. 38 is an exemplary GUI used in alignment processing according to the present disclosure.

FIG. 39 is an exemplary GUI used in alignment processing according to the present disclosure.

FIG. 40 depicts a schematic of initial set-up of 3D models of a head wearing an HMD device according to the present disclosure.

FIG. 41 depicts a schematic of the geometric readjustment processing according to the present disclosure.

FIG. 42 illustrates one embodiment of recolor processing performed according to the present disclosure.

FIG. 43 is a flow diagram detailing the exemplary recolor processing performed according to the present disclosure.

FIG. 44 illustrates another embodiment of recolor processing performed according to the present disclosure.

FIG. 45 illustrates another embodiment of recolor processing performed according to the present disclosure.

FIGS. 46A & 46B illustrate another embodiment of recolor processing performed according to the present disclosure.

FIG. 47 illustrates another embodiment of recolor processing performed according to the present disclosure.

FIG. 48 is a flow diagram detailing the exemplary recolor processing performed according to the present disclosure.

FIG. 49 illustrates another embodiment of recolor processing performed according to the present disclosure.

FIG. 50 illustrates another embodiment of recolor processing performed according to the present disclosure.

FIG. 51 illustrates another embodiment of recolor processing performed according to the present disclosure.

FIG. 52 illustrates an embodiment of landmark inference processing performed according to the present disclosure.

FIG. 53 illustrates an embodiment of landmark inference processing performed according to the present disclosure.

FIG. 54 illustrates an embodiment of landmark inference processing performed according to the present disclosure.

FIG. 55 illustrates types of transforms using in landmark inference processing performed according to the present disclosure.

FIGS. 56A & 56B are flow diagrams detailing the exemplary landmark inference processing performed according to the present disclosure.

FIGS. 57 & 58 illustrate exemplary CNN model architecture according to the present disclosure.

FIG. 59 is a flow diagram describing image preprocessing for training of the CNN according to invention principles.

FIG. 60 is a flow diagram describing image postprocessing according to invention principles.

FIGS. 61A & 61B are exemplary ways to create perception of 3d content.

FIG. 62 illustrates the difference of 2D projections from different camera models between our human figure capturing and 3D virtual environment.

FIG. 63 illustrates correction processing for camera systems according to the present disclosure.

FIG. 64 illustrates image scale and shift correction processing according to the present disclosure.

FIGS. 65A & 65B which illustrates two cases where the height and width of a person, will change when the person is moving.

FIG. 66 illustrates a pinhole camera used to rescale and shift user height and width according to invention principles.

FIG. 67 illustrates an exemplary image frame prior to encoding according to the present disclosure.

FIG. 68 illustrates an exemplary image frame after encoding according to the present disclosure.

FIG. 69 illustrates an exemplary encoding scheme according to the present disclosure.

FIG. 70 illustrates an exemplary encoding scheme according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

### Section 1: Environment Overview

The present disclosure as shown hereinafter describes systems and methods for implementing virtual reality-based immersive calling.

FIG. 1 shows a virtual reality capture and display system 100. The virtual reality capture system comprises a capture device 110. The capture device may be a camera with sensor and optics designed to capture 2D RGB images or video, for example. In one embodiment, the image capture device 110 is a smartphone that has front and rear facing cameras and which can display images captured thereby on a display screen thereof. Some embodiments use specialized optics that capture multiple images from disparate view-points such as a binocular view or a light-field camera. Some embodiments include one or more such cameras. In some embodiments the capture device may include a range sensor that effectively captures RGBD (Red, Green, Blue, Depth) images either directly or via the software/firmware fusion of multiple sensors such as an RGB sensor and a range sensor (e.g., a lidar system, or a point-cloud based depth sensor). The capture device may be connected via a network 160 to a local or remote (e.g., cloud based) system 150 and 140 respectively, hereafter referred to as the server 140. The capture device 110 is configured to communicate via the network connect 160 to the server 140 such that the capture device transmits a sequence of images (e.g., a video stream) to the server 140 for further processing.

Also, in FIG. 1, a user 120 of the system is shown. In the example embodiment the user 120 is wearing a Virtual Reality (VR) device 130 configured to transmit stereo video to the left and right eye of the user 120. As an example, the VR device may be a headset worn by the user. As used herein, the VR device and head mounted display (HMD) device may be used interchangeably. Other examples can include a stereoscopic display panel or any display device that would enable practice of the embodiments described in the present disclosure. The VR device is configured to receive incoming data from the server 140 via a second network 170. In some embodiments the network 170 may be the same physical network as network 160 although the data transmitted from the capture device 110 to the server 140 may be different than the data transmitted between the server 140 and the VR device 130. Some embodiments of the system do not include a VR device 130 as will be explained later. The system may also include a microphone 180 and a speaker/headphone device 190. In some embodiments the microphone and speaker device are part of the VR device 130.

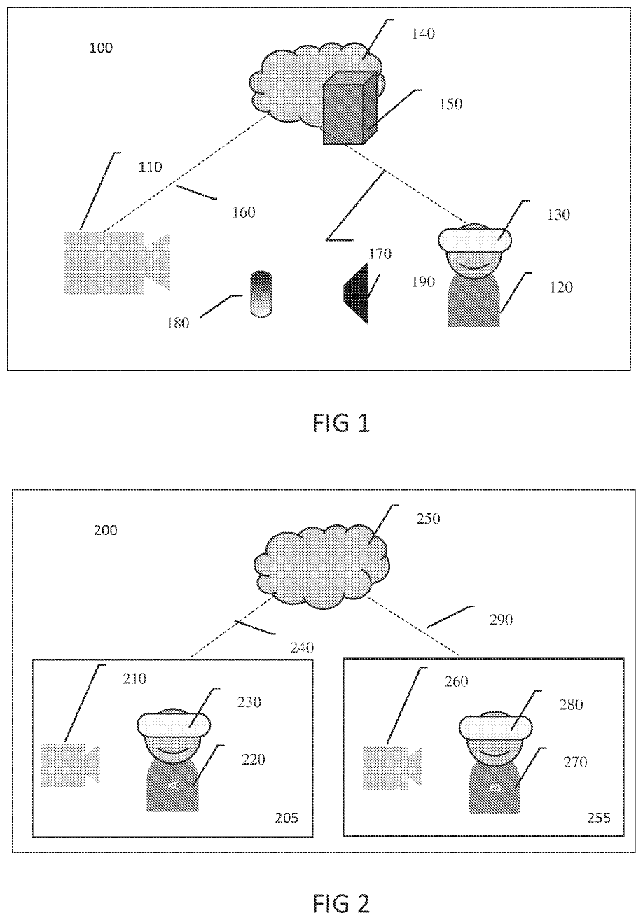

FIG. 2 shows an embodiment of the system 200 with two users 220 and 270 in two respective user environments 205 and 255. In this example embodiment, each user 220 and 270 are equipped with a respective capture devices 210 and 260, respective VR devices 230 and 280, and are connected via respective networks 240 and 270 to a server 250. In some instances, only one user has a capture device 210 or 260, and the opposite user may only have a VR device. In this case, one user environment may be considered as a transmitter and the other user environment may be considered the receiver in terms of video capture. However, in embodiments with distinct transmitter and receiver roles, audio content may be transmitted and received by only the transmitter and receiver or by both, or even in reversed roles.

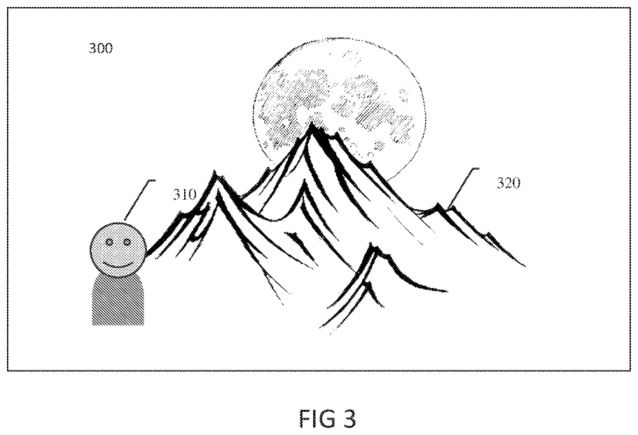

FIG. 3 shows a virtual reality environment 300 as rendered to a user. The environment includes a computer graphic model 320 of the virtual world with a computer graphic projection of a captured user 310. For example, the user 220 of FIG. 2, may see via the respective VR device 230, the virtual world 320 and a rendition 310 of the second user 270 of FIG. 2. In this example, the capture device 260 would capture images of user 270, process them on the server 250 and render them into the virtual reality environment 300.

In the example of FIG. 3, the user rendition 310 of user 270 of FIG. 2, shows the user without the respective VR device 280. The present disclosure sets forth a plurality of algorithms that, when executed, cause the display of user 270 to appear without the VR device 280 and as if they were captured naturally without wearing the VR device. Some embodiments show the user with the VR device 280. In other embodiments the user 270 does not use a wearable VR device 280. Furthermore, in some embodiments the captured images of user 270 capture a wearable VR device, but the processing of the user images remove the wearable VR device and replace it with the likeness of the users face.

Additionally, the addition of the user rendition 310 into the virtual reality environment 300 along with VR content 320 may include a lighting adjustment step to adjust the lighting of the captured and rendered user 310 to better match the VR content 320.

In the present disclosure, the first user 220 of FIG. 2, is shown via the respective VR device 230, the VR rendition 300 of FIG. 3. Thus, the first user 220, sees user 270 and the virtual environment content 320. Likewise, in some embodiments, the second user 270 of FIG. 2, will see in the same VR environment 320, but from a different view-point, e.g. the view-point of the virtual character rendition of 310 for example.

In order to achieve the immersive calling as described above, it is important to render each user within the VR environment as if they were not wearing the headset in which they are experiencing the VR content. The following describes the real-time processing performed that obtains images of a respective user in the real world while wearing a virtual reality device 130 also referred to hereinafter as the head mount display (HMD) device.

### Section 2: Hardware

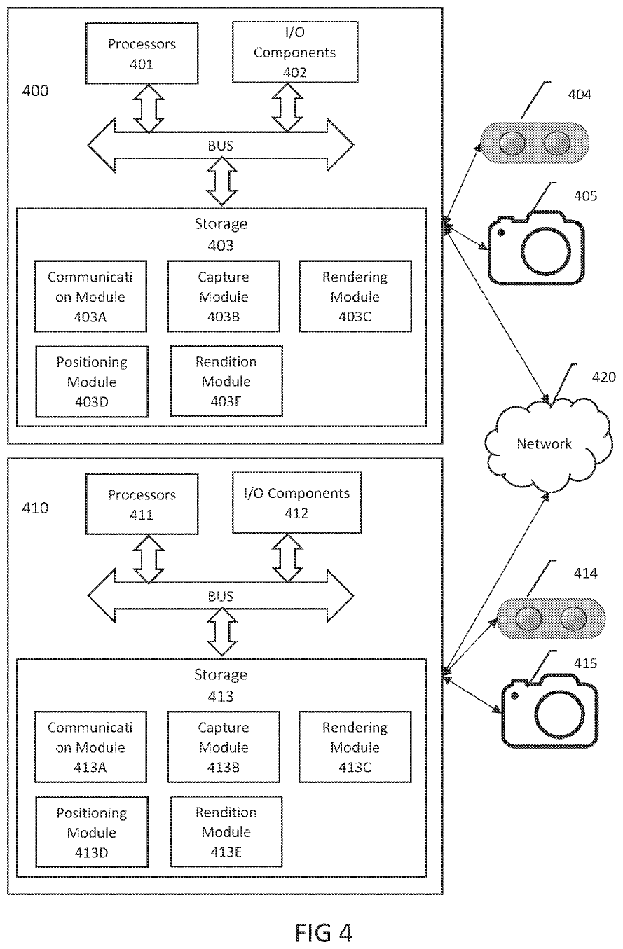

FIG. 4 illustrates an example embodiment of a system for virtual reality immersive calling system. The system includes two user environment systems 400 and 410, which are specially-configured computing devices; two respective virtual reality devices 404 and 414, and two respective image capture devices 405 and 415. In this embodiment, the two user environment systems 400 and 410 communicate via one or more networks 420, which may include a wired network, a wireless network, a LAN, a WAN, a MAN, and a PAN. Also, in some embodiments the devices communicate via other wired or wireless channels.

The two user environment systems 400 and 410 include one or more respective processors 401 and 411, one or more respective I/O components 402 and 412, and respective storage 403 and 413. Also, the hardware components of the two user environment systems 400 and 410 communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 401 and 411 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 402 and 412 include communication components (e.g., a graphics card, a network-interface controller) that communicate with the respective virtual reality devices 404 and 414, the respective capture devices 405 and 415, the network 420, and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storages 403 and $13 include one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storages 403 and 413, which may include both ROM and RAM, can store computer-readable data or computer-executable instructions.

The two user environment systems 400 and 410 also include respective communication modules 403A and 413A, respective capture modules 403B and 413B, respective rendering module 403C and 413C, respective positioning module 403D and 413D, and respective user rendition modules 403E and 413E. A module includes logic, computer-readable data, or computer-executable instructions. In the embodiment shown in FIG. 4, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 403 and 413. Also, in some embodiments, the two user environment systems 400 and 410 includes additional or fewer modules, the modules are combined into fewer modules, or the modules are divided into more modules. One environment system may be similar to the other or may be different in terms of the inclusion or organization of the modules.

The respective capture modules 403B and 413B include operations programed to carry out image capture as shown in 110 of FIGS. 1, 210 and 260 of FIG. 2. The respective rendering module 403C and 413C contain operations programed to carry out the functionality associated with rendering images that are captured to one or more users participating in the VR environment. The respective positioning module 403D and 413D contain operations programmed to carry out the process including identifying and determining position of each respective user in the VR environment. The respective user rendition modules 403E and 413E contains operations programmed to carry out user rendering as illustrated in the following figures described hereinbelow. The prior-training module 403F contains operations programmed to estimate the nature and type of images that were captured prior to participating in the VR environment that are used for the head mount display removal processing. In some embodiments the some modules are stored and executed on an intermediate system such as a cloud server. In other embodiments, the capture devices 405 and 415, respectively, include one or more modules stored in memory thereof that, when executed perform certain of the operations described hereinbelow.

### Section 3: Overview of HMD Removal Processing

As noted above, in view of the progress made in augmented virtual reality, it is becoming more common to enter into an immersive communication session in a VR environment where each user is in their own location wearing a headset or Head Mounted Display (HMD) to join together in virtual reality. However, HMD device has blocked the capability of achieving better user experience if a HMD removal is not applied since you won't see the full face of others while in VR and others are unable to see your full face.

Accordingly, the present disclosure advantageously provides a system and method that remove the HMD device from a 2D face image of a user that is wearing the HMD and participating in a VR environment. Removing the HMD from a 2D image of a user's face and not from the 3D object is advantageous because humans can perceive 3D effect from a 2D human image by inserting the 2D image into 3D environment.

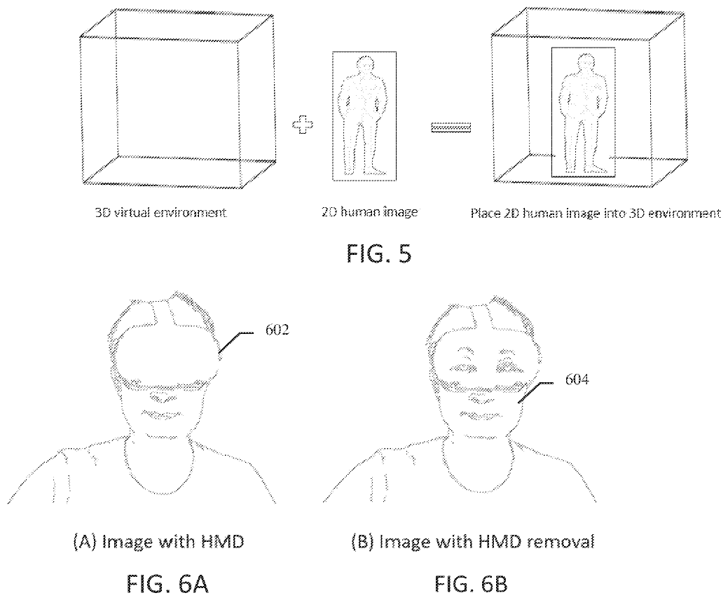

More specifically, in a 3D virtual environment, the 3D effect of a human being can be perceived if this human figure is created in 3D or is created with the depth information. However, the 3D effect of a human figure is also perceptible even if we don't have the depth information. One example is shown in FIG. 5. Here a captured 2D image of a human is placed into a 3D virtual environment. Despite not have the 3D depth information, the resulting 2D image is perceived as a 3D figure by human perception automatically filling the depth information. This is similar to the “filling-in” phenomenon for blind spots in human vision.

In augmented and/or virtual reality, users wear HMD device. At times, when entering a virtual reality environment or application, the user will be rendered as an avatar or facsimile of themselves in animated form but which does not represent an actual real-time captured image of themselves. The present disclosure remedies this deficiency by provide a real-time live view of a user in a physical space while they are experiencing a virtual environment. To allow the user to be captured and seen by others in the VR environment, an image capture device is camera positioned in front of the user to capture the user's images. However, because of the HMD device the user is wearing, others won't see the user's full face but only the lower part since the upper part is blocked by the HMD device.

To allow for full visibility of the face of the user being captured by the image capture device HMD removal processing is conducted to replace HMD region with an upper face portion of the image. An example is shown in FIG. 6 to illustrate the effect of HMD removal. We want to replace the HMD region 602 of the HMD image shown in FIG. 6A with one or more precaptured images of the user or artificially generated images to form a full face image 604 shown in FIG. 6B. In generating the full face image 604, the features of the face that are generally occluded when wearing the HMD 602 are obtained and used in generating the full face image 604 such that the eye region will be visible in the virtual reality environment. HMD removal is a critical component in any augmented or virtual reality environment because it improves visual perception HMD region 602 is replaced with some reasonable images of the user that were previously captured.

The precaptured images that are used as replacement images during the HMD removal processing are images obtained using an image capture device such as a mobile phone camera or other camera whereby a user is directed, via instructions displayed on a display device to position themselves in an image capture region and move their face in certain ways and make different facial expressions. These precaptured images may be still or video image data and stored in a storage device. The precaptured images may be cataloged and labeled by the precapture application and stored in a database in association with user specific credentials (e.g. a user ID) so that one or more of these precaptured images can be retrieved and used as replacement images to replace the upper face portion to replace an upper portion of the face image that contains the HMD. This process will be further described hereinafter.

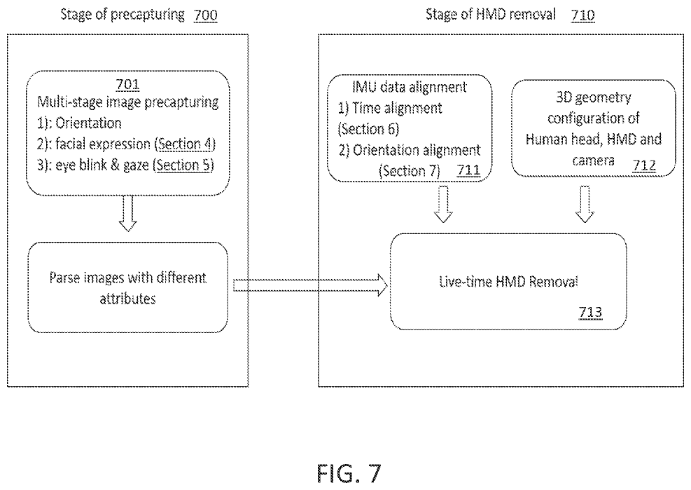

The flow diagram of FIG. 7 illustrates the HMD removal processing performed according to the present disclosure. The HMD removal processing uses a first precapture stage 700 and a second stage 710 that removes the HMD device, in real-time, from images being captured by an image capture device. According to the present disclosure the first stage 700 is the image precapturing stage where images of the user without the HMD positioned over their face and partially occluding a portion of the face are captured prior to entering a VR environment. The second stage 710 is the live, real-time HMD removal processing stage that is performed when a user wishes to participate in a virtual reality environment such as an immersive call. In the second stage 710, an upper face portion of an image being captured in real time that includes the HMD is identified and corresponding images from the one or more images obtained during the precapture stage 700 are obtained to generate a replacement image that includes a lower face portion captured in real-time with a precaptured image of the user. The processing is performed on video image data on a frame by frame basis in real time. However, it should be noted that this process can be performed on a still image as well.

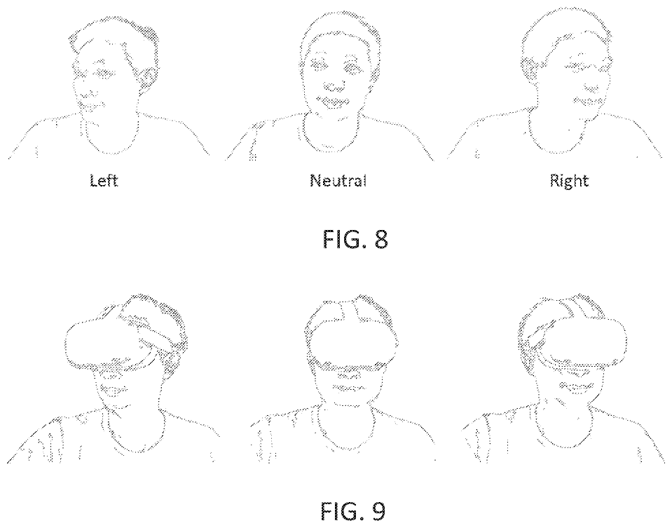

During the first stage 700 where image precapturing is performed, a series of images of the user without anything occluding the face are captured. A first precapture process is performed and includes a multi-stage image precapture process 701 whereby images of the user are captured in a (1) plurality of different orientations, (2) making a plurality of different facial expressions, and (3) performing a plurality of eye movements and blinks. One example is shown in FIG. 8 which illustrates three sample images precaptured in orientations on left view, neutral view, and right view.

Note that this is just an illustration and, in operation, there are many different facial orientations, positions and expressions that are captured and used for the HMD removal processing in the second processing stage. For example, the precaptured images of the user may cover 20 different orientations when a user is directed by a precapture application to move their head from left, right, up and down, etc. In another embodiment, the precapture images may represent orientations including tilted left to tilted right. It should be understood that the plurality of orientations of the user captured during the precapture processing covers all orientations in all three directions, X, Y and Z, of our world space at a reasonable resolution. Although ideally higher resolution of orientation provides a better human perception in terms of performance, it also increases the difficulty of image precapturing for a user. One practical example could be to split an angular range of −60 to 60 for Yaw into 9 intervals, an angular range of −40 to 40 for Pitch into 9 intervals, and leave roll untouched since we can programmatically create rolled images using rotation. The precaptured images are labeled according to orientation information derived from one or more sensors of the HMD device. In in other embodiments, the precapture application executing on the image capture device may generate labels for each image captured that provides orientation information identifying a particular orientation at which the particular image was captured.

The multi-stage precapture processing 701 further includes capturing, by a precapture application executing on the image capture device, the user's face images making different facial expressions, such as normal, happy, sad, surprise, anger, and fear. These are listed for purposes of example only and any facial expression that corresponds to a type of expression that may be made while a user is communicating with another use may be captured during precapture processing. This will enable the HMD removal process to align the facial expression of the upper face with the one from the lower face. This aspect of the precapture stage 701 will be described hereinbelow in greater detail in Section 4 of the present disclosure.

The precapture stage 701 further includes capturing images of the user spontaneously talking and reading a predetermined set of text to extract the information associated with movements of the user's eye and gaze of the user while the user is speaking. This process will be described hereinafter in Section 5 of the present disclosure. This eye movement information used in conjunction with the orientation information and expression information advantageously provides the real-time HMD removal stage 710 with the ability to generate a natural perception of eye movements and eye gazes when those eye information has to be artificially simulated during replacement processing as discussed hereinafter.

Once the image capture portion of the precapture stage has been completed, the precapture image data is automatically processed to generate one or more trained machine learning models by processing the precaptured data and label the data with the information needed for real-time HMD removal and replacement in HMD removal stage 710. The information needed for labelling for each image includes the orientation of face, the facial action units detected from the face, and the eye blink indicator from the face which enables the HMD removal stage to provide, live captured images to the trained machine learning model to search for and obtain, from the storage device, the best precaptured image for replacement processing for the particular user.

The second stage 710 of the HMD removal algorithm includes three sub-stages including IMU (Inertial Measurement Unit) data alignment stage 711, geometry configuration stage 712 (e.g., 3D geometry configuration of camera, HMD and human head), and real-time HMD removal stage 713. The first two sub-stages are calibration processes whereby different components of the system are configured and/or aligned such that the third, sub-stage, real-time HMD removal 713 can be performed. The components being configured and aligned in the first two substages include the HMD being worn by the user, the image capture device that is capturing the image of the user wearing the HMD and a processing device such as a cloud server that is receiving the captured image of the user wearing the HMD and which includes the precaptured image data all of which need to be synced so that the portion of the image being captured having the HMD can be identified, extracted and replaced in real time.

In the IMU data alignment stage 711, a first calibration process is performed whereby IMU data alignment occurs such that IMU data generation from HMD device is aligned with the real-time image generated by the images capture device during image capture process. This includes time stamp alignment and orientation alignment. The time stamp alignment enables the time stamps of IMU data to match the time stamps from the captured images. Without this alignment it is not possible to correspond one specific IMU sensor data with one specific image since they come from two different devices with two different clock systems. This process will be described hereinafter in Section 6 of the present disclosure.

Also, in the IMU data alignment stage 711, a second calibration process is performed whereby orientation alignment occurs such that the orientation reading from IMU sensor matches the orientation of the user estimated from the captured live images of the user wearing the HMD. Without this calibration, the orientation of one dataset cannot be used with the other dataset because of a different definition of a 3D coordinate world system in each component. One example is shown in FIG. 9 and will be described hereinafter in Section 7. FIG. 9 illustrates three images with different Yaw orientations. The orientation estimates from three images from images could be +10, 0 and −10 if we define the middle face with optical axis passing through the center face as the origin. However, IMU sensor might output the Yaw orientations of these three images at 30, 20, and 10. As such, the second calibration process advantageously aligns align the orientations to make sure their readings are transferable to each other.

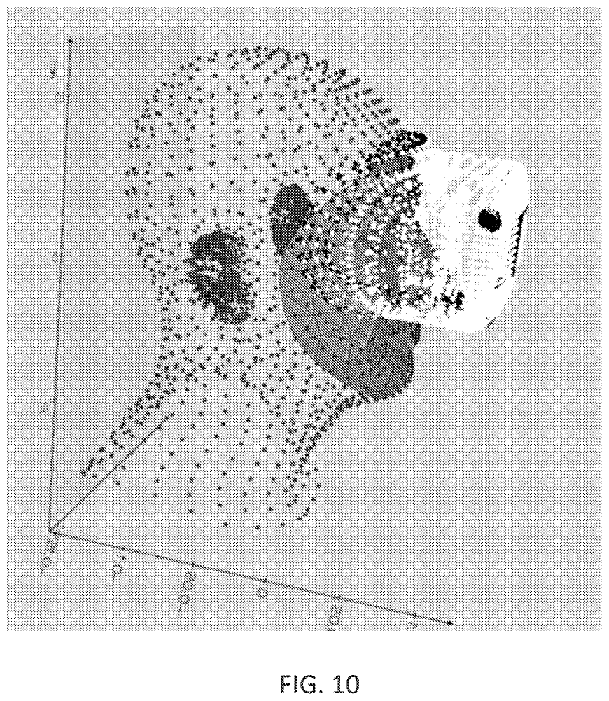

According to the second sub-stage 712 of the HMD removal processing illustrated in FIG. 10, alignment of the 3D geometries of human head, HMD device and camera are performed along with the orientation and time alignment in the first stage.

Despite an assumption that all users are wearing the same HMD devices, head shapes and sizes of users are different. As such, one number cannot be used to represent the variation of the value itself. In addition, how different users wear the HMD devices could also be different, and this difference needs to be contemplated and corrected during geometry alignment processing. This geometry configuration is critical to HMD removal processing because it is desirable to logically infer the 2D human face based on the HMD device position and orientation related to human head. Without correct 3D configuration data, it is difficult to achieve a good accuracy when inferring the 2D human face position since this inferring is purely dependent on the estimated information from HMD device.

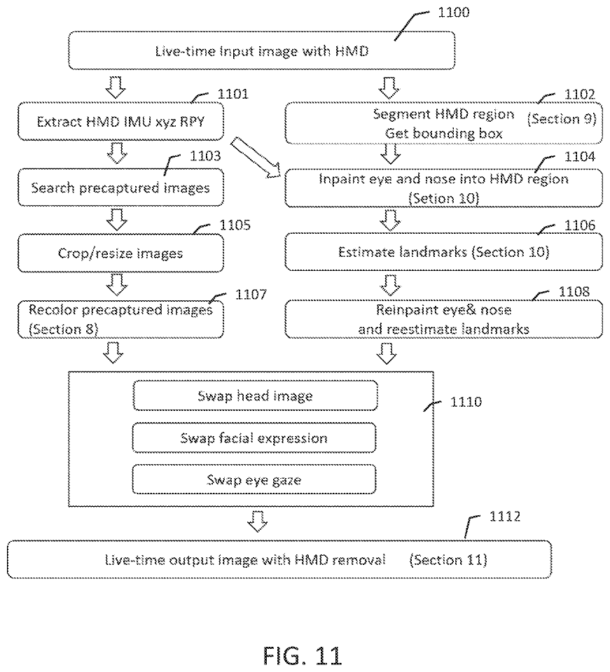

The real-time HMD removal processing stage 713 is then performed upon completion of the calibration stages. In one embodiment, the calibration processing of stages 711 and 712 are performed at a beginning of a session prior to entering the virtual reality environment. In another embodiment, the calibration processing is performed on each frame as it is captured prior to real-time removal of the HMD in the captured image which is then provided to a remote user in the virtual reality environment. The third stage 713 in FIG. 7 will be described in greater detail with respect to the flow diagram of FIG. 11.

Once the HMD removal module receives, in 1100, an input image of a user with HMD in the captured image, the image will be passed into two parallel channels: a first precapture image channel and a second live image channel. The precapture image channel illustrates the process related to one or multiple precaptured images. First, in 1101, the xyz positions and RPY orientations will be automatically generated from IMU sensor on the HMD device, and calibrated based on the IMU alignment described hereinafter in Section 6. The calibrated orientations will then be used in 1103 to search all of the precaptured image data obtained from the user for a precapture image that corresponds with the orientation in the live capture image. IN 1105, this image will then be cropped, resized and, in 1107, recolored to prepare for the image swapping processing in 1110. The recolor processing will be described in greater detail in Section 8.

According to the live image capture channel, a series of live images of a user wearing the HMD are obtained via image capture processing performed by an image capture device. These live captured images are processed to identify regions in the live capture image that include the HMD to extract that region from the live capture image and replace it with portions of the precaptured images based on the output of the precapture channel. In 1102, the HMD region is segmented and its bounding box is extracted based on trained machine learning model trained with images of different users wearing HMDs. This process is described in greater detail in Section 9. From the segmented area, in 1104, a candidate eye/nose region is determined, projected and inpainted into the HMD region based on the IMU orientation and the user-based 3D geometry configuration of head, HMD and camera discussed above in FIG. 10. This process is described in greater detail in Section 10. In 1106, an initial set of landmarks from the face region will be estimated as will be discussed in below and a secondary eye and nose region will be generated again, and the updated landmarks for the face region will be estimated in 1108. Note that the triangulation of these landmarks will also be generated to allow some 3D geometry operations. Given these updated landmarks and triangulation from the live channel and the returned image from the precapture channel, replacement processing 1110 is performed including one or more of three image region swaps are performed including head image swapping, facial expression swapping, and eye region swapping. After image processing that swaps at least one or all these three regions, an updated image is generated in 1112 whereby the HMD being worn and captured live will be removed having been replaced with the aligned precaptured images. This live output will be described hereinafter in Section 12 we will have the HMD removal version of live-time output image.

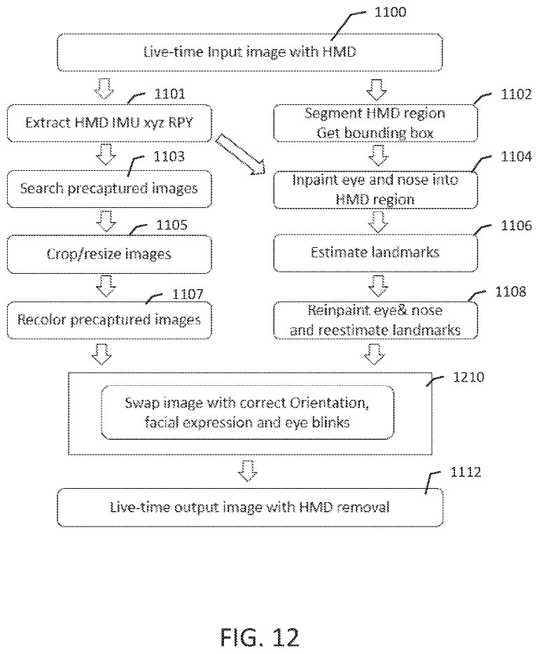

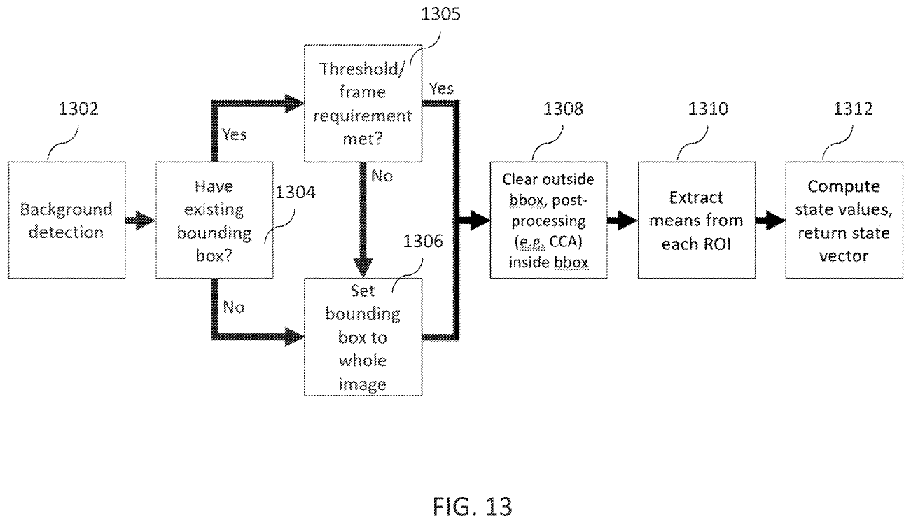

According to another embodiment, as shown in FIG. 12, a single swapping step is performed instead of three distinct swapping steps shown in FIG. 11. As such, the processing steps 1100-1108 remain the same and need not be further described herein. In this embodiment in FIG. 12, 1210 represents a single step to find one precaptured image with all correct information on head, facial expression and eye blink and eye gaze. In another embodiment, improved performance in terms of human perception may be achieved. As noted above, a search for an image of head with correct orientation was performed and then a face region thereof was replaced using another image with correct face action unit, and finally replace the eye region of the face using the third image with correct eye blink. The output of previous approach is a combination of three precaptured images. To further improve the quality of the image with respect to unnatural boundary appearances between head and face, as well as between face and eyes, this embodiment in 12010, searches for and locates single image with all correct information on orientation, facial action unit and eye blink using the determined parameters to use as the replacement image which decreases possible unnatural transitions between regions. Thereafter, processing as in 1112 is performed.

The above described real-time HMD removal algorithm advantageously replaces an HMD region of a face image with reasonable orientation, facial expression, eye blinks and eye gazes. This process, when performed in real time advantageously enables the user to appear to other users in the VR environment as if they are not wearing the HMD device that is needed enter and enjoy the VR environment. This provides a more authentic connection in VR between users such that the communication experience is immersive and connected. This advantageously uses image precapturing processing to collect one or more face images of a user without an HMD occluding a portion of their face. Orientation alignment is performed such orientation information associated with the HMD is transferred from the HMD to images. Configuration is performed to configure and align configuration of 3D models of a user's head, HMD and camera capturing images of the user wearing the HMD such that region swapping for head region, face region and eye region is performed to replace the HMD region of a live captured face image.

Part of the advantage of the HMD removal processing described above and in the subsequent subsections herein rely on successful transmission of both the data being used for the HMD removal processing but also information that aids a user wearing an HMD to be in desired position such that image capture by an image capture device can properly be performed and that the captured data is transmitting with manageable size to enable the real-time processing described in the present disclosure.

With respect to the ability to ensure the a user is in a desired position for image capturing of their image of them wearing the HMD, the present disclosure advantageously determines if and by how much a person has moved or is about to move into and out of the camera frame using an alpha channel. An alpha channel is an information parameter transmitted with each image frame that characterizes one or more aspects of the image frame associated therewith. According to the present disclosure, the alpha channel defines regions in the image frame that is associated with as being one of background or foreground image regions. For example, information in the alpha channel includes a binary representation where “1” indicates the pixel should be understood to be foreground while “0” indicates that the pixel should be understood background. Because the HMD removal processing is performed on the user wearing the HMD device, it is advantageous to the HMD removal algorithm to identify only the desired region, in this case foreground region containing the user in 2D image captured by the image capture device, on which HMD removal processing is to be performed.

According to the present disclosure, in some embodiments this may be derived from a background detection/segmentation network. In some embodiments this alpha channel may be further post-processed, e.g. using connected component analysis (CCA), to filter out any small false positive regions, selecting only the largest connected foreground region to be the detected mask of the person. In other embodiments, post-processing, e.g. in a video context, may include the extraction of a bounding box from the alpha channel, outlining the detected foreground object in one frame. In the following frame, this bounding box (which in some embodiments may be scaled up by a fixed or adaptive factor) may serve as a starting point to only perform CCA within the bounding box, automatically marking the rest of the frame as background and thus improving the speed and robustness of the algorithm. In the case there are multiple similarly sized foreground objects in frame, CCA may jump from one to the other if the full frame is analyzed, but with the restriction to only focus in the (expanded) bounding box from the previous frame, CCA jumping will be reduced, instead tracking the first object detected. If at any point the bounding box shrinks below a certain threshold, or in some embodiments simply after a specific number of frames, the bounding box may be reinitialized to cover the entire frame so that CCA does not become “stuck” tracking a single foreground component when other, larger components may exist outside of the bounding box.

FIG. 13 illustrates an exemplary algorithm for the above described algorithm. In 1302, a captured image frame is input and background detection processing is performed to identify a region of interest (e.g. foreground object) and a background region that is a region of the frame that includes everything other than the foreground object. In 1304, a query is performed on the received image frame to determine if a bounding box surrounding a foreground object is present in the frame. If the result in 1304 indicates that no bounding box is present, the algorithm automatically sets, in 1306, a bounding box having dimensions of the input image frame. If the query in 1304 is positive indicating that a bounding box is present in the input frame, the query in 1305 is performed to determined if a threshold is met. In one embodiment, the threshold indicates a size of a bounding box. In another embodiment, the threshold is whether the algorithm has received a predetermined number of input frames. In a further embodiment, the threshold can be set to determine the size of the bounding box and that a certain number of frames have been received and processed by the algorithm. If the result of the query in 1305, is negative, processing proceeds to 1306 where a bounding box is generating having a size substantially the size of the input frame. If the query in 1305 is positive or if a bounding box is set to the size of the frame, processing proceeds to 1308. In 1308, the process, such as CCA, will be conducted only in an expanded region associated with the predefined set bounding box. Any outside region will be ignored to improve the processing speed. Once the foreground is reliably extracted, we then move to 1310 and 1312, which is described in the section below.

The alpha channel, at this stage will identify a foreground and a background region, either with continually varying opacity (e.g. 0-255 if the image is stored as an unsigned 8-bit integer array or 0-1 if the image is stored as an array of floating point numbers) or as a binary mask, 1 in the foreground and 0 in the background. If the alpha channel is not a binary mask, it may be converted into one by selecting a threshold delimiting the foreground from the background (e.g. all pixels with alpha>128 are foreground).

In 1312, the algorithm computes a state vector for a given frame as a collection of four state values, each between 0 and 3, describing the degree to which the user is to the left of the frame, right of the frame, too close to the camera, and too far from the camera. In some embodiments these state values are restricted to discrete values such as integers, which can then be interpreted as discrete states. For example, if the state value identifying the degree to which the user is on the left side of the frame is binned into the integers 0, 1, 2, and 3, these may be identified as 0=“not left at all”, 1=“slightly left”, 2=“moderately left”, 3=“extremely left”, or similar categories. Action may then be taken based on these state values, including but not limited to causing a message to be displayed on a graphical user interface (GUI) of the HMD device (or other device visible to the user). In another embodiment, response to the state vector altering the functionality of the application, etc.

The processing associated with computing the state vector will now be described. For each state value, we define a region of interest (ROI) in the frame wherein we calculate the average proportion of foreground pixels in the ROI. This ROI is fixed for each value in the state vector. In some embodiments, this value is defined by a fixed number of rows/columns/pixels while in other embodiments it is defined by a fixed percentage of rows/columns/pixels in a specific part of the frame.

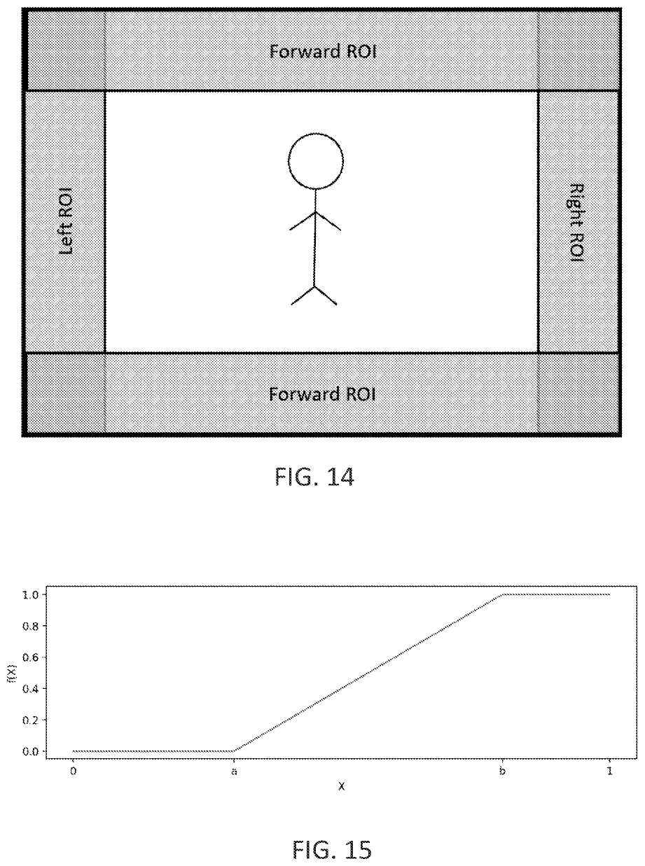

For example, we may define the region of interest (ROI) for determining the degree to which the user is on the left side of the frame to be the leftmost 10 columns of the frame. Similarly, the ROI for determining the degree to which the user is on the right side of the frame may be the rightmost 10 columns of the frame. For determining the degree to which the user is too far forward, we may define an ROI to be the top 10 and bottom 10 rows, or some combination of them, e.g. the logical OR of the two separate ROIs, containing a binary 1 when either the corresponding pixel in the top 10 rows or the corresponding pixel in the bottom 10 rows is a foreground pixel. For the degree to which the user is too far backward, an ROI might be the entire frame. This is illustrated in FIG. 14 whereby each of the labeled ROIs are assigned a state value that will be used to understand the user's position within the frame and provide feedback in guiding the user to be in a desirable position within the frame for successful image capturing and subsequent HMD removal processing on the captured 2D image.

In exemplary an embodiment, and as described in 1310, the state value, s, can be calculated from the mean proportion, M, of foreground pixels in the ROI according to the following equation

$$M = \frac{1}{P} {\sum }_{p ∈ ROI} p \qquad ( 1 )$$

where P is the total number of pixels in the ROI and p is the binary value of each pixel (1 if foreground, 0 if background). This mean is then mapped to the interval [0,3] based on a beginning and an ending threshold, a and b respectively, for each state value. A function ƒ(x) which is zero when x is less than a, 1 when x is larger than b, and linearly scales from 0 to 1 between x=a and x=b is defined as

$$f ( x , a , b ) = \{ \begin{matrix}0 , & x \leq a \\ \frac{x - a}{b - a} , & a < x < b \\ 1 , & x \geq b\end{matrix} \qquad ( 2 )$$

then the following is computed

$$s ( M ; a , b ) = 3 \cdot f ( M ; a , b ) \qquad ( 3 )$$

for each of the left, right, and near state values. For the far value, since it is desired to have s(0)=3 and s(1)=0, the reverse of the other state values (i.e. the user is too far if the number of foreground pixels is very small), s(M)=3ƒ(1−M) is defined in this case and plotted in FIG. 15.

In another embodiment, certain state vector information may be obtained using one or more sensors on the HMD device. In this embodiment, a context in which the person being tracked is wearing a head mounted device (HMD) or other device containing an inertial measurement unit (IMU) with position data, the algorithm utilizes the IMU to perform the out-of-frame detection after an initial alignment step (discussed hereinbelow) wherein the IMU coordinates are transformed into the camera axis coordinates, and after a detection of the initial distance the user is from the camera as described below. Using this information, the user's position can be accurately tracked in three dimensions and a check can be performed for when the user leaves the frustrum of the camera viewport.

In addition to using information contained in the alpha channel associated with a captured image to ensure proper position within the image frame, additional control is performed to direct a user wearing the HMD to properly face the image capture device capturing the image on which HMD removal processing is to be performed.

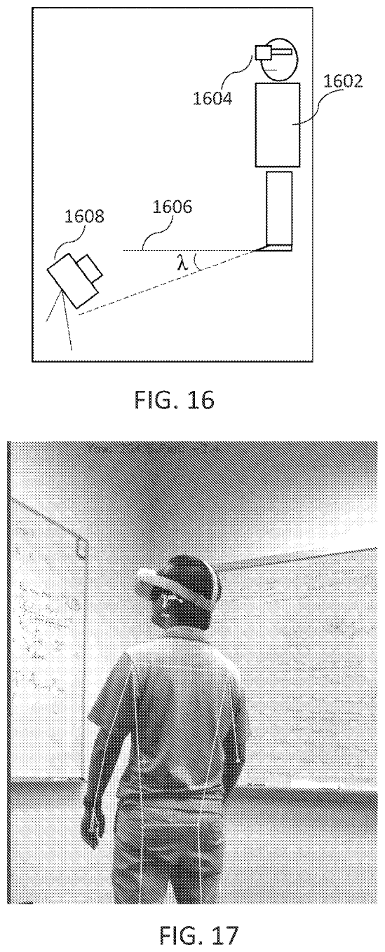

In order to perform image capturing of a user wearing a headset such that they can enter and interact with a virtual reality environment, the user, with the headset positioned over their eyes, needs to stand facing substantially in the field of view and in a direction that faces the camera to initialize any forthcoming procedures such as IMU alignment (described below). The user's pose orientation is estimated from that initial capture and then be used to guide the user's pose adjustment during interaction in the virtual reality environment. The most critical angle for this purpose is the yaw angle of the body pose relative to the camera as shown in FIG. 16. In FIG. 16, a user 1602 wearing an HMD device 1604 is shown standing on a surface such as the floor 1606 in the field of view of an image capture device 1608. The angle illustrated by λ is an angle of the user relative to the image capture device. The value of/will be used by the algorithm to correctly instruct the user on what movements to make in order to be in the desired position.

A human pose skeleton estimator is executed to estimate the body joints of the user that include, for instance, shoulders, hips, elbows etc. These estimated joint positions are represented with x, y, z coordinates in a predefined coordinate system. Here, the area of interest is in the pose orientation relative to the camera so the joints' coordinates need to be transformed into world-centric coordinates.

Next, the orientation of the upper body is estimated. To do this, the human upper body is approximated as a plenary surface which is used to estimate the orientation of the surface normal relative to the camera. All joint coordinates are projected onto a normal vector and the summed residuals are minimized. The normal vector that manages to minimize the summed residuals is the normal vector used to then compute the angles. In exemplary operation, a predetermined number of joints such as the shoulders and the hip yields satisfactorily accurate angle estimate. In this case, the normal vector is calculated by taking the cross product of any of the two vectors connecting the three joints (two shoulder plus the hip). This angle is used to guide the user to face substantially in the direction toward the direction of the camera. An example of this is illustrated in FIG. 17 which illustrates the user having their back facing the camera, indicated by the yaw angle of 204.8 degrees (180 degrees means facing exactly opposite the camera). In this case, the algorithm will control a display of the HMD to guide the user to turn accordingly.

Turning back to the HMD processing described in FIG. 7, the following sections referenced therein will be discussed in more detail. Each of these sections describes specific algorithmic processing steps performed in order to obtain the desired output which is then used in the real-time HMD removal processing. The following begins with the description of aspects of the precapture processing 700.

### Section 4: Video-based Facial Action Unit (FAU) Detection

Facial action unit (FAU) detection is a difficult task in computer vision. Most existing detection models attempt to determine expressed FAUs of a single image. In some contexts, such as video recordings, multiple images of the same subject are present, which are often underutilized. One type of dataset used to train FAU detection models is BP4D, which contains labels for many FAUs. However, some FAUs are more prevalent than others in the dataset, and many are present only in a small fraction of the images in the dataset. This leads to an imbalanced data problem, which can skew training results and degrade overall performance. This is particular problematic in context of the present HMD removal algorithm because, in order to replace an image of a user wearing an HMD, it is important to make sure the image selected for replacement includes the correct FAU that were expressed in the precapture image as compared to the live capture image.

Some embodiments of video-based FAU detection include at least four components. The first component is a tool to infer a standard set of facial landmarks from a given frame (image) of video. Examples include Mediapipe's Face Mesh, Google's MLKit, or dlib's facial landmark detector. A larger number and therefore higher resolution of facial landmarks usually improves performance, so Mediapipe's set of 468 landmarks may provide satisfactory results. The second component is a framework to record multiple frames' detected facial landmarks so that cross-frame comparisons can be made. The third component is a “canonical” face, which contains the facial landmarks of a standardized, forward-facing, neutral face, to which all collections of detected landmarks can be compared and analyzed. This face may be person-specific (e.g., an average of normalized landmarks detected in multiple images of the same person) or generic (e.g., some “typical” 2D or 3D model of a human face). The fourth component is a classifier or collection of classifiers that accept features derived from landmark coordinates as inputs and that output a binary classification for a single FAU or for multiple FAUs with a shared architecture. Some embodiments of the fourth component contain support vector machines (SVMs), some contain artificial neural networks (ANNs), and some use another applicable type of classifier or classification algorithm.

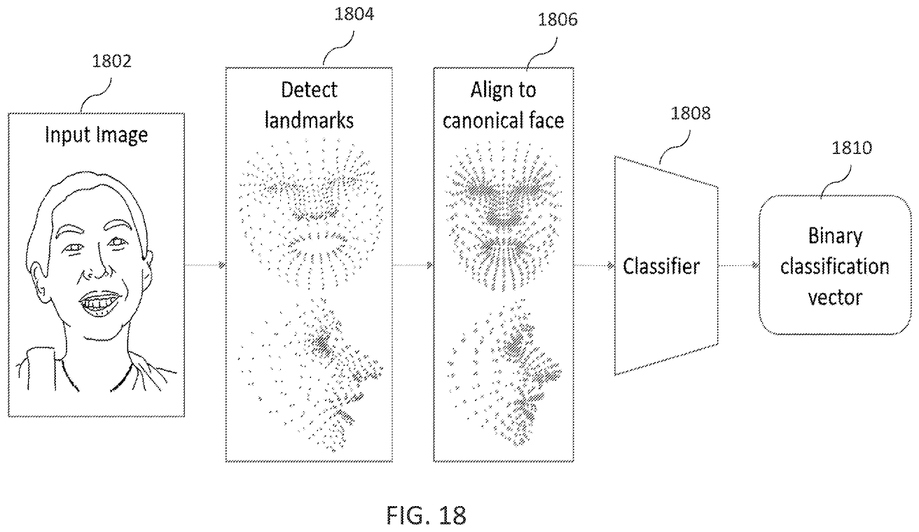

As noted above, one feature of these embodiments is the use of a “canonical” face to augment the detected facial landmarks. An exemplary process for alignment is illustrated in FIG. 18 whereby an input image of a human face 1802 is provided and landmarks of the human face are determined, in 1804, in one or both a front facing orientation and one or more side orientations. These determined landmarks are aligned to a canonical face in 1806 and provided to train a classifier 1808 which outputs a binary classification vector in 1810.

Because every person's face has a unique shape and characteristics, just using raw landmark coordinates may not adequately account for natural variations in the population. Because using the displacements of the landmarks from points of reference (e.g., the points of reference may be locations of the landmarks while the face is in a “rest” position) may produce better results than using the absolute detected locations of the landmarks, some embodiments of the classifiers are trained using the coordinate differences between (i) the landmarks in the canonical face and (ii) versions of the detected locations of the landmarks that have been normalized and aligned to the canonical face.

For example, some embodiments of the canonical face landmarks can be described (or otherwise defined) as a set of two- or three-dimensional coordinates,

$${\{ {c}_{i} \}}_{i = 1}^{N} ,$$

where N is the number of landmarks able to be detected for each face. The landmarks detected from the input image may be described as a set that has the same number and that has the same dimensionality of the coordinates,

$${\{ {l}_{i} \}}_{i = 1}^{N} .$$

To align the detected landmarks to the canonical ones, both may first be zero-centered and normalized to a unit standard deviation. For example, if μₗ and μ_{c} are the mean of all detected and canonical landmarks, respectively, and if σₗ and σ_{c} are the corresponding standard deviations, then the zero-centered and normalized landmarks may be described by (and may be calculated according to) the following:

$$\begin{matrix}\hat{{c}_{ι}} = ( {c}_{i} - {μ}_{c} ) / {σ}_{i} , and \\ \hat{{l}_{ι}} = ( {l}_{i} - {μ}_{l} ) / {σ}_{i} ,\end{matrix}$$

where [symbol] is the zero-centered and normalized canonical landmark, where [symbol] is the zero-centered and normalized detected landmark, and where the division is done componentwise. Then some embodiments generate a linear transformation matrix M that maps the detected landmarks onto the canonical ones. For example, some embodiments of the linear transformation matrix M can be described by (and may be calculated according to) the following equation:

$$M = arg {min}_{A ∈ {ℝ}^{3 \times 3}} {\sum }_{i = 1}^{N} {‖ A \hat{{l}_{ι}} - \hat{{c}_{ι}} ‖}^{2} \qquad ( 4 )$$

Equation 4 represents, a least squares regression, which selects the transformation that minimizes the mean of the square of the norm of the difference between the coordinates of the normalized detected landmarks after applying the transformation and those of the normalized canonical landmarks. Then the transformed features of each landmark, features

$${\{ M {l}_{i} - {c}_{i} \}}_{i = 1}^{N}$$

may be input to the classifier (e.g., input one by one). In other words, the features of all landmarks are combined as the input to the classifier, representing the entire face at once, not landmark by landmark (1808).

In a similar manner, some embodiments may use other features besides the raw landmark coordinates, such as cosine similarity measures for all edges in a face mesh, interior angle measures for each triangle in a mesh, or any concatenation of the above. And embodiments that use these features may use the differences of features between the input face and the canonical face.

In embodiments that identify FAUs in a single image of a person's face (facial image) for which they do not and will not have access to other facial images or preconfigured 3D models of the same person, the canonical face may be a generic 3D model of a human face, for example the canonical-face model in Mediapipe's Face Mesh. Other embodiments may have access to a prerecorded collection of facial images. In these embodiments, the alignment procedure can be employed to align all the facial images in the collection to a generic 3D model of a face, then use the average of all facial images as the canonical face. This has the added benefit of being person-specific and generally leads to better results than using a generic model for the canonical face.

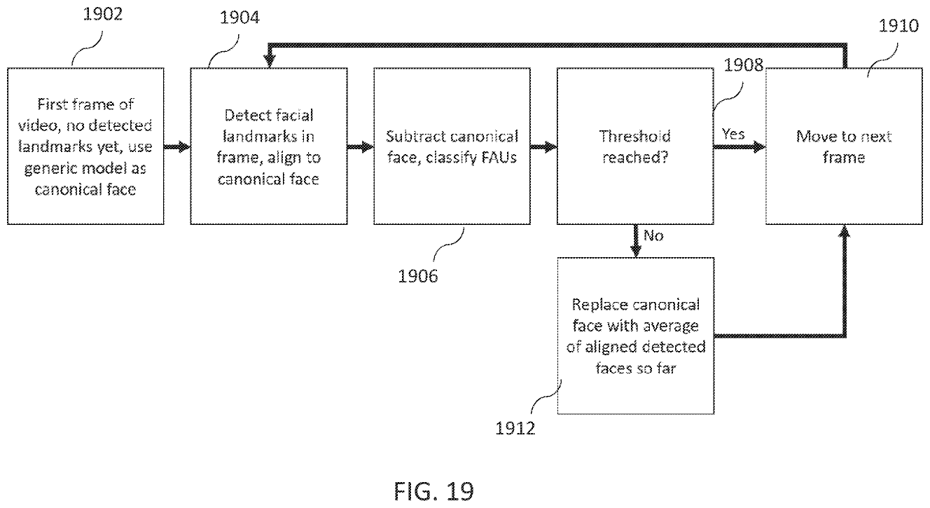

FIG. 19 illustrates an exemplary algorithm that is used to determine the canonical face according to the present disclosure. In 1902, a first frame of video data is received without any facial landmarks detected on that received image frame and it is determined to use a first canonical face which is a generic canonical face as described above. In 1904, FAU landmark detection is performed on the received input image and the detected landmarks are aligned with the generic canonical face. From there, in 1906, the canonical face is subtracted and the results are provided to a trained machine learning classifier (e.g. neural network) to classify FAU's based on the aligned landmarks. In 1908, after classification, a determination is made whether a threshold number of frames have had the FAUs classified. If the result of the determination in 1908 is positive, the algorithm proceeds to analyze a next image frame in 1910 which then reverts back to 1904. In a case where the determination in 1908 is negative, the canonical face used in 1902 is updated, in 1912, with an average alignments detected thus far until the threshold number of alignments have occurred. After updating the canonical face, processing proceeds to 1910 for the next frame.

Some embodiments detect FAUs in a video context where they do not initially have access to multiple facial images of the subject but, with each new frame that is obtained, can derive a collection of multiple person-specific facial images that are added to a collection (see 1906-1910). These embodiments may begin with a generic model for the canonical face (1902) and compute a person-specific average face after reaching a given threshold of facial-image frames. Alternatively, a continuously adapting process may be employed, whereby an initial image is the canonical face being a generic model, and each new facial-image frame that is processed is averaged with the existing canonical face to produce a new canonical face for processing the following facial-image frame(s). In some of these embodiments, a threshold for the maximum number of facial-image frames to be averaged for the purpose of generating a canonical face may be set as shown in FIG. 19. The original generic model may or may not be retained in the cumulative average canonical face. The threshold here is the maximum number of faces to average. Before the threshold is reached, a current face is added into the average before moving to the next frame (1912). After the threshold has been reached, modification of the average is stopped and use what we have for the remaining frames.

### Balancing the Training Dataset

There are many existing data sampling and augmentation methods to help balance the positive/negative labels in a single-label dataset. As described herein, the labels indicate the presence or absence of expression of each FAU in a given image. For each image in the dataset, the label is a list of binary yes/no indications for all FAUs. More generally, the labels of a dataset are the target variables, i.e., the thing you want the model to predict. However, these methods may not be effective when the dataset contains multiple labels for each sample, as is the case for the BP4D dataset, which is often used to train FAU classifiers. Thus, embodiments of at least one of the following two methods may be used to balance a multi-label dataset to improve training performance. Both methods use under-sampling to build a training set but differ in how each sample is determined given past selections.

### Most-Imbalanced-Class Embodiments

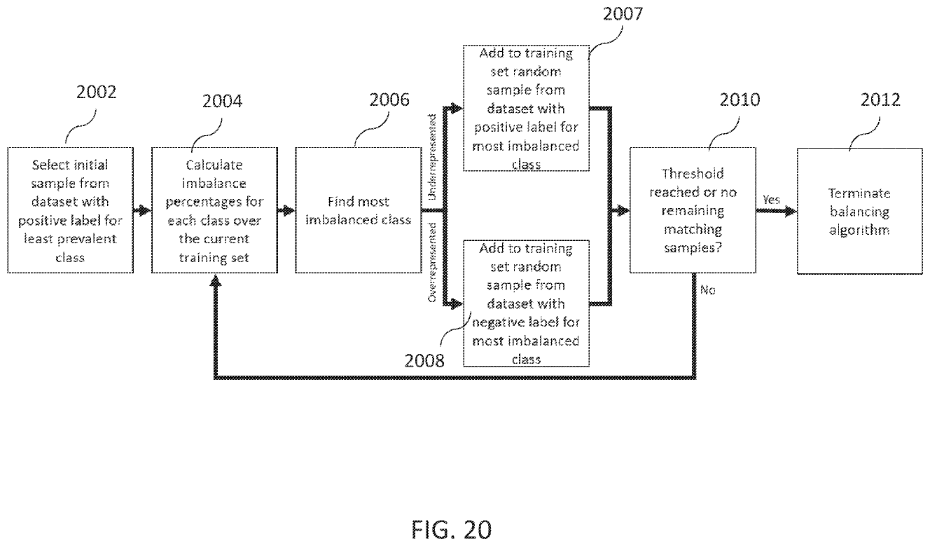

On exemplary balancing algorithm is illustrated in FIG. 20. This first method prioritizes the most imbalanced class (which is the class with a percentage of positive samples farthest away from 50%), with classes having larger than 50% prevalence being over-represented and those with less than 50% prevalence being under-represented. “Class” here refers to each FAU individually. For example, if 90% of images are labelled as expressing FAU12 and only 10% are labelled as NOT expressing FAU12, we say the FAU12 class is imbalanced. A perfectly balanced class is one where 50% of the samples (i.e. images) are positively labelled and 50% are negatively labelled. To begin data selection for the training set, embodiments of the first method select, in 2002, first a single random sample that has a positive label for the least prevalent class. Then, until a threshold (e.g., a user-defined threshold) on the number or percentage of samples is met, or until it is no longer possible to choose a sample meeting the criteria, the first method selects the next training sample accordingly.

In 2004 and 2006, the most imbalanced class in the dataset is determined by calculating the prevalence of positive samples for each class in the already selected training set and selecting the most over- or under-represented class. If the class determined in part (1) is over-represented, select, in 2008 a sample from the dataset that has a negative label for this class but if the class is under-represented, select, in 2007, a sample from the dataset that has a positive label for this class. If no such sample exists in 2010, repeat 2004-2008 with the second most imbalanced class. If no such sample exists again, repeat with the third, fourth, etc., most imbalanced class until a matching sample is found. If no such match can be found for any class, terminate the balancing process 2012.

### Hamming-Distance Embodiments

The first method illustrated in FIG. 20, considers only the most imbalanced class for each selection. However, when making a selection based only on this, it is possible that the sample chosen may have labels for other classes, which further exacerbate their imbalance percentages. For example, if the most imbalanced class is under-represented, a sample that has a positive label for that class is selected. If the positive labels for that class are correlated with the labels for another class (e.g., in the case of FAUs, this would mean that certain action units are often co-expressed), selecting a sample with a positive label for the most imbalanced class may inadvertently increase the imbalance percentage of the correlated class.

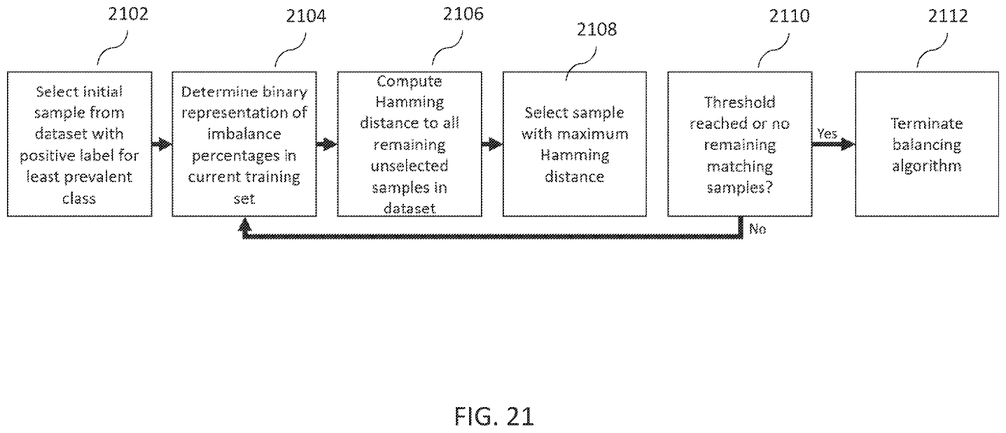

To remedy this issue, embodiments of the second method illustrated in FIG. 21 incorporate selection criteria based on the Hamming distance from information theory. Assuming that the current positive prevalence of each class in the selected training set is a string of binary bits where 0 corresponds to an under-represented class (prevalence less than 50%) and 1 corresponds to an over-represented class (greater than 50%), these embodiments compute the Hamming distance to a similar binary representation of each sample (while the present disclosure uses a facial image as the same, the present balancing method works for any type of data set with multiclass labels) in the remaining unselected dataset (0=negative label, 1=positive label), and select next the sample that has maximum Hamming distance to the current training dataset. This ensures as best as possible that each new selection does not inadvertently increase the imbalance percentage of any classes. This processing includes selecting an initial sample from a dataset with a positive label for a least prevalent class in 2102 and determined the binary representation of imbalance percentages in the current training set in 2104. In 2106, the hamming distance to all other unselected samples is computed and in 2108 the sample with the maximum Hamming distance is selected. In 2110, a determination is made as to whether a threshold number of samples are calculated and selected and, if the determination is positive, the algorithm terminates in 2112. If the determination in 2110 is negative, processing reverts back to 2104 and is repeated until the threshold is met.

FAU detection with a canonical face allows for the use of differential information to determine facial expressions rather than using raw coordinates. This has the benefit of better accounting for variations in facial structure among people. Furthermore, the balancing methods provide a better procured dataset, which further improves training performance. This advantageously provide the ability for the model used to determine which of the precaptured images are selectable for a given HMD removal in a given frame using relative/differential features for detecting facial action units (FAUs), video-based FAU detection; and balancing multilabel datasets using under-sampling to further improve the training set of the model that will be used in the HMD removal processing.

Continuing now with the description of the processing performed during the precapture stage 700, the ability to determine and simulate eye blink and gaze will be described.

### Section 5: User Based Eye Blink Simulation and Eye Gaze Generation

As noted above, in augmented/virtual reality, a user wears a HMD device to experience virtual reality. When a user wants himself to be seen by others in virtual reality, a camera positioned in front of the user captures the user's image. However, because of the HMD device the user is wearing, others won't see the user's entire face since the upper face is blocked by the HMD device. To allow the visibility of the entire face, a HMD removal as described herein is often conducted on the HMD region in the user's HMD face image. Generally, the HMD region can be replaced with some precaptured images or artificially generated images. During this replacement, it is difficult to determine the truth of the eye region since the eye region is fully blocked. The algorithm described herein remedies this drawback by generating a sequence of images with natural perception of eye blinks and eye gazes.

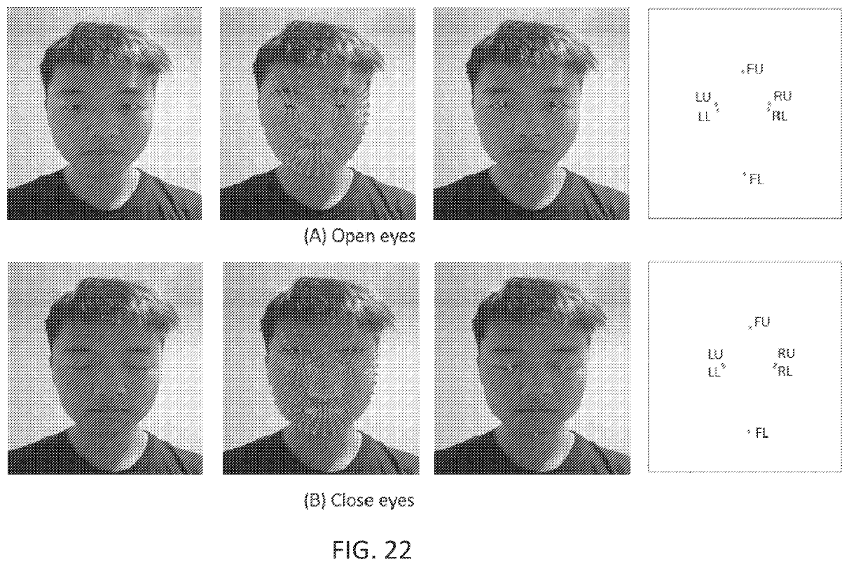

Eye blink and eye gaze data is collected from the user during the precapture stage of the HMD removal algorithm in section 3. This advantageously enables the system to artificially generate eye blink and eye gaze images with natural perception. Eye information collected includes, but is not limited to frequency of eye blinks indicative of how often there is a blink, a blink interval indicative of time between two neighboring (successive) eye blinks, magnitude information indicating how wide our eyes open and close. This eye information is collected using an eye blink indicator module. The design and operation of the eye blink indicator is shown in FIG. 22.

For each face captured, landmarks representing an upper lid and lower lid of both left and right eyes are determined and located and a distance of upper lid and lower lid against the distance of the height of an entire face is measured. As can been seen in the first columns of both (A) and (B), two images are shown, one with open, and the other with eyes close. Facial landmarks are estimated using a facial characteristic library such as Mediapipe. The landmarks obtained for the whole face are shown on the second columns of each of (A) and (B). Once all the face landmarks are determined and collected, landmarks related to the features of an eye blink are identified. For example, four landmarks representing upper and lower eye lids, two from left and two from right, and two landmarks representing the height of face are located. In detail, a predetermined number of landmarks from each eye are selected to represent the eye to determine and obtain eye information. As shown herein, four landmarks are selected from both left and right eyes, two from left eyes containing LU (left upper) and LL (left lower) and two from right eyes containing RU (right upper) and RL (right lower). Additionally, a predetermined number of face landmarks are obtained representing the upper face and lower face of the entire face. These are indicated as FU (face upper) and the other shown as FL (face lower). The predetermined number of eye and face landmarks are described for purposes of example only and any number of landmarks may be used in this processing depending on computation time and power of the processing device executing the algorithm. An eye blink indicator is defined using the distance between the landmarks of upper eyelid and lower eyelid and the height of face, or the distance from Upper face to the lower Face.

The eye blink indicators can be represented using equation the following

$$left eyeblink inicator = ( LU - LL ) / ( FU - FL ) * 100 \qquad ( 5 )$$

$$right eyeblink inicator = ( RU - RL ) / ( FU - FL ) * 100 \qquad ( 6 )$$

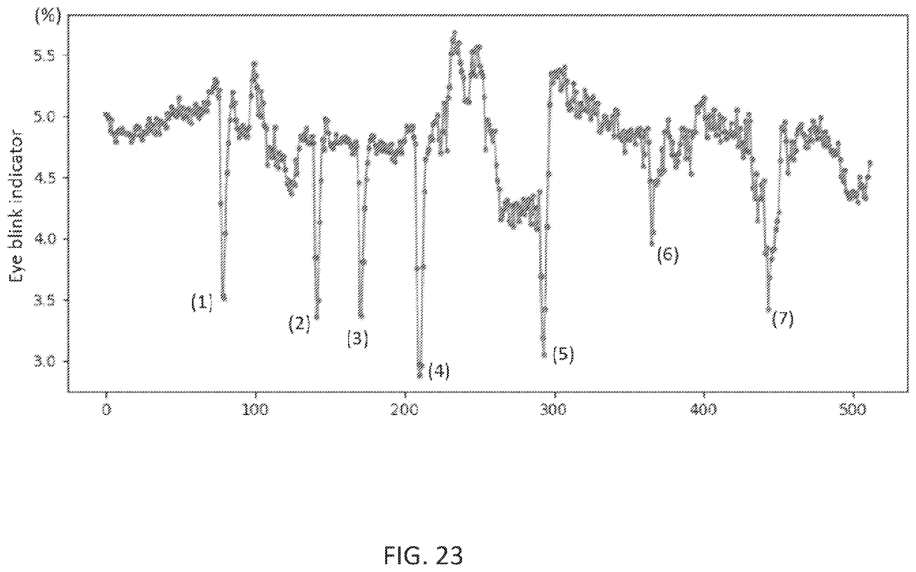

The eye blink indicator is scaled in order to identify a range of positions of the eyes. By multiplying the distances by 100 to scale the indicator into a range from 0 to 100. This scaled determination is graphically illustrated in FIG. 23 which represents an eye blink indicator executed on a series of 512 video frames. FIG. 23 illustrates the eye blink indicator from the left eye for a video over a predetermined number of frames, here it is over 512 frames. As can be seen herein, the eye blink indicator values vary from 6.0 to 3.0 for this user based on a percentage of the whole face. Note that 6.0 here means the distance between upper and lower lids is 6 percent of the whole face height. Based on the observation, when the user opens the eyes, the percentage of upper and lower eye lid distance is around 5 percent, and when the user closes the eyes, the percentage of upper and lower eye lid distance is around 3.5 percent. As shown herein, the blink indicator successfully identified seven eye blinks found in these 512 frames indicated by the numbers adjacent to the plot line in FIG. 23.

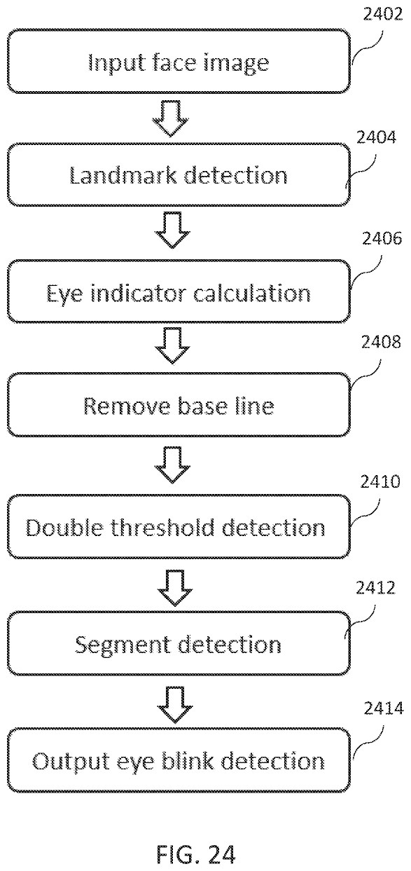

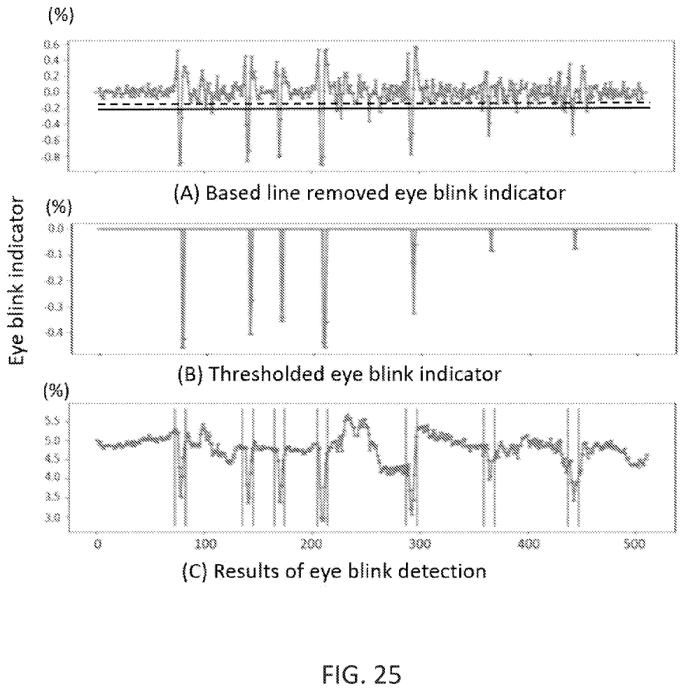

FIG. 24 is a flow diagram that describes the eye blink detection algorithm used in generating the plot line above and which is used as part of the HMD removal algorithm according to the present disclosure. In 2402, a face image is obtained and provided to a landmark detection model in 2404 to detect all facial landmarks present in the obtained image. Upon determining all of the face landmarks present in the image, eye blink indicators are calculated in 2406. The calculated eye blink indicator results are provided, as an input, to eye blink detection process which will be described with respect to FIG. 25.

The eye blink detection process includes three stages. A first stage, in 2408, performs processing to remove the base line of eye blink indicator which removes big or sharp changes between eye open and eye close. The base line is first estimated based on the moving average of eye blink indicators at a predefined windows. A practical example could be 60 frames or 2 seconds if the frame rate per second is 30. We then subtract the baseline from the raw data, and the results of base-line removed eye blink indicator is shown in (A) in FIG. 25. The baseline removed indicator is applied against two thresholds in 2410. A first threshold is shown as the solid line and enables a reliable detection of eye blink. The second threshold is illustrated as the dashed line and enables reliable effective detection of the duration of an eye blink. A higher threshold for eye blink detection is used because it will not easily be compromised by the remaining baseline noise, and a lower threshold for duration determination to ensure coverage for a little wider of the eye blink segment for eye region swapping. The results after applying threshold processing is shown (B) of FIG. 25. Given the results in (B), a segment detection algorithm is applied, in 2412, to identify all segments of detected eye blinks. The segment detection algorithm works by first identifying each negative transition from zero to negative and each positive transition from negative to zero, and then pairing every two corresponding transitions, one from positive and one from negative into one segment. As shown in (C), the algorithm successfully identified all seven eye blinks in the input video as outputs in 2414. Once the eye blinks from a sequence of images are identified, the algorithm obtains and collects statistical information of features that are representative of an eye blink. A first feature is a time interval between two neighboring eye blinks and a second feature is a duration of an eye blink. Note that these two features will determine what should be the time to generate the next eye blink and how long the generated eye blink should last.

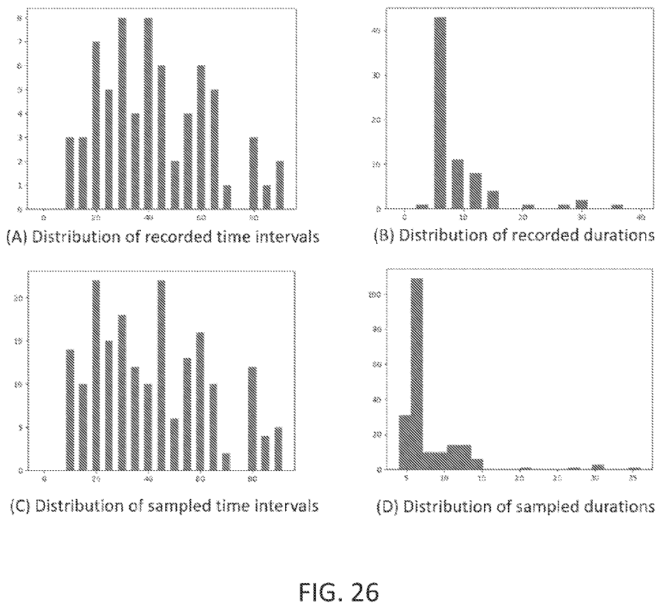

FIG. 26 illustrates histograms of artificial generation of a new sequence of user's eye blink according to the present disclosure. In histogram (A) and (B) the first and second features based on 71 eye blinks identified by the blink indicator is illustrated. It is important to note that different users might have different histogram values depending on their nature eye blinking patterns and is there user dependent. In operation, the algorithm simulates eye blinks of a user by ensuring that simulated eye blinks align with the statistical information we collected from the user in advance, generally during the precapture stage described above in Section 3. The time interval and duration for each simulated eye blink is determined by sampling them from the distribution of the real collected data. Histograms (C) and (D) show the distribution of time intervals and durations from 200 sampled eye blinks. While the above description includes the first and second features described above, this is merely exemplary and other features may be used instead or in conjunction with the first and second features. Other features that may be used in simulating eye blinks include but are not limited to eye blink magnitude, the correlation between two neighboring eye blinks or any other higher order statistical information related to eye blinks.

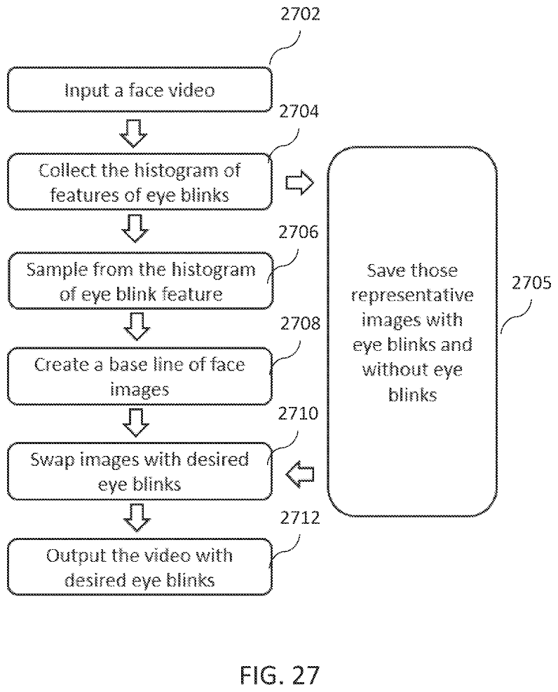

Upon determining the time interval and the duration for each eye blink, a sequence of images are artificially generated with expected eye blinks from user as shown in FIG. 27. Given an input video 2702, all eye blinks are detected and histograms of those eye blink related feature are estimated in 2704. Based on the eye blink features, an image preselection process is performed where certain images are preselected and saved where a portion of the preselected images include eye blinks and another portion of images are without eye blinks in 2705. These preselected images will be used for our eye gaze generation described hereinafter. A population of these eye blink features are generated by sampling from the histogram of real experimental data in 2706. Any preexisted sequence of frames are located. Alternatively, some segments of frames are or artificially collected. These sequences are combined together as a baseline sequence of images in 2708. This baseline will be swapped, in 2710, with our prerecorded image with desired eye blink or no eye blink from 2705. After the swapping, a video of face images with desired eye blinks, either blink or no blink, is generated and output for display in 2712.

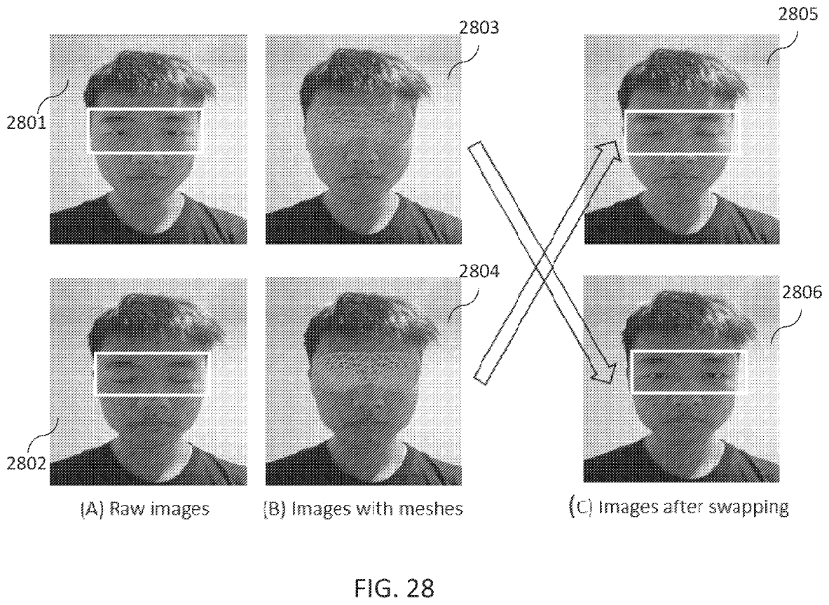

The swapping and generation of the output image will be discussed with respect to FIG. 28. To swap the eye region of two images, meshes of eye region as shown in FIG. 28 are obtained. Here two images are used, one with eye open 2801 and the other with eye closed 2802 shown in column A of FIG. 28. Given two input images, landmarks representing an eye region are obtained via estimation processing using a trained machine learning model along with the meshes (e.g. triangles), associated with these landmarks. The results of the estimation processing are shown in images 2803 and 2804 in column (B) of FIG. 28. Since those triangles estimated from two images are related to each other, pixels from respective triangles can be swapped in each triangle between two images based on their corresponding positions. The results are shown in column (C) of FIG. 28. The result advantageously enables the output image to have the eyes open even if the raw image has eyes close as shown in 2806 or have the eyes closed even if the raw image has eyes open as shown in 2805.

The eye blink detection algorithm advantageously detects, from an input image, the presence or absence of an eye blink such that features associated with the eye blink and face image are collected and used to artificially generate a video of a user with the natural perception of eye blinks by simulating a sequence of eye blinks that are naturally perceptible to the human mind and swap eye regions between two images such that it appears to a user viewing the image that the person in the image is blinking naturally even if, at the time the image is being captured, the user is not blinking.

Sections 4 and 5 described respective algorithms used to identify and process precapture images during the precapture stage 700 from FIG. 7. Once sufficient processing in accordance therewith is performed, these images can be used as source images for use in replacement processing that will be described hereinbelow. As a first part of the removal pipeline, configuration processing must occur such that the images being captured by the image capture device and the images being displayed to users in the HMD are properly correlated. This begins in Section 6 which describes time shift alignment processing between images in the HMD and one or more sensors of the HMD.

### Section 6: Time Shift Alignment Between HMD Images and HMD IMU Data

Turning back to the second stage of the HMD removal algorithm from Section 3 whereby real-time HMD removal is being performed, a first step associated therewith is alignment processing between the HMD images and Inertial measurement unit (IMU) data obtained from the HMD. Given video frames of a user with a virtual reality (VR) headset and the headset's positional and orientation data provided by its inertial measurement unit (IMU) sensor, it is desirable to accurately paste (or otherwise replace) an image onto the user. This requires calculations that rely on accurately detecting the headset in the video frame and the orientation of the headset according to its IMU data. These two sets of data need to be aligned well or it could result in the image being pasted into the correct location but at the wrong orientation or vice versa. The issue with this is that the sets of data come from different devices without any means of ensuring that each sets corresponding data is correctly aligned. This is even the case if all data is provided with timestamps because the clocks on the two devices are not guaranteed to be synchronized. The alignment algorithm uses two separate approaches to estimate the offset: estimation using cross correlation and estimation using mutual information.

Both methods require a predetermine number of frames of video data to calculate the offset. In one embodiment, at least a couple hundred frames are used to accurately estimate the offset. Calculations can be done with between 200 to 1,000 frames but are generally done somewhere in the middle at about 600 frames to maximize accuracy and time spent sampling. A larger number of frames means that while the sample frames are collected there will be no offset correction. Thus, with 600 frames at 30 frames per second, there will be no correction applied for at least 20 seconds until the estimation is done. While a larger sample is meant to help ensure there is enough data to analyze, the effectiveness can be tested using sample frames as will be discussed hereinbelow.

Every video frame will be accompanied by IMU data including the positional X, Y, and Z of the headset as well as its pitch, yaw, and roll. This IMU data will be our first set of data. Inside the video frame, a bounding box around the headset is detected, and the coordinates of this bounding box are used as our second set of data (this implies that only frames where the headset can be detected are viable for both approaches). The IMU data is matched to a video frame by its timestamp. However, there is no guarantee that the times from the video and IMU are aligned. The following solutions will use the movement described by both data sets to estimate an offset that will synchronize the two sets of data.

A first alignment processing used herein is based on cross correlation. Cross correlation compares specific signals from each set of data. Specifically, it compares signals that should have greater correlation with each other. This is more often true when comparing the IMU's pitch reading with the Y coordinate of the headset's bounding box in the video frame. As a user tilts their head up or down while looking through the headset, the headset will also move up or down in respect to the video frame. For the same reason, comparing the IMU's yaw and the bounding box's X coordinate works just as well. Depending on the movement of the user, using the IMU's positional X or Y may also be a viable option for narrowing down the estimation.

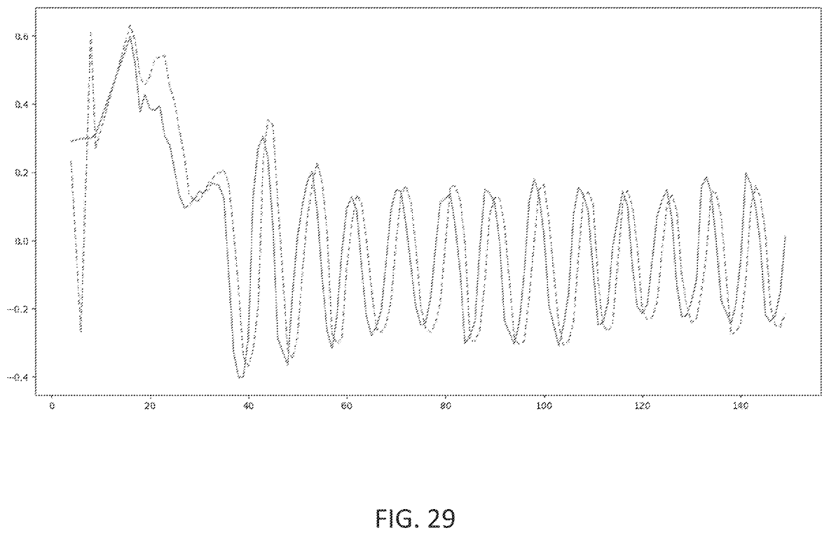

This is illustrated in FIG. 29 which compares a sample of pitch values from a headset to the Y coordinate of a bounding box of the headset in a video frame. Both signals have been normalized as part of the process to estimate the offset and to make visual comparison clearer. In FIG. 29, the normalized data from the headset's pitch values is graphed here in a solid line, while the normalized landmark detection Y coordinate is graphed in a dotted line. In FIG. 29, the Y-axis is the normalized value of each data set, and the X-axis is the frame number. The output finds the number of frames to offset the coordinate (dotted) data to most accurately match the IMU data. A metric for determining the score for each offset is the cross-correlation coefficient of the two signals.

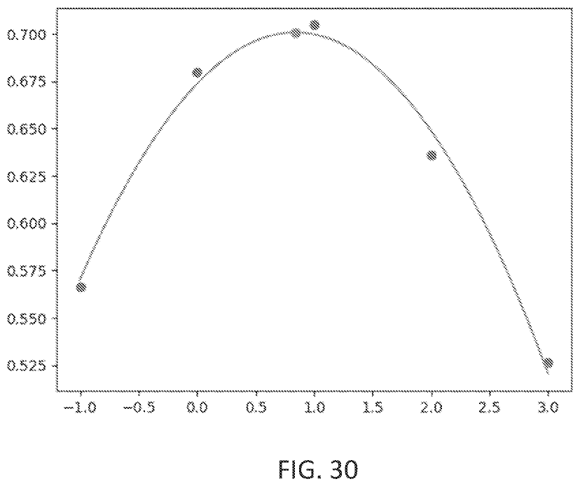

To determine the best offset, the cross-correlation coefficient between the two signals for some range of offsets is calculated. In the present context it is desirable to identify smaller offsets between-5 frames and 10 frames (moving the data backward 5 frames to forward 10 frames). For example, looking at the data depicted in FIG. 29, where approximately 150 frames worth of video and IMU data is visualized. When calculating the cross-correlation coefficient, two equal length arrays are required. In order to have enough room to shift the data 5 frames backwards or 10 frames forward, frames 5 to 140 of the IMU data (135 frames total) are used. This way, when the video data is offset 5 frames backwards. IMU frames 5 to 140 can be compared with video frames 0 to 135. Similarly to move the video data 10 frames forwards, IMU frames 5 to 140 are compared with video frames 15 to 150. For each number in the range −5 to 10, video data, as shown in FIG. 24 in a dotted line, is offset by that number and a cross-correlation coefficient is calculated using an external library, NumPy, which provides methods for fast operations on arrays. Rather than just taking the offset with the highest cross-correlation coefficient, the peak offset's coefficient is obtained and its two neighboring (on either side) offsets' coefficients to perform a quadratic interpolation as shown in FIG. 30 which illustrates an interpolation of highest coefficients with the offsets shown on the x-axis and cross-correlation coefficients shown on the y-axis.

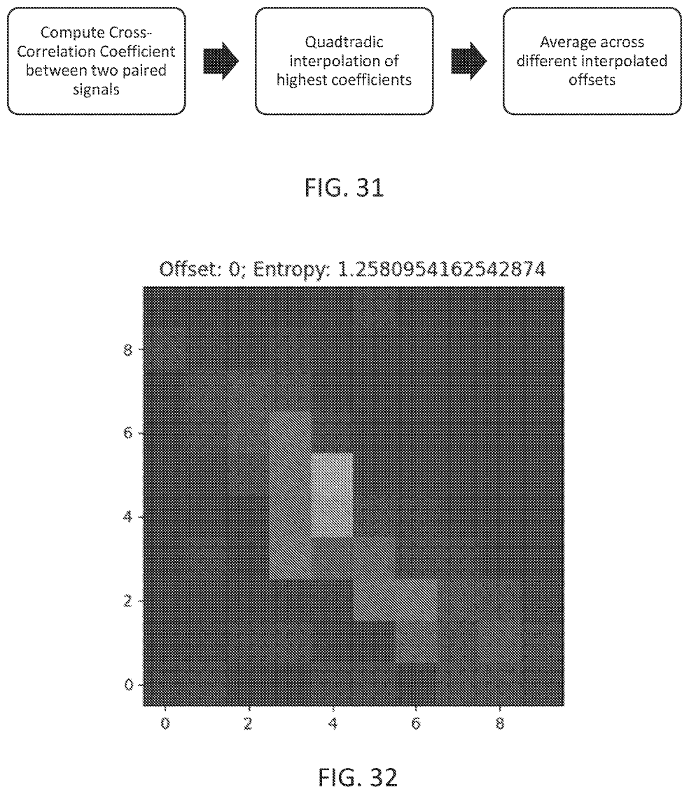

As shown in FIG. 30, the highest offset (x-axis) was found at 1.0. Looking at the neighboring offsets, the coefficient at 0 frames offset is noticeably higher than at 2 frames. To find a more accurate offset, we take the two neighboring offsets on either side and their coefficients and perform a quadratic interpolation. The peak of this interpolation sits just below 1.0 frames (shown at the peak of the parabola in FIG. 30) and is obtained as a final offset for the pitch and coordinate Y. This process repeats across other pairs of data including (a) Yaw to coordinate X, (b) IMU X to coordinate X, and (c) IMU Y to coordinate Y. A determination is made as to whether any calculated offsets should be considered outliers (either due to the offset falling out of a specified range or the cross-correlation coefficient score falling below a certain threshold) and filter these out if they fall outside the range of offsets; in this case between −5 and 10 frames of a segment of video data. The remaining values calculated are averaged and this average is returned as our final result. The approach can be summarized in FIG. 31.

A second alignment processing is based on mutual information and differs in how obtained data is interpreted. With mutual information, each set of data is analyzed as a whole rather than its individual parts. For both data sets principal component analysis (PCA) is used to determine its dimension of greatest variation. For example, rather than comparing the video coordinate Y to the IMU's pitch, the coordinate X to the IMU's yaw, and so on as done in cross-correlation alignment processing, in mutual information alignment, the coordinate X and Y together are compared to all of the IMU's data (pitch, yaw, roll, X, Y, Z). PCA makes this possible by taking all six dimensions of the IMU data and reducing it to a single dimension of the highest variation. The same is done with the two dimensions (X and Y) of the video coordinate data. We calculate our PCA through a function provided by scikit-learn, a library that provides data analysis methods for Python. This advantageously enables the algorithm to compare two data sets as one dimensional rather than with all its original dimensions.

Similar to the cross correlation processing, the two signals are compared at different frame offsets. Rather than using the cross-correlation coefficient, however, a new metric for determining the best offset is calculated. For each offset, a 2D histogram is populated with the two one dimensional sets of data such that each axis represents one of the sets of data. Each histogram's number of bins is determined based on the size of the sample data given. Currently, with a sample of 600 frames, we use a 10×10 histogram. This is shown in FIG. 32 whereby the histogram illustrates 0 offset and it calculated entropy.

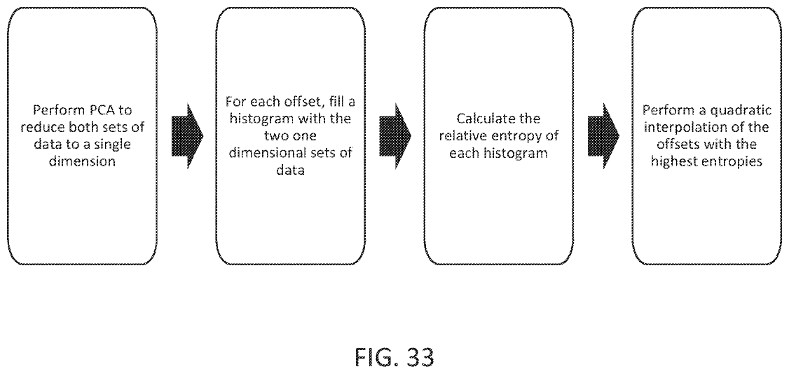

Once the histogram is filled, the next step is to calculate the relative entropy of the histogram. This histogram is the metric for this approach. From here, the steps are like our first approach. The offset with the highest entropy value and its surrounding entropies are obtained the peak offset is interpolated again using the same quadratic interpolation. Because we look at each data set as a whole and find its dimension of greatest variation, there is no need for averaging across different dimensions; this interpolation is our final result. This process is illustrated in the flow diagram of FIG. 33.

Based on the two alignment processes described above, it is important to note that each has a method of determining the viability of sample frames. These methods would not be able to accurately estimate the offset if there was no movement in the recorded frames. Without movement, there is no change in the signals to compare. While having a large enough sample size (200-1,000) of frames is important, it is also possible to check for movement in each case. Once frames and data have been collected, the data is assessed before any calculations to estimate how much movement is depicted in our sample. For cross correlation, because the signals are looked at directly, looking at the values and variation of the signal directly enable a determination of the amount of movement. By taking the absolute value of the data at each frame compared to the average position, it can be determined if the amount of variation meets a certain threshold. For mutual information, when using PCA to reduce the data sets to one dimension, the explained variance ratio is used to determine the percentage of variance for the one dimension. This again determines if the movement surpasses a certain threshold meaning the frames are viable.

The result advantageously enables correction processing of a misalignment of the obtained video data and headset IMU data by up to 10 frames. While a misalignment of a few frames seems small, it can cause noticeable delay in the final output between raw video and the corrected images fixed on top of the frames. The IMU data is needed to gauge the orientation of the user and headset to accomplish headset removal, and with no way to ensure the clocks on our video and headset are synchronized, this solution accounts for disparities between the two data streams. The alignment algorithm allows the overarching program to run continuously while a sample set is collected. This sample of the two incoming data sets can then be used to determine the offset between the two streams of data and determine how one signal corresponds to the other. Once that is completed, the program may continue to run with the estimated offset to more accurately perform its own calculations as a result

Continuing with the description of another aspect of configuration processing that is performed Section 7 describes alignment processing between the IMU device and the image capture device

Section 7: Alignment between IMU Device and Image Capture Device

Turning back to the second stage of the HMD removal algorithm from Section 3 whereby real-time HMD removal is being performed, a second step associated therewith is alignment processing between the IMU device and the image capture device capturing live images of the user wearing the HMD.

Head pose estimation is a computer-vision task that predicts the head orientation [yaw, pitch, roll.] in the camera view. This prediction is needed to successfully perform face swapping, estimating eye gaze, applying facial recognition and applying augmented reality. A first exemplary head pose estimation is a two-step approach whereby a trained machine learning model predicts facial landmarks from input image and then head pose is estimated by aligning the predicted facial landmarks with the facial landmarks of a canonical face. In another embodiment, a trained machine learning model is trained to directly estimate head pose from input image. A challenge associated with either of these approaches is specific to a user wearing a VR device that occludes the user's face. In these approaches, the architecture of model will contain backbone sub-net, which is a CNN (convolution neural net) such as MobileNet, ResNet, or VGG to extract feature maps from input image. But, these models require input image to include a clear face that should not be significantly occluded by head-mounted-device (HMD). Thus, when inputting an image into these models whereby the face of the user is occluded in some manner, a less than desirable prediction result if key facial features are occluded by opaque head-mounted-device (HMD) such as the oculus quest-2 headset. The following HMD orientation alignment processing resolves these issues and provides an algorithm that can estimate position even when part of the face is occluded.

During a VR experience, a user is wearing the HMD which is fixed to their head and is equipped with IMU (Inertial Measurement Unit) providing position [Xᵢₘᵤ, Yᵢₘᵤ, Zᵢₘᵤ,] and orientation measurement [Yawᵢₘᵤ, Pitchᵢₘᵤ, Rollᵢₘᵤ,]. In operation, an image capture device is capturing and providing, as input, a real time image of the user wearing the HMD. Is therefore necessary to estimate head pose data from the perspective of camera [Yaw_{cam}, Pitch_{cam}, Roll_{cam},| and this is achieved, if the transform |Yawᵢₘᵤ, Pitchᵢₘᵤ, Rollᵢₘᵤ,|→|Yaw_{cam}, Pitch_{cam}, Roll_{cam},] can be established. And the linear transform between the two parameter systems are shown as follows:

$$\begin{matrix}{Yaw}_{cam} = {Yaw}_{imu} - {Yaw}_{0} \\ {Pitch}_{cam} = {Pitch}_{imu} - {Pitch}_{0} \\ {Roll}_{cam} = {Roll}_{imu} - {Roll}_{0}\end{matrix}$$

Here, the offset constants [Yaw₀, Pitch₀, Roll₀,] are data from the IMU sensors when head is facing camera straight indicating at-rest pose [Yaw_{cam}, Pitch_{cam}, Roll_{cam},]=[0, 0, 0]. Estimating head pose with IMU data can be obtained from the at-rest pose at the alignment step.

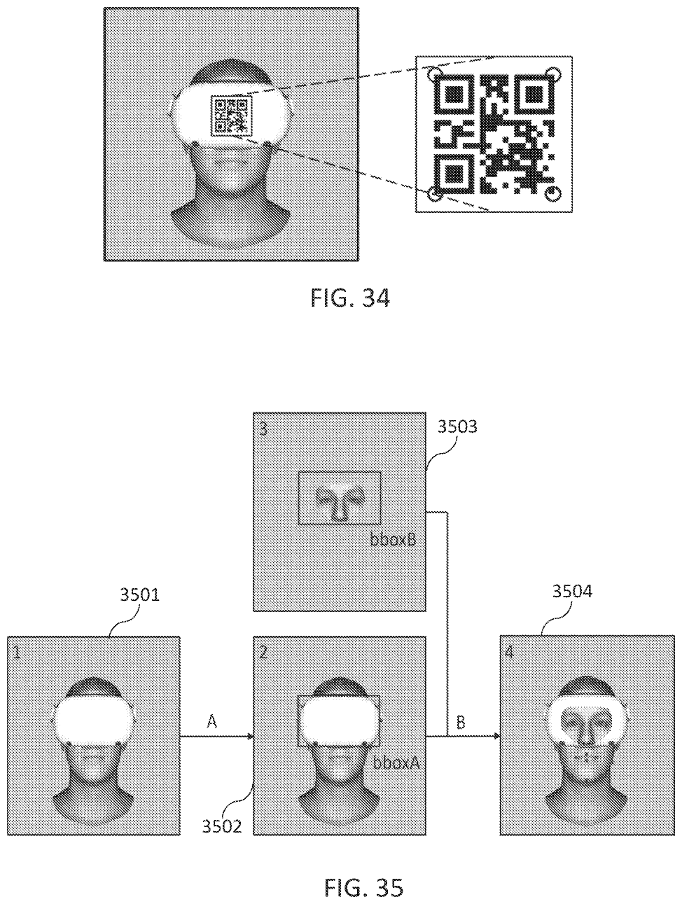

In one embodiment, alignment processing is performed using an indicator affixed to an HMD. In one example, a QR-code is attached a substantially a center location of the front-panel of the HMD as shown in FIG. 34. During alignment processing, a QR code processor such as pyzbar will decode QR-code for each frame to obtain a set of current coordinates of the four corners of the QR code represented by [[x₁, y₁], [x₂, y₂], [x₃, y₃], [x₄, y₄]]. This is obtained while the user is adjusting head pose slightly in front of the camera. When the four corners form an upright square indicating at-rest pose, the current IMU reading are considered as the offset constants [Yaw₀, Pitch₀, Roll₀,], and the alignment between IMU and camera is done.

One manner of determining whether the QR code is formed as an upright square includes determinations that one or more of the (a) side edges are in vertical direction; (b) all edges are of equal length; and (c) four interior angles are of 90 degrees. The exemplary alignment process is shown in FIG. 34. As shown in FIG. 34, the four circles are indicating the current coordinates of the four corners decoded by a QR-code module.

In another embodiment, alignment may be performed using inpainting. As used herein, inpainting refers to the process of adding features that exist in real space but which are occluded by an object thereby blocking those features from being seen in a virtual space. For example, inpainting the upper face is the process of adding upper facial features (e.g. eyes, nose, forehead) on top of the HMD in the capture image. In this embodiment, a QR-code is not required. The alignment process consists of the following four elements which are described using FIG. 35 which shows as schematic of the inpainting process where input image 3501 is provided and, in A, a bounding-box surrounding the HMD is determined in 3502. From 3503, a bounding box surrounding candidate facial features and which include the candidate facial features is obtained and, in B, alignment between bboxB and bboxA.

To provide further context for the depictions in FIG. 35, the following algorithm is used to generate the ultimate output in 3504. In 3501, an input image of a user wearing a HMD captured by an image capture device is provided. In 3502, a bounding-box of the head-mounted-device (HMD) in image (bboxA) is generated. This is performed by image segmentation and the bounding-box (bboxA) can be specified by values in the image frame representing top-left corner [xₘᵢₙ, yₘᵢₙ] and bottom-right corner [xₘₐₓ, yₘₐₓ]. In 3503, a predefined bounding-box (bboxB), which instructs the user to adjust position [x, y, z,] relative to camera for the alignment purpose is generated and in 3504, bboxB and bboxA, are aligned by performing an affine transform (scaling and translation of bboxB to fit bboxA). The affine transform then can be applied to predefined eyes/nose image for inpainting upper-face. From this, a head pose using landmarks on the lower-face through Perspective-n-Point (PnP) method is estimated and inpainting of the occluded upper-face is performed. Upon alignment of the bounding boxes and inpainting, the image is provided to predict facial landmarks using a trained machine learning model and verify the predicted landmarks on the lower face that are visible to estimate head pose.

By collecting one data point near at-rest pose, the following equations may be used to estimate the offset constants [Yaw₀, Pitch₀, Roll₀,]

$${Yaw}_{0} = {Yaw}_{imu} - {Yaw}_{cam}$$

$${Pitch}_{0} = {Pitch}_{imu} - {Pitch}_{cam}$$

$${Roll}_{0} = {Roll}_{imu} - {Roll}_{cam}$$

If a plurality of data points are collected (e.g. k=1, 2, 3, 4, 5) around at-rest pose, the offset constants [Yaw₀, Pitch₀, Roll₀,] are estimated through the following linear regressions.

$$loss ( {Yaw}_{0} ) = sum of {\vert {Yaw}_{imu}^{k} - {Yaw}_{cam}^{k} - {Yaw}_{0} \vert}^{2}$$

$$loss ( {Pitch}_{0} ) = sum of {\vert {Pitch}_{imu}^{k} - {Pitch}_{cam}^{k} - {Pitch}_{0} \vert}^{2}$$

$$loss ( {Roll}_{0} ) = sum of {\vert {Roll}_{imu}^{k} - {Roll}_{cam}^{k} - {Roll}_{0} \vert}^{2}$$

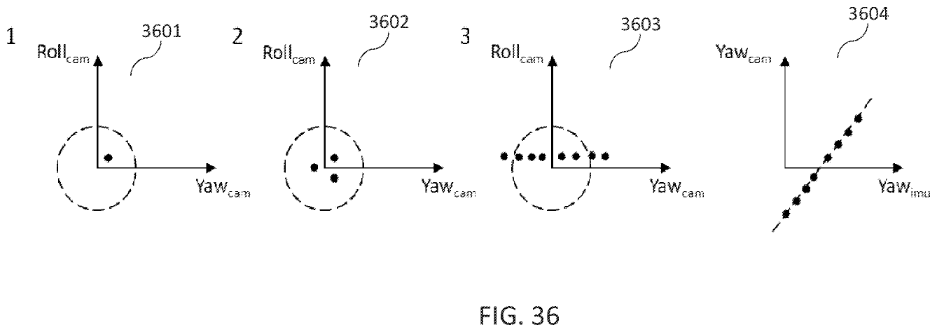

If a 1-D scan of data points around at-rest pose is collected for [Yaw_{cam}, Yawᵢₘᵤ], [Pitch_{cam}, Pitchᵢₘᵤ], [Roll_{cam}, Rollᵢₘᵤ] respectively, the offset constants are estimated [Yaw₀, Pitch₀, Roll₀,] respectively through line-fitting and zero-crossing as illustrated in FIG. 36 which illustrates exemplary approaches 3601, 3602 and 3603 to estimate the offset constants 3604. To illustrate the option 3 (2603), 1-D scan of data points around at-rest pose for [Yaw_{cam}, Yawᵢₘᵤ] by rotating head from left to right is collected. The linear transform between the two parameter systems means that to estimate the offset constant Yaw₀ is to estimate the intercept through line-fitting and zero-crossing.

Current AI-models are designed and trained to infer landmarks from input image where face is clearly visible. As such, the models will fail to predict landmarks if key facial features are occluded by opaque head-mounted-device (HMD) in image. In order to obtain facial landmarks, we advantageously inpaint eyes/nose on the mounted-headset, then invoke ai-model such as mediapipe face mesh to predict facial landmarks. Since only lower-face is visible to verify results, we extract landmarks on the lower-face to estimate head pose.

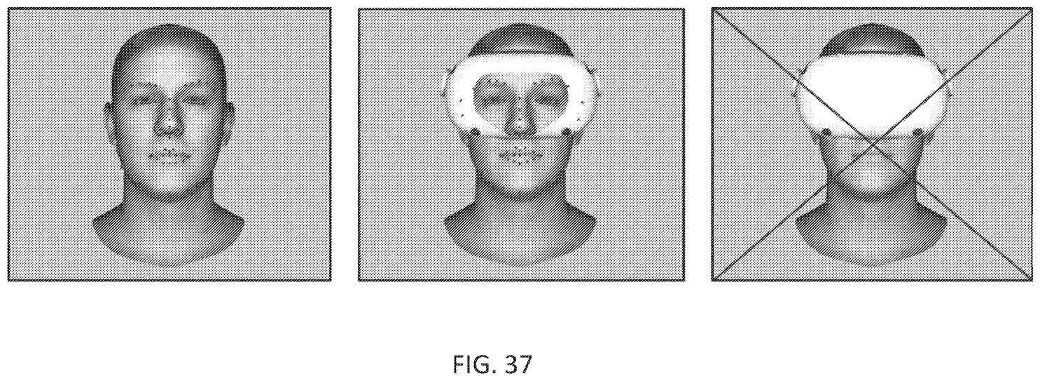

In FIG. 37, the left image is a typical input image and output landmarks for landmark AI-model while the right shows invalid input image where key facial features are invisible for landmark AI-model. The middle shows the lower-face landmarks can be inferred if the upper-face is inpainted resulting in a modified image that allows for estimation of landmarks using the AI model without the need for a full face in the input image.

In another embodiment, part of the process of aligning the coordinate axes of the HMD's IMU with a set of coordinate axes relative to the camera, processing is performed whereby the user is guided to look directly at the camera. At this point the IMU orientation and position are recorded as reference and given the distance of the user to the camera as described hereinbelow, a full 3D environment can be constructed, and further IMU orientations and positions can be mapped to the camera axes using the reference orientation and position. Accordingly, a graphical user interface (GUI) is presented to the user during the alignment stage and guides them to look directly at the camera.

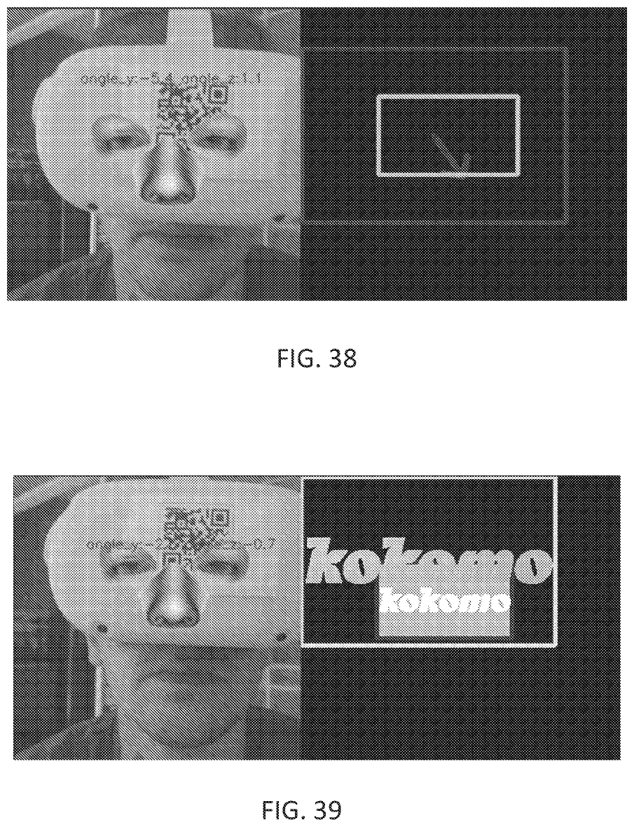

In one embodiment, the generated GUI may include but are not limited to a rectangle fixed to the frame at a target location which allows for satisfactory results from the orientation detection algorithm described herein in the IMU alignment section. In another embodiment, a rectangle derived from the bounding box of the user's HMD in the frame. Other embodiments, include, in or around either of the above rectangles, any graphics (logos, images, shapes, etc.) or text (e.g. instructions) may be placed to aid the user in the alignment process by improving the visualization of a desired position and orientation. The GUI may also include a means of determining the movements the user must make to align their rectangle to the target rectangle as shown in FIG. 38.

As shown in FIG. 38 two rectangles are generated based on the HMD position in face image and displayed in the GUI of the HMD. As shown in FIG. 38, the target rectangle is the inner rectangle and the moving rectangle derived from HMD is the larger, outer rectangle. An image element representing an arrow illustrates the instructed moving direction for the user and is continually updated to further prompt direction movement of the head of the user based on the position of the inner and outer rectangles. An additional embodiment is shown in FIG. 39 whereby, instead of the image element being an arrow, there are matching image elements in both the outer and inner rectangles and, the user is directed to match the image elements over one another to determine position to obtain alignment information.

Given the rectangles in FIGS. 38 and 39, alignment is achieved by determining the centroid of each rectangle, i.e. the average (x,y) coordinate of the corners. The difference in the x and y coordinates, which in some embodiments may be normalized to [0,1] or any other useful scale, are used to determine in which direction the user's rectangle must be moved to align with the target rectangle. For example, if the y coordinate of the user box center is larger than the y coordinate of the target box center, some indication may be given to the user to move their head down in the frame.

In addition to having the correct (x,y) coordinate, in order to obtain reasonable results for orientation detection, the user must also be the correct distance away from the camera. Using the two rectangles a calculation of the intersection over union (IOU) of them can be interpreted as a distance requirement. If the user is too far away from the camera, the outer rectangle will be much smaller than the target, so the IOU will be similarly small, and if the user is too close to the camera, the rectangle #2 will be much larger than the target, again making the IOU small. It is only when the user is the desired distance away from the camera that the IOU is large, and an orientation detection may be trusted.

Since it is not enough to have the user at the correct location in the frame but also at the correct orientation, some embodiments also take into account the detected orientation of the face IMU alignment section and artificially shift the location of the user's bounding box accordingly. For example, if the user is exactly in the target location (so their bounding box perfectly aligns with the target box) but they are looking to their left instead of at the camera, the displayed bounding box is moved left, indicating they are not perfectly aligned. In a similar manner the bounding box and all included graphics and/or text may be rolled clockwise or counterclockwise to indicate that the user is not correctly aligned. Once the user has successfully maneuvered their head into position to align the two boxes, the reference angles can be trusted and recorded for use in other applications such as HMD removal.

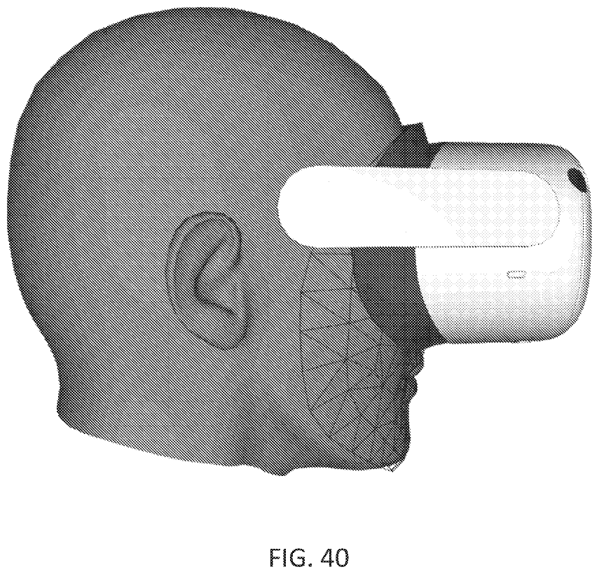

In another embodiment, alignment processing described in this section includes using 3D model geometry readjustment processing. As described in this embodiment, in order to infer facial landmarks from input image/frame where a face is significantly occluded by head-mounted-device (HMD), face and headset 3D models are established offline as a default geometric configuration. Initially standard face (canonical media-pipe face: 468 facial landmarks) and HMD (for example, oculus quest-2) models are manually aligned and assembled using a default head model (for example, SMPL head) as reference head. For online processing, standard face can be automatically replaced with user-specific face through non-rigid alignment approach (in the least-square sense, one facial landmarks is to best match the other). A schematic of initial set-up of models is shown in FIG. 40. Here, face and headset 3D models are generated offline and in advance of the processing performed herein. A default head model could be visually helpful as reference head to manually arrange face and headset models. This may be generated, in part, using a face mesh generation library such as Media-Pipe which represents the landmark-inference machine-learning-model that can predict (media-pipe face: 468 facial landmarks) from a face image.

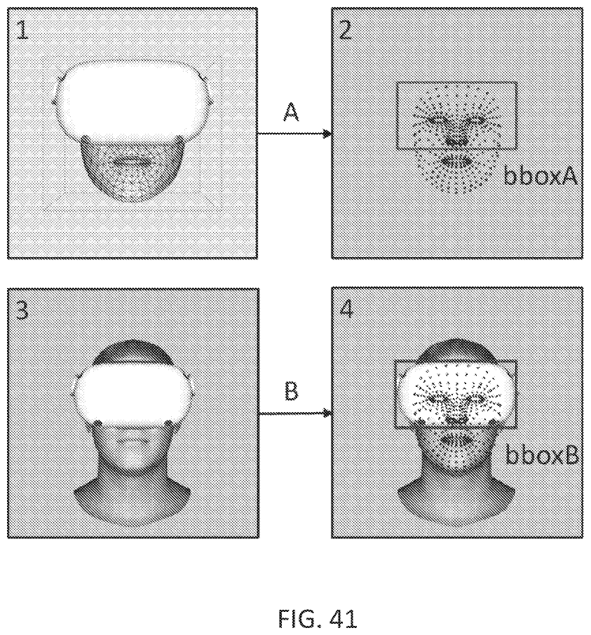

For online processing, it is also desirable to adjust HMD position according to a reference image of front-view, since different user may position the HMD with slight positional variation and thereby cover upper-face differently, albeit with small varieties. Here, we the front-view image that is used to complete IMU-alignment step for adjusting HMD position relative to face model may be used. The adjustment algorithm is illustrated in FIG. 41 and includes generating bounding-box of head-mounted-device (HMD) in reference image (bboxB), which is a base computer-vision task and can be achieved by image segmentation wherenby the bounding-box can be specified by top-left corner [Xₘᵢₙ, Yₘᵢₙ] and bottom-right corner [Xₘₐₓ, Yₘₐₓ]. Generate facial landmarks in reference image which can be achieved by inpainting eye/nose on HMD region defined by bboxB and invoking landmark-inference machine-learning-model such as a media-pipe face-mesh solution. Obtain a 2D point cloud [Xᵢ, Yᵢ] projected from 3D point cloud [Xᵢ, Yᵢ, Zᵢ] onto image-plane by projection transform. The bounding-box of 2D headset point (bboxA) can be estimated by [Xₘᵢₙ=min(Xᵢ), Xₘₐₓ=max(Xᵢ)] and [Y min=min(Yᵢ), Yₘₐₓ=max(Yᵢ)]. Thereafter, alignment between (2) and (4) in FIG. 41 using lower-face landmarks, which can be achieved by the affine transform (scaling and translation). By comparing the two centers of bboxA and bboxB, the adjustment of HMD model in X or Y direction can be derived. As shown in FIG. 41, A represents projection onto image-plane through projection transform and B represents image segmentation, eye/nose inpainting and landmarks inference and (1) and (3) in FIG. 41 represent 3D models and reference image, respectively.

In addition to alignment between the HMD device and the camera capturing the user wearing the HMD, the images that are captured will be used to generate updated images that have replacement portions thereof that come from the precaptured images. However, because the precaptured images were obtained prior to a current imaging of the user wearing the HMD device, color correction processing must be performed in real time between the candidate image to be used for replacing the current image being captured that includes the HMD device. Section 8 describes this processing.

### Section 8: Recolor Processing on Precaptured Images

Being able to correctly relight or transfer the color of the image of an object or an environment is useful in augmented virtual reality. This process is part of the processing performed on the precaptured images described above in Section 3. The images of a virtual environment or the images of different users are often captured in different places at different times, and are thus captured under different lighting conditions. Humans will easily perceive the lighting differences, causing an unnatural perception of the scene if the image are combined without aligning the lighting between them. Furthermore, in augmented virtual reality, a user often wears an HMD device, which thus requires HMD removal or HMD region replacement if others are to see the user's whole face. If the HMD region is replaced with some precaptured images or artificially generated images, the lighting conditions of the precaptured images should be aligned with the lighting conditions of the HMD image.

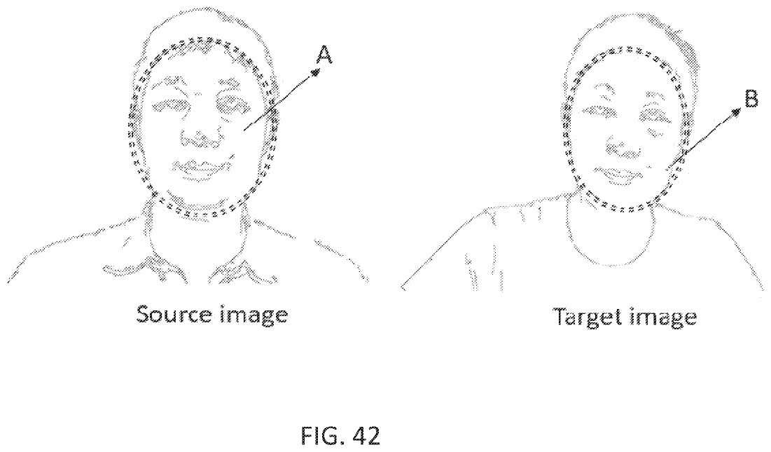

In one embodiment, recolor processing includes region-based color transfer and will be discussed hereinbelow with respect to FIG. 42. Some systems, devices, and methods perform (e.g., implement an algorithm that performs) relighting or transferring the color of a source image based on a specific region of a target image (e.g., transfer the coloring of the target image to the source image). In FIG. 40, the goal is to transfer or relight the color of the face of the source image, shown in region A, based on the face of the target image, shown as region B. Different aspects may be used to transfer or relight the color of the face. Some embodiments use a CIELAB color space, and other embodiments use the covariance matrix of the RGB channels. In some embodiments of the relighting, the goal is to use the CIELAB color space or the covariance matrix to de-correlate the information among red, green, and blue channels in an RGB color space. In addition, an RGB color space is also device dependent, thus different devices will produce color differently. Therefore, an RGB color space may not be ideal for the color transfer between images that have different lighting.

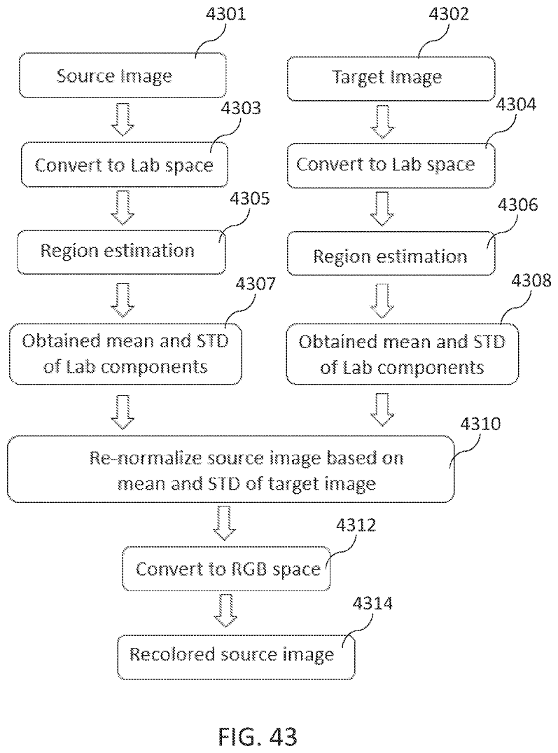

One embodiment that uses a CIELAB color space is shown in FIG. 43, which shows an example embodiment of a method for color transfer using a first color space (CIELAB color space). After obtaining a source image 4301 and a target image 4302, the two images are converted from an RGB color space to a CIELAB color space (4303,4004). Then the regions from both the source image 4305 and the target image 4306 that need color transfers are estimated, and the mean and standard deviations (STDs) of Lab components of CIELAB color space on the regions are also calculated for each of the source image 4307 and target image 4308. After obtaining the mean and the STD for both the source and target images, some embodiments adjust, in 4310, the LAB components of source images such that the adjustment can be described by (e.g., is performed according to) equation (7):

$${x}_{source} = \frac{{x}_{s o u r c e} - mean ( {x}_{s o u r c e} )}{std ( {x}_{source} )} * s t d ( {x}_{target} ) + mean ( {x}_{target} ) \qquad ( 7 )$$

where x is any one of the three components L, a, b in CIELAB space. Thereafter the adjustments determined to be made are converted to RGB color space in 4312 and use to recolor the source image (e.g. the image used for replacement) in 4314.

Embodiments that use covariance-based decorrelation can follow an operational flow that is similar to FIG. 43. Although covariance-matrix-based embodiments may appear to be more data-driven than the CIELAB-based embodiments, CIELAB was designed entirely based on the perception of human vision, and CIELAB often provides simpler implementations for removing the correlations of an RGB color space. Thus CIELAB-based embodiments may be faster and more flexible for multiple-regions-based color transfer.

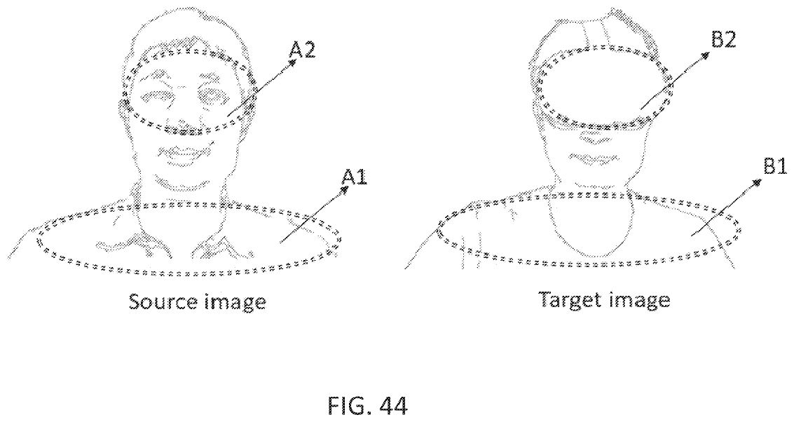

In another embodiment, recolor processing may also use reference image based color transfer. In other embodiments, multiple recolor processing may be employed In reference image recolor processing a reference image that is based on multi-region color transfer is used. This will be described with respect to FIG. 44 which illustrate when region-based object relighting cannot be directly applied.

When applying region-based color transfer, both the source image and the target image should share the same features or contain the same feature information. The reason is that when the images share the same features, the differences of the means and the STDs between regions of the source and target images can be assumed to be caused by differences in image lighting rather than feature differences. FIG. 44 shows two cases in which the region-based color transfer cannot be directly applied.

The first case is to transfer the color of region A1 using the color of region B1. Regions A1 and B1 contain different features because the person in the images is wearing different clothes. Therefore, the differences of the means and STDs of regions A1 and B1 cannot be assumed to be entirely caused by the lighting. If region A1 is directly renormalize based on the mean and STD of region B1, that will produce a very unnatural color perception from user perspectives.

The second case is the color transfer of region A2 using region B2. Region A2 comes from the eye region of a human face, but region B2 shows a head mounted display (HMD) instead. It is meaningless to use the mean and STD of region B2 to recolor region A2 because they come from completely different objects. Note that the second case is generally the case where an HMD device is replaced using a precaptured image and the color of the replaced eye region in the upper face in the precaptured image is changed to match the color of the lower face.

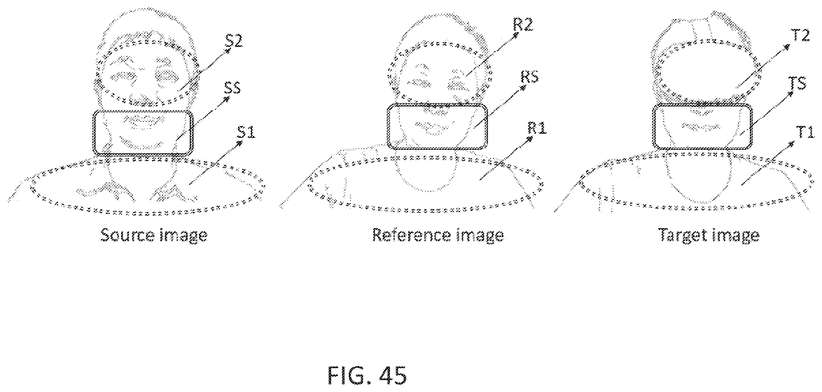

To use the same color transfer technique that is shown in FIG. 43 to transfer the color of regions that do not share any features, some embodiments use a reference image. An example of this is illustrated in FIG. 45. Note that reference image could be, for example, a source image or an image that was predefined for some specific effect. In FIG. 45, the source image, the reference image, and the target image all share the same features in the regions SS, RS, and TS. Because these regions share the same features, embodiments of the above-described methods can be used to transfer the colors between the images even though some of the features are not shared by all of the images.

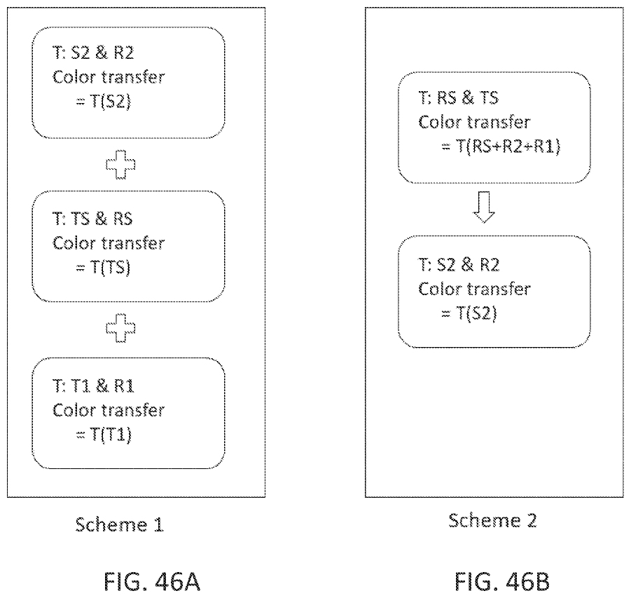

FIGS. 46A and 46B show example embodiments of methods for color transfer. FIG. 46A shows a first scheme and FIG. 46B shows a second scheme 2 where a reference image R is used for the color transfer between a source image S and a target image T. FIG. 46A uses a reference image (region R2) as a target image for the color transfer for region S2. Some embodiments transfer the color of the reference image R to both the source image S and the target image T. Because both the source image S and target image T get the color transfer from the same reference image R, the transferred color on the region S2 should match the color of regions of TS and T1. Therefore, region T2 can be replaced with the color-transferred region S2.

FIG. 46B uses a reference image R to connect the source image S and the target image T. First, the entire reference image R is color transferred based on the shared regions RS and TS, then a new transform is derived based on the shared regions S2 and R2 between the source image S and the reference image R. After region S2 is color transferred, the recolored region S2 should also align with the color from regions TS and T1. And region T2 can be replaced with the color-transferred region S2.

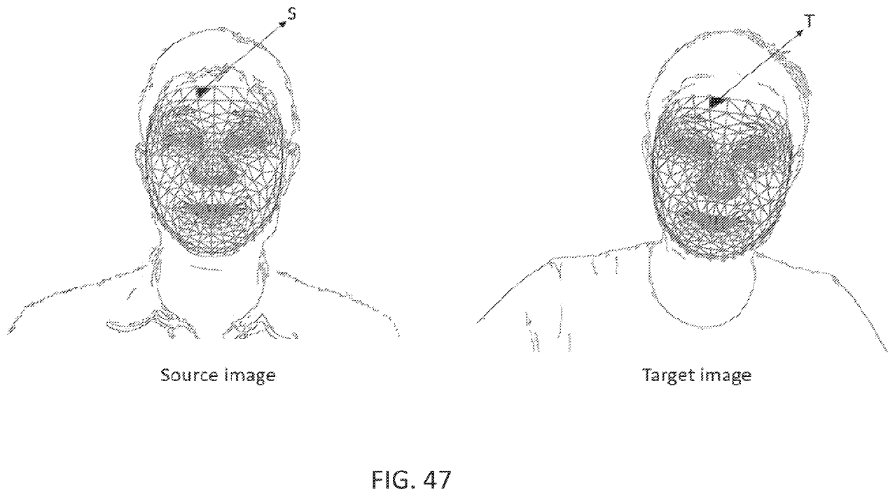

In another embodiment, recolor processing includes multi-region color transfer processing which will be described with reference to FIG. 47. The means and STDs of the intensities of a region are two numbers that provide a simple summary (e.g., statistical information) of the lighting conditions of the overall lighting or color of the entire region. These two numbers may be insufficient to represent any change of the lighting across the region (dynamic lighting changes in the region). However, because the object is three dimensional and because different regions may have different lighting, the lighting may change across the region (the lighting may have dynamic changes). Therefore, some embodiments do not use only one or two numbers to represent the lighting in the entire region (i.e., some embodiments use more than just one or two numbers to represent the lighting in the entire region).

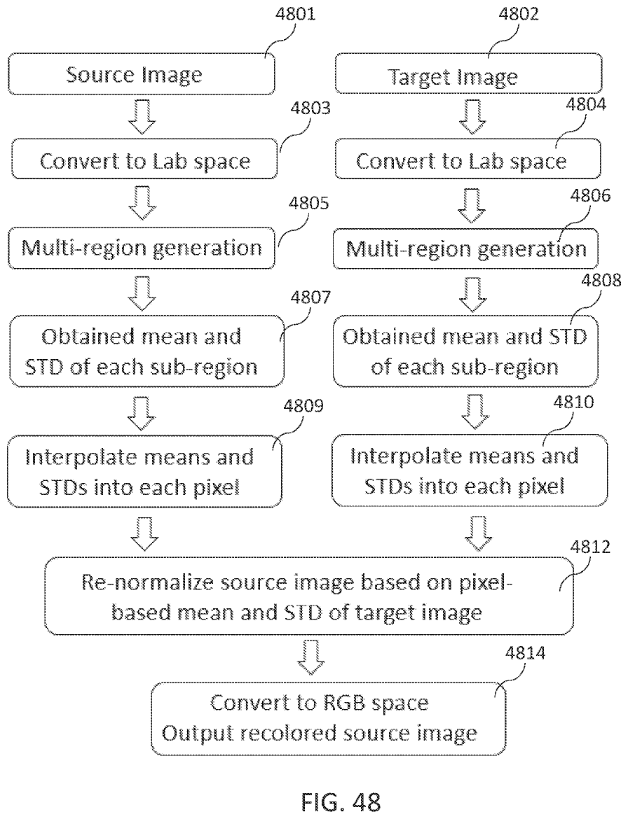

To better represent the different lightings across the region, some embodiments use a multi-region-based color transfer. As shown in FIG. 47, a mesh can be used to split an object (a face in this example)—or a region in an image—into a large number of sub-regions based on the feature landmarks. Each mesh in the source image has a corresponding mesh in the target image, and each sub-region in the source image has a corresponding sub-region in the target image. For example, the triangle sub-region S in the source image corresponds to the triangle sub-region T in the target image. Because these sub-regions share the same features and are thus related to each other (e.g., correspond to each other), a flow diagram shown in FIG. 48 can be used to perform the color transfer for each sub-region.

FIG. 48 illustrates an example embodiment of a method for multi-region-based color transfer. Similar to FIG. 43, the flow first converts the source image 4801 and the target image 4802 from an RGB color space to a CIELAB color space (4803, 4804). The algorithm generates many sub-regions based on triangles or meshes generated from feature landmarks in each of the source image 4805 and target image 4806. One example embodiment generated the sub-regions based on Mediapipe's 468 landmarks. Given the 468 landmarks, the embodiment created 898 meshes and split the entire face into 898 sub-regions. Sub-regions can be merged with other sub-regions if they are too small. After calculating (e.g., estimating) the mean and the STD of merged sub-regions for the source image 4807 and target image 4808, those region-based means and STDs of the sub-regions are interpolated (4809, 4810) into pixel-based means and STDs. These images are used to renormalize the entire source image in 4812 based on the interpolated mean and std of each pixel from the target image. Finally, in 4814, the source image is converted back to RGB color space, and the recolored source image is stored or output.

Thus, embodiments of the devices, systems, and methods transfer the color of an image in accordance with human perception and transfer the color of an image such that large changes in lighting conditions or in color distribution are accounted for. Further, embodiments of the devices, systems, and methods use a reference image to allow color transfers for regions that share no features and use multiple regions to allow color transfers that account for changes of color distribution across the image.

According to another embodiment recolor processing includes performing color transferring between images based on detected corresponding regions of the images. Given video frames of a user wearing a virtual reality (VR) headset, it is advantageous to provide rendering of images of the user without the headset by pasting and stitching images on top of the frame where the face is obscured by the headset. This is the real time HMD removal processing discussed herein. Only the regions of the face that are covered by the headset are replaced to maintain the expressions of the video frames. As previously described, the images pasted are obtained from a set of sample pre-capture images taken prior to a user entering the virtual reality environment. Assuming the images are pasted to replace the missing regions of the face correctly, the colors of the pre-capture image will also need to be altered to match the video frame to seamlessly stitch the two together. To correctly match the colors of the video frame and pre-capture image—depicting the same face—other areas of the two pictures such as the background are ignored because those areas may not necessarily be matching. This solution requires detecting corresponding facial regions in the two images and color matching the images based solely on these regions.

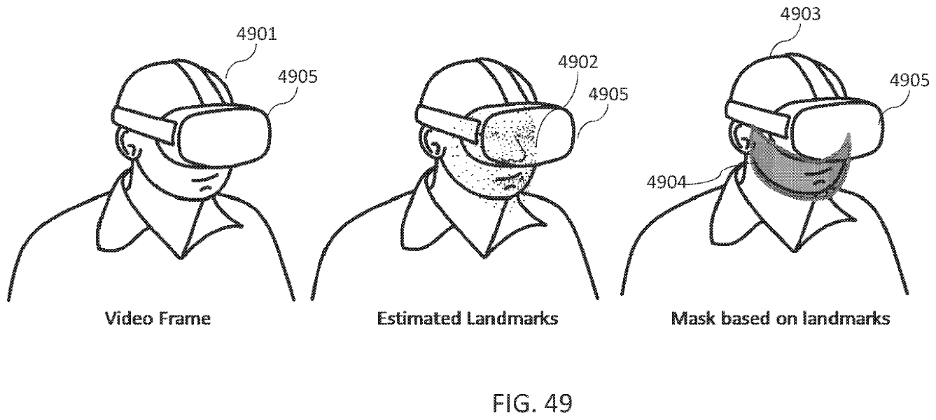

The first step of the color matching algorithm is to find corresponding candidate regions in a current video frame and pre-capture image that are to be color matched to each other. Because the VR headset will cover much of the upper areas of the face (the eyes, nose, etc.) this process is performed using the lower region of the face in both the present video image and the precaptured image. To only take the lower face region into consideration when color matching, a mask is created for each image that only includes the area of that image used for comparison purposes. In exemplary operation, the mask is generated to cover a region of the face that is not covered by the HMD device. As such, a face mesh is created (in a manner discussed above) based on the currently captured video frame and one or more pre-capture images from the precapture stage 700 in FIG. 3. A set of landmarks that are considered to encapsulate the lower face is determined and used to create a mask of the lower face by creating a path between chosen landmarks (i.e. connecting the dots) and including the area inside this path as the mask. This process is illustrated using the obtained video frame 4901 illustrated in FIG. 49 whereby a mask is created based on the estimated landmarks shown on the face of the user in 4902 in the video frame and creating the mask 4904 shown as the shaded region of the third image 4903. Because the headset 4905 hides much of the face, libraries alone cannot be used to estimate these landmarks. However, a set of these landmarks that have already been determined are used to generate the mask 4904. In FIG. 49, the original video frame 4901 is shown along with the frame 4902 with estimated landmarks painted over it, and finally how a mask created by connecting the lower face landmarks may appear in 4903. In operation, the landmarks were selected to create the mask were selected to go around the headset. As can be seen in FIG. 49, the mask 4904 is generated such that the left side of the mask tops out near the ear and dips down towards the mouth and rises again on the right side. Because the user could be facing many different angles, the headset 4905 may obscure parts of our mask (such as on the right side of the face in FIG. 49). While color matching will be discussed below, it is important that the headset 4905 is not included in the mask 4904 color matching is being performed as it may adversely affect the ability to successfully match the colors. While a smaller number of landmarks could be selected to create a smaller mask that is less likely to include the headset 4905, at certain angles any region of the lower face could be obscured by the headset 4905. Thus, it is desirable for the mask 4904 being created to be large enough to be visible at most angles. In contrast, the described algorithm maintains the mask 4904 but removes any part that is blocked by the headset 4905. This is possible because the algorithm has already detected where the headset 4905 is located in the image for which replacement and color matching is to be performed.

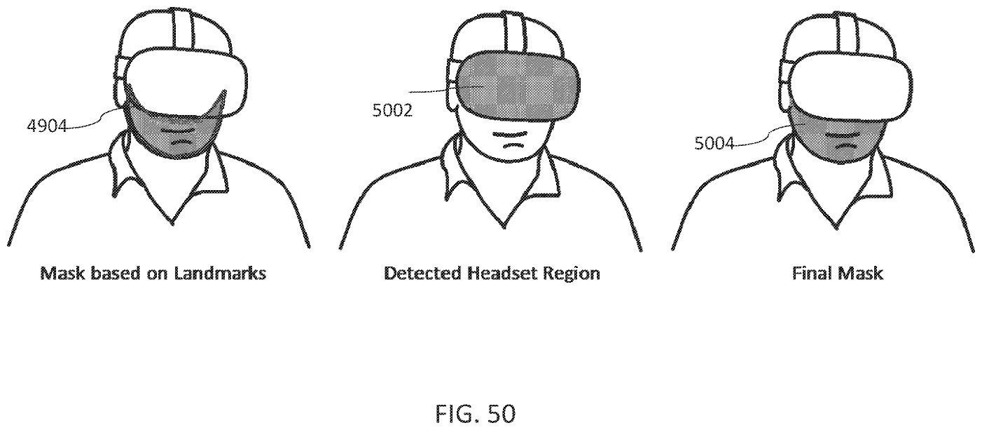

FIG. 50 illustrates the process of removing a headset region and generating the final mask for use in region recolor processing. FIG. 50 shows a mask 4904 based on landmarks obtained from the processing discussed above with respect to FIG. 49, a previously obtained headset mask 5002, and the target final mask 5004. The final mask 5004 is generated by taking the original mask 4904 and removing any part of the mask 4904 that overlaps with the headset mask 5002.

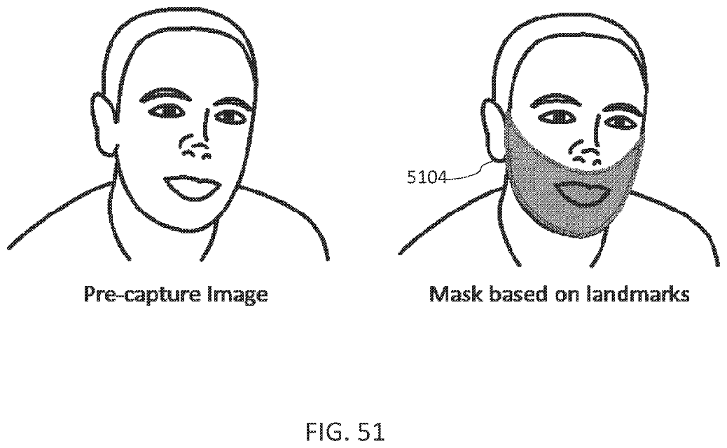

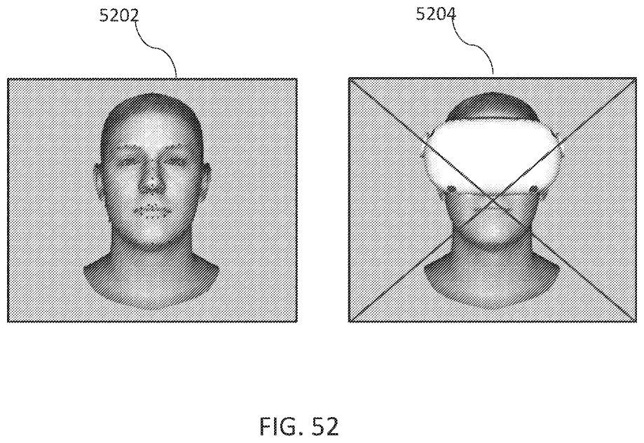

This process is much easier with pre-capture images that represent the user when the user is not wearing the HMD because there is no headset obscuring the face of the user. Thus, FIG. 51 illustrates how the mask 5104 appears on a candidate pre-capture image (with the mask depicted by the shaded in region). Once a final video frame mask 5004 and our pre-capture mask 5104 are generated, color matching is performed between the two images based on these regions. Because we are pasting the pre-capture image onto the video frame, the color of the entire pre-capture image is changed to match the current video frame. More specifically, although the regions being considered for color matching purposes are used for color matching, the color of the entire image is changed because the upper face from a precaptured image of the user without the HMD will be pasted onto the current video frame. To match the images, colors of the video frame are transferred to the pre-capture image that will be used for replacement. Both images are analyzed using the LAB color space, which is designed to approximate human vision (unlike other color models such as RGB or CMYK). Then for each image, the mean and standard deviation of all three color channels for the masked area are obtained. From here processing, in accordance with Equation 8, for each of the color channels is performed to replace the values with the result (where the video frame is source image and the pre-capture image is our target).

$$( Target - mean ( Target ) ) \times \frac{standard deviation ( Source )}{standard deviation ( Target )} + mean ( source ) \qquad ( 8 )$$

Lastly, any values that fall out of the standard range of color values (0 to 255) are clipped resulting in the colors of the faces should match between the two images.

This solution advantageously allows for more accurate color transferring between two images. Specifically with the desired area of the video frames to transfer from being inconsistent due to the headset potentially obscuring areas of the face. This solution works around what areas of the face are shown in each frame and is able to match a pre-capture image to it.

Section 9: Landmark Inference from an Occluded Face Image

Facial-landmark detection is a computer-vision task in which a computer (e.g., a machine-learning model implemented by the computer) identifies or predicts landmarks (e.g., points) on eyes, eyebrows, nose, lips, and other facial structure in one or more input images. The results of facial-landmark detection may be passed to other functions that perform other computer-vision tasks, including swapping faces, estimating head poses, identifying gaze directions, and applying augmented reality. However, some landmark machine-learning models are designed and trained to infer landmarks from images in which an entire face is clearly visible. These models will fail to identify landmarks, or will return distorted landmarks, if key facial features are occluded, for example by an opaque head-mounted-device (HMD) in an image. Thus, when obtaining facial landmarks (e.g., lines or facets that are formed by connecting landmarks) as outputs that indicate key facial features (e.g., eyes, eyebrows, nose, lips, jawline) from an input image, some landmark machine-learning models (e.g., deep-learning-models) require the input image to show an entire face that is not significantly occluded, for example by an opaque head-mounted-device (HMD).

A schematic of facial landmark detection is shown below in FIG. 41. In FIG. 41, the an input image 5202 is shown with landmarks positioned thereon that were output b by a trained landmark machine-learning model. Image 5204 is an input image where key facial features are invisible to the landmark machine-learning model because they are occluded by an HMD. If facial landmarks can still be inferred from occluded faces when video communication between two or more users happens through HMDs, it can allow for broader applications. In order to infer facial landmarks from input images where a face is significantly occluded by an HMD, some devices, systems, and methods first generate face and headset 3D models (e.g., point clouds) offline, and these models can be loaded as runtime data ready for fast online landmark-inference.

### 3D Models (3D Point Cloud)

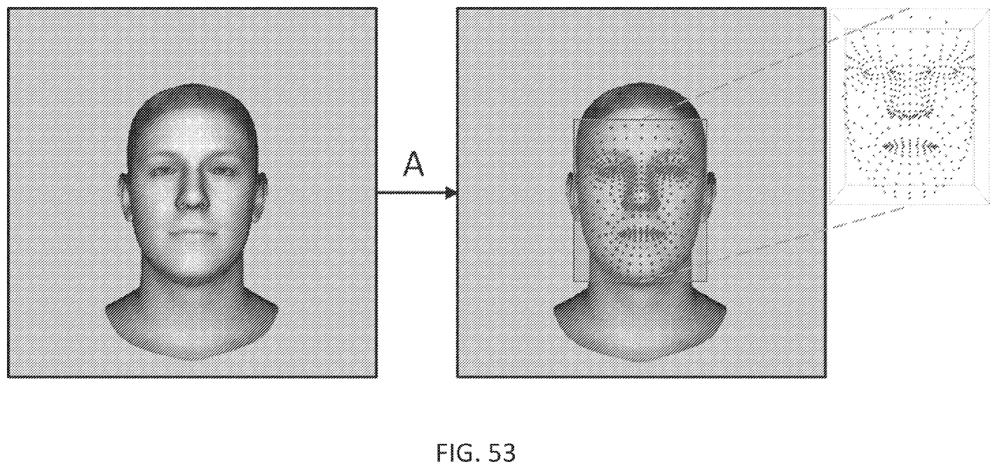

A 3D point cloud is a collection of data points analogous to the real-world object in three dimensions. Each point is defined by its own position and (sometimes) color. The points can then be rendered to create an accurate 3D model of the object. While LiDAR is a typical scanning technology to make point clouds, not all point clouds are created using LiDAR. For example, output landmarks (e.g., point clouds, key points) can be generated through landmark machine-learning models from one or multiple input images. An example of a face mesh solution is shown below in FIG. 53. In FIG. 53, (A) represents a landmark machine-learning model that can identify (e.g., infer) 468 three-dimensional (3D) facial landmarks. Then, for landmark inference (e.g., online landmark inference, real-time (or near-real-time) landmark inference), face and HMD 3D models are projected onto an image plane, and a bounding-box (bboxB), defined by a projected HMD's 2D point cloud, is obtained. The HMD bounding-box (bboxA) in an image is also detected through image segmentation. By aligning bboxB and bboxA, for example through an affine transform, face points can be transformed accordingly to denote landmarks in an image. Thus the correspondence between projected 2D points and detected 2D points in an image can be determined. This produces geometric references to transform face points that can be aligned with face features in an image. In addition to an HMD bounding-box, the correspondence also can be established using other markers, such as QR-code corners and HMD cameras.

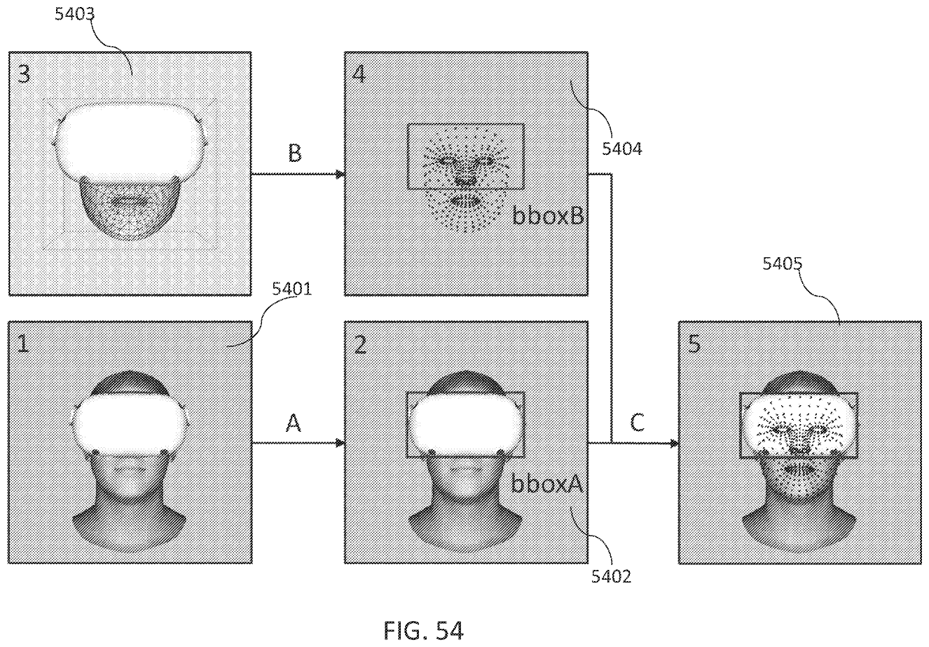

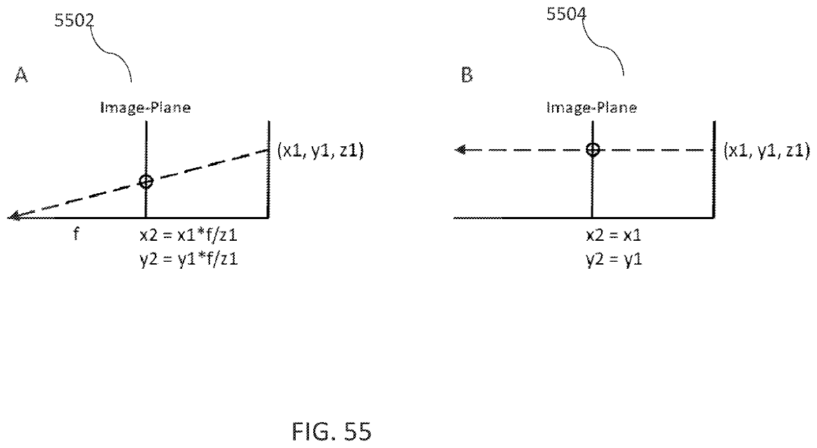

An exemplary algorithm for inferring landmarks will be described with reference to FIG. 54. Accordingly, the online landmark-inference process includes the following four stages. In a first stage, the bounding-box of the head-mounted-device (HMD) in the image (bboxA) is obtained. This is a base computer-vision task and can be achieved by image segmentation. Also, for example, a bounding-box may be specified by the top-left corner [Xₘᵢₙ, Yₘᵢₙ] and the bottom-right corner [Xₘₐₓ, Y max]. This is shown in 5401 and 5403 in FIG. 54. In a second stage, the orientation of the occluded face or head is obtained according to data output by the Inertial Measurement Unit (IMU) of the HMD which may be provided as part of an image (e.g., frame) annotation (e.g., in metadata). The IMU of the HMD may provide position and orientation measurements [X, Y, Z, Yaw, Pitch, Roll]. In a third stage, a 2D point cloud [Xᵢ, Yᵢ] projected from a 3D point cloud [Xᵢ, Yᵢ, Zᵢ] of face and HMD 3D models onto an image plane is obtained. This can be achieved through a projection transform to obtain a bounding-box defined by the HMD's 2D point cloud (bboxB) in 5403 and 5404, which can be approximated by Xₘᵢₙ=min(Xᵢ), Xₘₐₓ=max(Xᵢ), Yₘᵢₙ=min(Yᵢ), Yₘₐₓ=max(Yᵢ). A projection transform of a virtual camera can be modeled as a perspective transform or as an orthographic transform. The point cloud described herein represent a face that is wearing an HMD where one point cloud labeled as face and the other point cloud is labeled as HMD. A perspective projection or perspective transform is a linear projection where 3D objects are projected onto an image plane. One effect is that distant objects appear smaller than nearer objects. Photographic lenses and human eyes work in the same way, therefore perspective projection may look more realistic to a viewer. If 3D objects are put at a position farther away from the image plane, perspective projection can be approximated as a weak perspective projection, which basically is an orthographic projection with a scaling factor. Schematics of a perspective transform and an orthographic transform are shown below in FIG. 55 which illustrates a perspective projection 5502, where f is the focal length (the axial distance from the camera center to the image plane) and 5504 which illustrates an orthographic projection.

In stage 4, as shown in 5405, bboxB and bboxA are aligned, which can be achieved by an affine transform which includes scaling and translation of bboxB to fit bboxA. The affine transform then can be applied to a face's point cloud to infer landmarks in an image of the face. As shown in FIG. 54, landmark inference prior to correction processing is illustrated where the processing performed between 5403 and 5404 represents a projection onto an image plane through a projection transform and the processing performed between 5401 and 5402 represents a determination of a bounding-box through image segmentation and the processing performed using 5404 and 5402 represents the alignment between bboxB and bboxA through an affine transform to generate 5405.

Landmark Correction with Inpainting

If facial landmarks obtained above are not sufficiently accurate (for example, lower-face landmarks do not align well with lower-face features in the image performed after inpainting using a trained model to detect lower face landmarks which can serve as ground truth to compute discrepancy), correction processing is performed to update and improve the landmarks. Previously, the bounding-box corners were used as reference points. In this embodiment, detected lower-face landmarks are used as reference points. Instead of the HMD, the lower face is real and direct target (ground truth) we aim to align with. An offline procedure may collect a set of pre-captured images of a user that clearly show the user's face, and the pre-captured images can be annotated with landmarks and orientations. At first, the upper face may be inpainted with the upper face from a pre-captured image. Then a machine-learning model (e.g., a mediapipe face mesh solution) can be invoked to detect facial landmarks that can align well with lower-face features. In summary, the upper face is inpainted with the upper face from a pre-captured image, and a landmark machine-learning model is invoked to detect facial landmarks, so that detected lower-face landmarks can align well with lower-face features in the image. Then landmarks are updated and improved by re-alignment using the detected lower-face landmarks as new geometric references. In addition to using a pre-captured image, inpainting of the upper face can also use a rendered image (e.g., an image obtained by rendering a 3D face model). Here, reference points are needed to derive affine transform. Previously, bounding-box corners as were used reference points. In this embodiment, detected lower-face landmarks are used as reference points. Then, new affine transforms can be applied to face landmarks (previous face model or pre-captured landmarks) for better alignment with face.

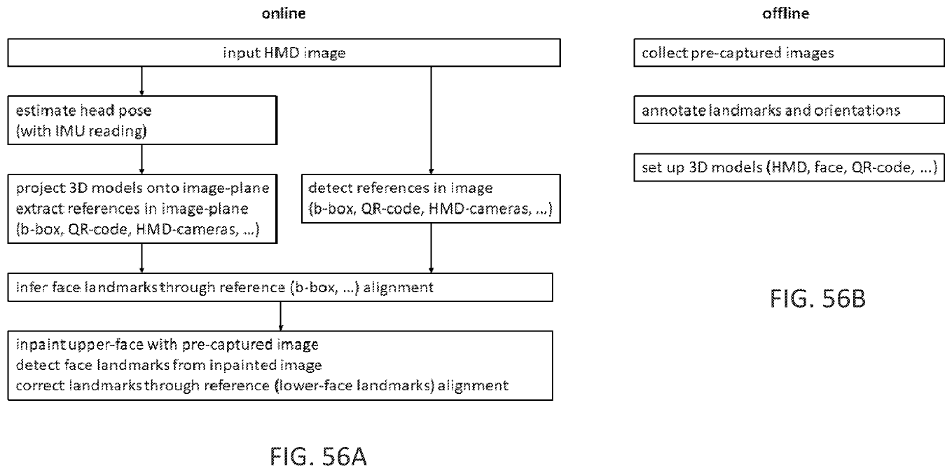

An example embodiment of a landmark-inference process is shown below in FIGS. 56A and 56B. This flow diagram reiterates the above described steps and identifies the timing at which they are preformed.

Accordingly, some embodiments allow for broader applications by enabling landmark inference even when a target (e.g., a face) is significantly occluded in an image. And some embodiments allow real-time frame processing because they perform time-consuming requirements or time-consuming operations offline, such as constructing 3D models such that they are ready to be loaded as runtime-data for online landmark inference.

Thus, some embodiments infer landmarks from an image in which a target (e.g., a face) is significantly occluded, for example by equipment (e.g., an HMD), infer landmarks by projecting a prebuilt 3D model onto an image plane (which allows them to not invoke a landmark machine-learning model for every frame), and infer landmarks for real-time frame processing.

### Section 10: HMD Landmark Detection Processing Using a CNN

Detection of key landmarks in images of people and other objects is a relatively common task in computer vision, but most machine-learning models are trained with images of people showing their unoccluded face. Because of this, pre-trained machine-learning models tend to perform poorly on images of people wearing head-mounted devices (HMDs), which occlude the top part of their face. Furthermore, existing machine-learning models that can be trained to detect general landmarks may not give satisfactory results when trained on a dataset with labeled HMD landmarks. If machine-learning models that track landmarks on the HMD itself were available, these machine-learning models could be combined with, or used to infer, results from other landmark-detection machine-learning models. Some HMDs have a distinctly colored body (e.g., a white body) and multiple cameras (e.g., four cameras) on the front face. The cameras can serve as good landmarks to detect, track, and find the orientation of the HMD in an image or sequence of images, such as a video.

To detect these camera landmarks, some embodiments of a machine-learning model (e.g., a convolutional neural network (CNN)) accept as inputs an RGB image (as an example, a size of the image is 224×224 in the following description, although some embodiments have other sizes). The machine-learning architecture may have some similarities to U-Net, a CNN that attempts to perform image-to-image operations, such as segmentation, via a “classical” convolutional backbone, augmented with shorter convolutional branches that retain spatial information at various scales from the input image.

For example, for embodiments of the HMD that have four cameras, some embodiments of CNNs have a similar architecture that has two convolutional branches retaining full-resolution spatial information from the input image. These two branches are then concatenated with the main feature-extracting backbone before a final convolution and sigmoid activation is applied to the output, resulting in a four-channel heatmap of the same size as the input image with values in [0,1]. Each of the four channels contains a heatmap corresponding to the location of one of the four HMD cameras. Also, the number of channels may equal the number of cameras on the HMD (e.g., two, three, four, five, six). Thus, if the HMD has two cameras, the number of channels may be two.

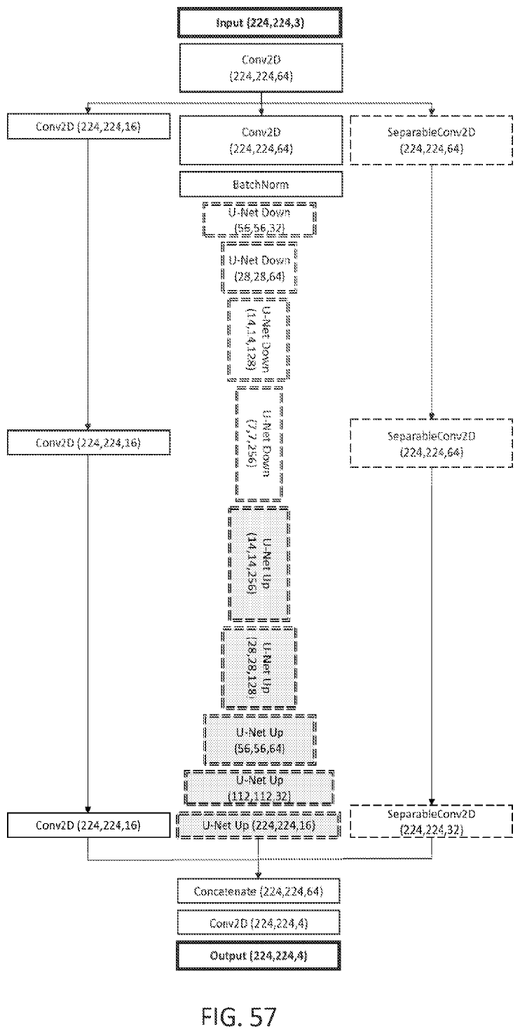

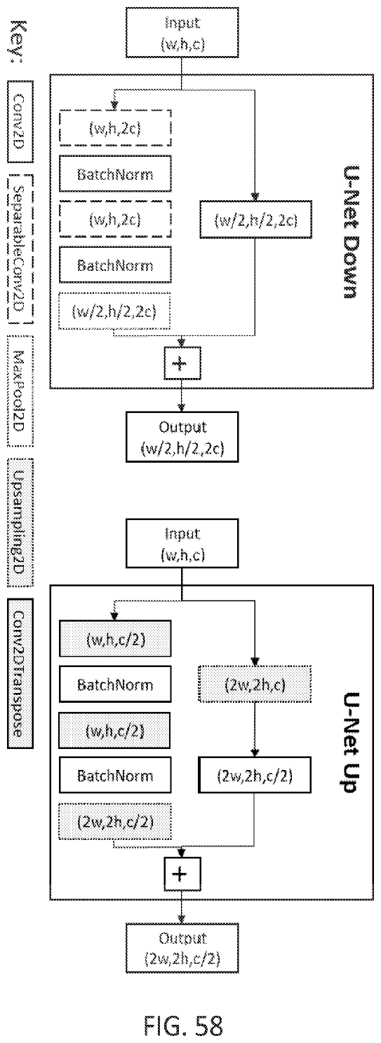

A diagram of an exemplary CNN architecture is shown in FIGS. 57 and 58 FIG. 37 shows an overview of the entire CNN, while FIG. 38 depicts a detailed view of the two main components of the backbone. The output dimensions of each layer or unit are shown in parentheses. Arrows indicate the path of the input image through the network, indicating branching and recombination where necessary. The embodiments depicted in FIGS. 57 and 58 contains a total of 2,146,340 parameters, and 2,142,404 of the parameters are trainable. Other embodiments may contain more or fewer parameters, depending on the “length” of the backbone, the number of convolutions in each secondary branch, the number of convolutions within each unit (e.g., U-Net unit) of the backbone, or similar modifications.

### Training Set Preparation and Image Preprocessing

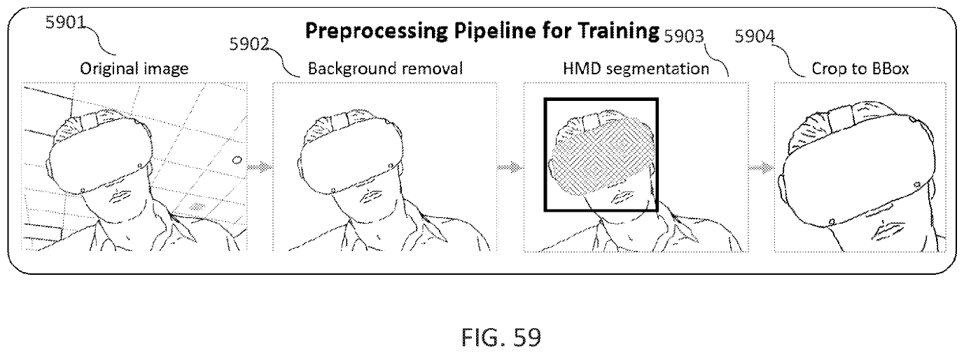

To train the CNNs, some embodiments use a collection of images of various people wearing HMDs. This is illustrated in FIG. 59 which shows that an input image 5901 is preprocessed, for example by first removing the background 5902 with a segmentation machine-learning model (e.g., neural network), then using a different segmentation machine-learning model (e.g., neural network) to segment the HMD region and specify (e.g., identify, find) a bounding box 5903. A square region that includes the bounding box is selected and the image in the bounding box is scaled in 5904 to the 224×224 size required for the example CNN's input (the scaling may be different for other embodiments of the CNN according to the other embodiments' respective input sizes). To form the target output for each image, the location (e.g., (x,y) coordinates) of each of the four HMD cameras is labeled by hand in each image. The labels distinguish between the top-left, top-right, bottom-left, and bottom-right cameras. If a camera is not visible in an image, estimated locations of the camera may be used. In this way, the CNN may learn to incorporate the spatial relationships among visible landmarks to accurately predict the locations of occluded landmarks.

Then the determined locations (e.g., (x,y) coordinates) are converted into a four-channel image that is compatible with the output of the CNN. To do this in this example, an array, having a (224,224,4) dimensionality, of all zeros was created, then a 3×3 square of ones with the (x,y) coordinates of the top-left camera at its center was generated in the first channel of the output. This was repeated for the top-right (channel 2), bottom-left (channel 3), and bottom-right (channel 4) cameras. It should be noted that the four-channel image should, in general, have as many channels as cameras/features on the HMD that are being detected. Each channel corresponds to a camera/feature on the HMD and is populated as mentioned in the previous sentences. This four-channel image will serve as the target output for the input image. The network will accept a preprocessed 224×224 RGB image as input and produce the corresponding 224×224 four-channel image generated from the manually identified (x,y) coordinates of the cameras as output.

### Training Loop

Training of the CNN can be performed using each of the preprocessed images (e.g. the input RGB image cropped to the bounding box of the HMD as described in FIG. 59 above), with random augmentations such as translations, scaling, and rotation applied to both the input images and the target heatmaps. The training may use a modified binary cross entropy loss function that is applied pixel by pixel and that uses constant multipliers (α, β) to emphasize correcting false negatives more than false positives. These may be used because the output may be heavily imbalanced toward zero output, which would incentivize simply outputting zero everywhere. The training may further add a term with weight γ that penalizes positive outputs in multiple channels for the same pixel to encourage the CNN to distinguish between each camera landmark rather than learning to output 1 in all channels for each landmark. Some embodiments of the loss function can be described by Equation 9:

$$L ( y , \hat{y} ) = \frac{1}{4 \cdot {224}^{2}} {\sum }_{ρ} [ - {\sum }_{c} α {y}_{p , c} ln ( ) + β ( 1 - {y}_{p , c} ) ln ( 1 - ) + γ {\sum }_{c} ] , \qquad ( 9 )$$

where [symbol] is the predicted value of channel c for pixel p, and where y_{p,c} is the target value. The 4 and 224 in this function are specific to the 4-camera network in the example, which accepts images of size 224×224, but each term here is described above. The alpha term penalizes false negatives, the beta term penalizes false positives, and the gamma term penalizes positive outputs in multiple channels.

The weights of these three terms were modified in stages, first weighting false positives and false negatives at parity (α=β), then increasing the weight of the false negative term (α>β), before in the final stage increasing the weight γ of the multiple channel penalty. For this embodiment of the training and the CNN, each stage required approximately 50 epochs.

### Post-Processing the Heatmap Output

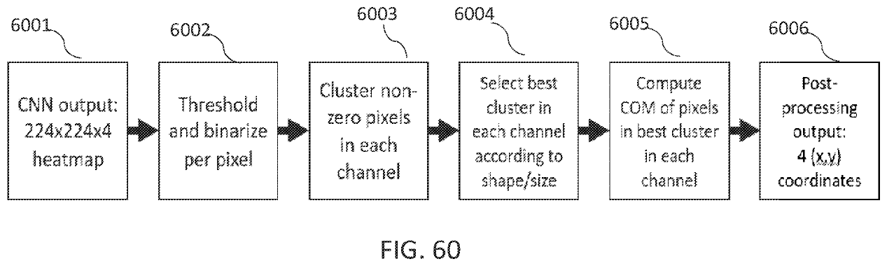

After training and evaluation, the output of the CNN is still four separate heatmaps instead of the set of four (x,y) coordinates for each individual landmark. To obtain the coordinates, some embodiments perform, in FIG. 60, the following post-processing operations shown on the output heatmap 6001 including threshold processing and binarization of the output 6002, clustering the resulting non-zero pixel locations in each channel 6003, computing the condition number of the 2×2 covariance matrices for each cluster 6004, as well as the total number of pixels in each cluster, selecting 6004 the best cluster according to the shape (1/condition number) and size (number of pixels) in a 70-30 proportion and determine (x,y) coordinates 6005 using the center of mass (COM) of pixels in best cluster in 6006.

The machine-learning model (CNN) can reliably detect all the cameras on an HMD, even when the cameras are occluded. Furthermore, the machine-learning model can be easily trained on any other dataset to detect different landmarks. The staged modification of loss function parameters allows the network to learn in stages, refining its knowledge with each stage rather than attempting to learn everything in one stage. The addition of the clustering and covariance stages of the post-processing further allows for more robust detection and rejection of false positive results.

Thus, some embodiments include a machine-learning model (e.g., a CNN) for landmark detection, modify loss function parameters in stages, and generate a post-processing heatmap output with clustering and covariance matrices.

Section 11: Scale and Shift Adjustment on Embedding 2D Image into 3D Virtual Reality

Turning back to the real-time HMD removal processing, after all the extraction and replacement is performed, a live output image including the replaced portions are provided and are displayed to other users in the VR environment. An issue associated with generating the live output image is related to the process of inserting a 2D image into a 3D environment. More specifically, an algorithm that corrects for shift and scale issues when inserting a 2D image into a 3D image is needed.

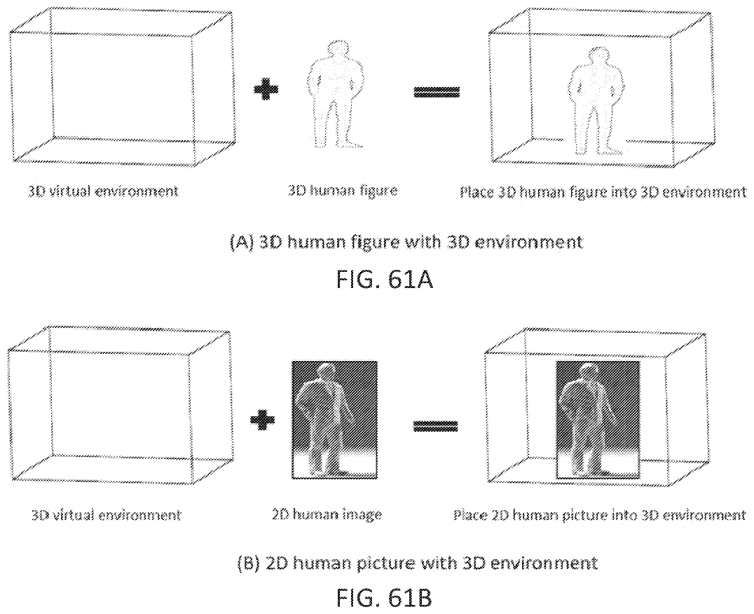

The problem resolved by the present algorithm is understood when looking at FIGS. 61A and 61B which illustrate different ways to create a perception of 3D content. FIG. 61A, illustrates that, in a 3D virtual environment, the 3D effect of a human being can be perceived if this human figure is created in 3D or is created with the depth information. However, as shown in FIG. 61B, the 3D effect of a human figure is also perceptible even if we don't have the depth information. In FIG. 61B. a 2D image of a human is placed into a 3D virtual environment. Although we don't have the 3D depth information, the resulting 2D image is perceived as a 3D figure by automatically filling the depth information. This is similar to the “filling-in” phenomenon for blind spots in human vision.

FIG. 42 illustrates the difference of 2D projections from different camera models between our human figure capturing and 3D virtual environment which causes the problem resolved by the presently disclosed algorithm. Here, the 2D projection of a 3D object is illustrated using a pin-hole camera model. The pin-hole camera model uses triangles to simplify the mathematical relationship between the coordinates of a point in three-dimensional physical world and its projection onto the image plane.

Although placing a 2D human image into a 3D virtual environment could result in humans perceiving this in 3D, doing so requires one or more adjustments be made for successful, natural insertion into the 3D virtual environment. One reason for the need to perform adjustment processing results from the fact that the camera models from our real-life human figure capturing and 3D virtual environment are different. A 2D image could be considered as a projection of a 3D object within a physical camera model. Here, the camera model refers to those factors influencing the projection of a 3D object, including focal length, angle of view, image size, resolution, etc. For the same 3D object, different camera models will give different 2D projected images. On the contrary, the same 2D images might also give different perceptions of possible 3D objects for humans if the assuming camera models are different.

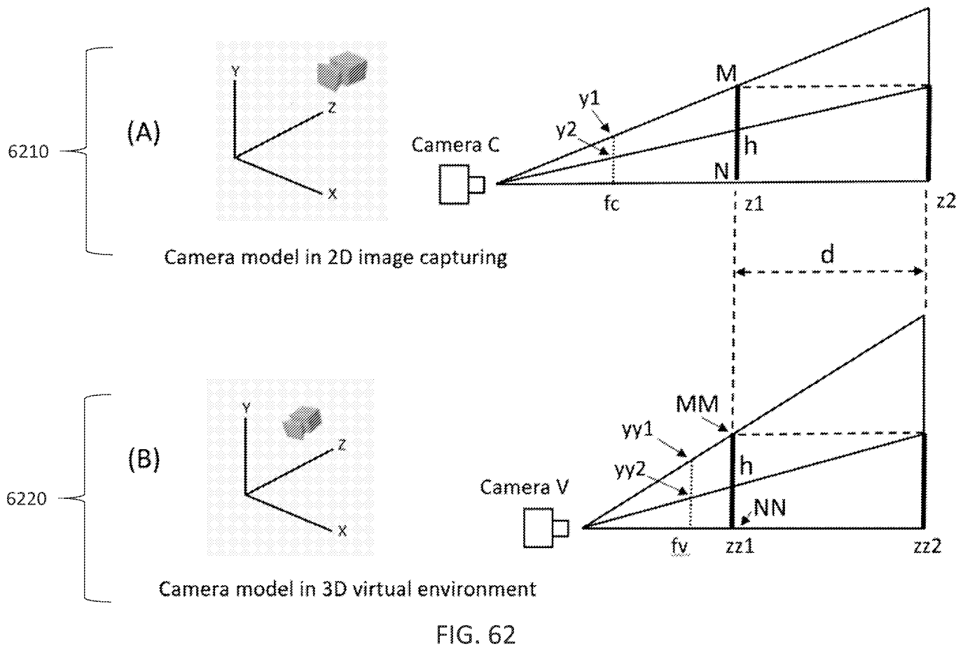

The challenges are illustrated in FIG. 62 which illustrates two different models of camera each with their own specifications used for two specific environments. A first camera system depicted as 6210 in row (A) is from the 2D image capturing environment where a real person is moving in a real 3D world and identified as Camera C as shown in FIG. 62. A second camera system 6220 is from the 3D virtual environment being displayed on a display of the HMD where the user is assumed to move in this 3D virtual world as shown in FIG. 62 labeled Camera V. When these models are different, there is a difficult in compensating for these differences as illustrated below.

In a case where a person with a height of h is moving at a distance of d, this can be modeled as a person shown as the solid line of M-N is moving from z1 to z2 for Camera C in 6210 or the solid line of MM-NN is moving from zz1 to zz2 for Camera V in 6220. Note that since both models represent the same person's moving in 3D space, the distance between z1 and z2 and the distance between zz1 and zz2 are the same, and the length of M-N and the length of MM-NN are also the same. Where the focal length of Camera C in 6210 is fc and the focal length of Camera V in 6220 is fv, the 2D projection from the same person, or the 2D images rendered or captured in these two models could be demonstrated by the moving from y1 to y2 for Camera C and the moving from yy1 to yy2 for Camera V. Since fc is different from fv, the scale change for the 2D image capturing environment is different from the scale change for the 3D virtual environment rendering. In other words, the ratio of y1 to y2 is different from the ratio of yy1 to yy2. Moreover, the difference is not just related to the change in scale but also on the position, or the shift from the optical axis. Therefore, 2D images captured in Camera C environment 6210 cannot be directly placed into the Camera V environment 6220 because the human mind will not correctly perceive a 3D effect from the 2D image if that image was not corrected.

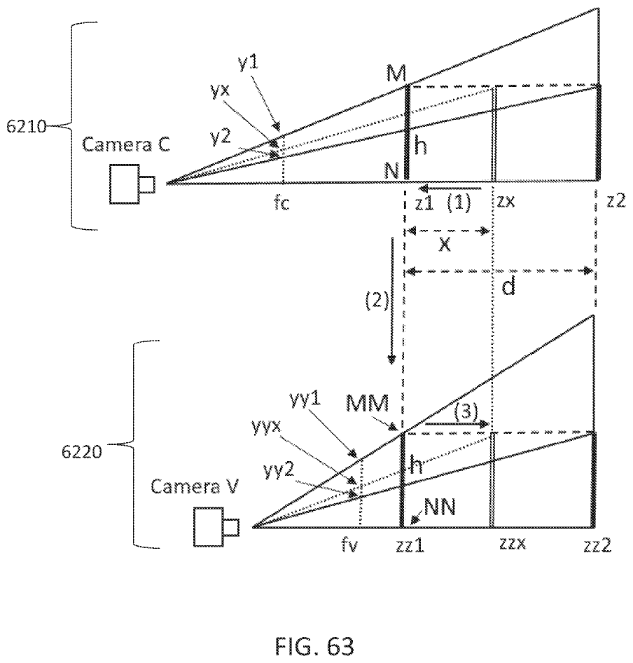

The processing performed to correct for this shift in scale and position will be described with respect to FIG. 63 which adjusts a 2D image captured from a user camera to allow a natural perception of reasonable scale and shift in the camera system of virtual environment. FIG. 63 illustrates a correction algorithm for correcting the incorrect/inconsistent perception between the 3D human and the 3D virtual environment resulting from merely placing a 2D human image from camera system into another camera system. The correction algorithm provides a solution that advantageously recovers the expected change of 2D image in the virtual camera system based on the recorded change of the 2D image in camera used to capture the live view of the user in real space. This is particular useful in the real time HMD replacement algorithm described herein which needs to ensure proper scale of the live captured image when considering and performing HMD replacement particular precaptured images.

Referring back to FIG. 63, there are two camera systems one for real space 6210 and the other for virtual space 6220. When a person M-N moves from z1 to z2, a change of the 2D image in the imaging plane from y1 to y2 in the imaging focal plane fc is recorded. To allow a user to be able to perceive the same movement of the person from zz1 to zz2 in virtual camera, the images delivered or rendered need to change from yy1 to yy2. For any position yx between y1 and y2 due to the movement to zx, the adjusted image in the imaging plane in the virtual camera would shift from yy1 to yyx to allow a consistent perception of movement from zz1 to zzx in virtual 3D reality.

The correction algorithm includes eliminating any scale and shift changes in 2D image due to the movement of the person, shown as (1) in FIG. 63 and manually align the 2D image information of y1 in unit of pixels to the 2D image plane information of yy1 in unit of meter or other physical unit in the 3D virtual world and adjust the scale and shift from yy1 to yyx using the pin-hole virtual camera model V. The second step needs to be performed only one time for the whole process since the purpose of this step is just to relate the same person between image coordinate and physical world, and once the starting positions z1 and zz1 in two camera systems are selected, this relation remains unchanged. The transfer function we derived in this step is implemented as a global parameter for any incoming scale and shift adjustment. In one embodiment, the scale and shift adjustments may be automatically executed in 3D virtual space if the moving distance x in the physical real 3D space is known.

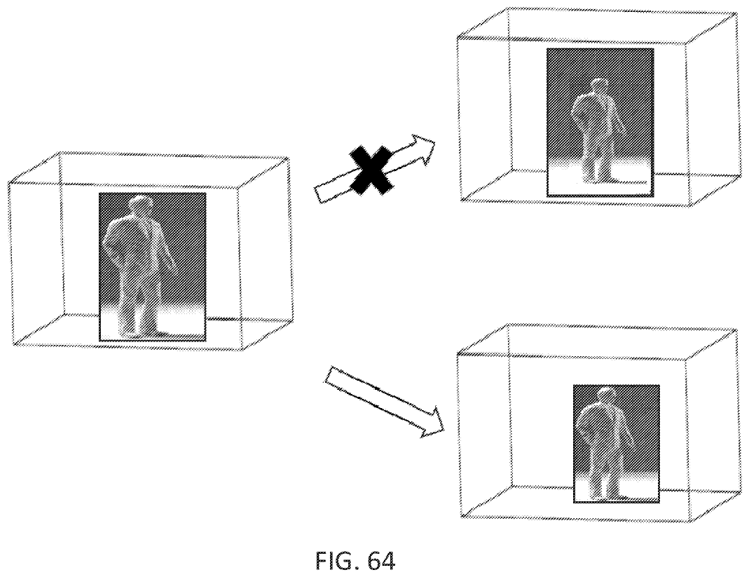

In one instance a virtual imaging plane MM-NN is placed in 3D virtual space. It is a physical plane in virtual world and initially positioned at the position zz1. This ensures that the physical unit of this virtual plane matches the physical unit of the image information. For example, if a person has a height of 2 meters in real 3D world and 100 pixel in 2D image captured in z1, an imaging plane showing a 2D person at height of 2 meter at zz1 is created. Then when the person moves z1 to zx, the image plane is moved from zz1 to zzx. This is illustrated in FIG. 64.

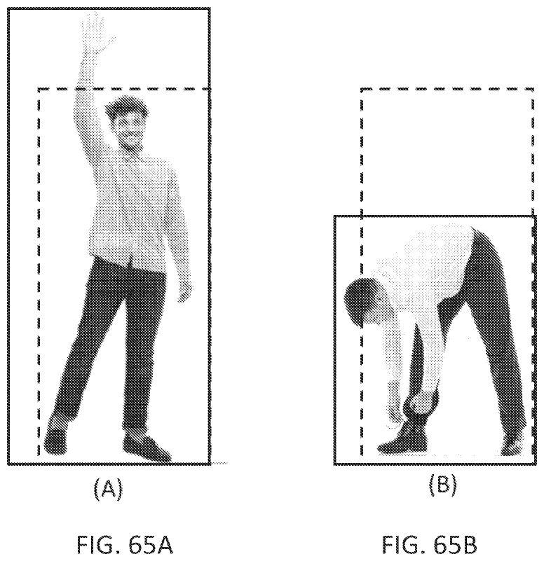

With the above said, the only step remaining is to remove scale and shift changes to reset back from yx to y1 when the user has moved to the position of zx. This is shown in FIGS. 65A & 65B which illustrates that rescaling directly on the human figures is not ideal. The scale and shift adjustment should not directly be applied to the height or width of human. One example is shown in FIGS. 65A & 65B which illustrates two cases where the height and width of a person will change when the person is conducting some movements, such as raising hand shown in FIG. 65A or bending the body shown in FIG. 65B. Thus directly using the height or width of a human being will not be an acceptable manner for rescaling an image.

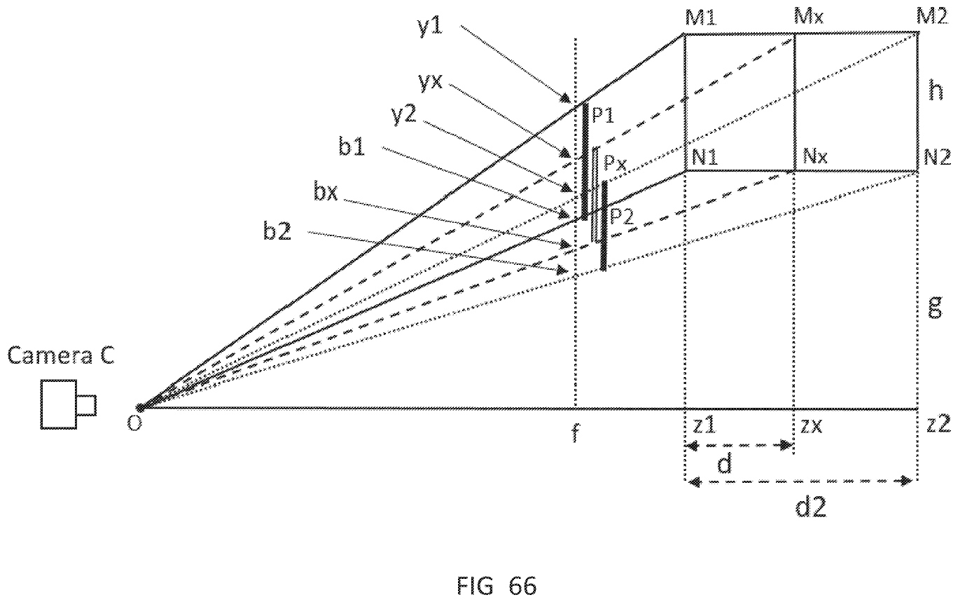

FIG. 66 illustrates a pinhole camera used to rescale and shift user height and width and illustrates readjustment of images to compensate for human movement being captured in real time. FIG. 66 includes a ground floor into the camera model to further adjust the scale and shift of the image. The height of the person is shown as h and the distance between the floor and optic axis is g. Note that g could be negative here depending on how image coordinates are defined. Given the pin-hole camera model with a focal length of f, then P1, Px and P2 are the 2D projections of a human figure with the height of h at the positions of z1, zx and z2, and the two ends of P1, Px and p2 are y1 &b1, yx &bx, and y2 & b2. From this, the equations below can be derived with reference to FIG. 66.

To obtain the relationship between the human figure position in real world and its 2D projection in focal plane, the relationship between the triangle M1-z1-O and the triangle y1-f-O is used according to Equation 10

$$y 1 / f = ( g + h ) / z 1 \qquad ( 10 )$$

Similarly, according to Equation 11, the triangle Mx-zx-O and the triangle yx-f-O are used to recalculate the relationship between 3D human figure and its 2D projection when the person moves from the position z1 to the position zx,

$$yx / f = ( g + h ) / zx = ( g + h ) / ( z 1 + d ) \qquad ( 11 )$$

By dividing equation (11) by equation (10), we get the ratio of y1 to yx is

$$y 1 / yx = ( z 1 + d ) / z 1 = s \qquad ( 12 )$$

This ratio here is the scale change of one of the two ends of 2D projection the human figure. Similarly, we can get the scale change of the other end of the 2D projection from equations (13), (14) and (14).

$$b 1 / f = g / z 1 \qquad ( 13 )$$

$$bx / f = g / zx = g / ( z 1 + d ) \qquad ( 14 )$$

$$b 1 / bx = ( z 1 + d ) / z 1 = s \qquad ( 15 )$$

The length of the 2D projection of the human figure in the focal plane in two positions of z1 and zx are (y1−b1) and (yx−bx). Thus, scale change of the length of human figure in focal plane can be determined by equation (16)

$$( y 1 - b 1 ) / ( yx - b x ) = ( s * y x - s * bx ) / ( yx - b x ) = s \qquad ( 16 )$$

And the scale adjustment is

$$s = ( z 1 + d ) / z \qquad ( 17 )$$

Knowing that the scale change of human figure, shown in equation (17), is the same as the scale change of image, shown in equation (12) and (15), the image is caused to be scaled and the human figure should also be scaled accordingly. Secondly, it shows that to scale the human figure, if we know the starting position z1 and the moving distance of a person moves in real world, we can simply multiple a scale factor with (z1+d)/z1 to the image to determine how the image should look like if the person does not move.

Turning back to FIG. 66, often times, the value of d is obtained from the IMU sensor of a HMD device. For example, the moving distance in x, y and z directions in 3D real world is obtained using the IMU sensor of the head mount display device. Additionally, an estimation of z1 is performed in advance of this algorithm being executed by reshaping Equation (12) as follows

$$z 1 = d * bx / ( b 1 - b x ) \qquad ( 18 )$$

Here, z1 is the position of human figure selected in physical world to align its 2D projection in focal plane with the 3D virtual world, d is the moving distance of the human figure from z1 to zx, and finally b1 and bx are the 2D projection of foot plane estimation at the positions of z1 an zx. Given the z1 and the readout of d from IMU, the scale factors is obtained. Similarly, the shift of image is estimated based on the same pin-hole camera described in FIG. 66. When the person moves from z1 to zx, the projected human figure is also changed from P1 to Px. Apparently, the changes from P1 to Px contain not just the scale but also a position shift. The shift is estimated by subtracting the bx from b1,

Mathematically, the shift is obtained by subtracting equation (14) from equation (13) on both left and right end, shown in equation (19).

$$shift = b 1 - b x = f * g / z 1 - f * g / ( z 1 + d ) = f * g * ( 1 / z 1 - 1 / ( z 1 + d ) ) = f * g * d / ( z 1 * ( z 1 + d ) ) \qquad ( 19 )$$

After obtaining values for f, g and z1, the shift value is estimated based on the movement of d. A value for z1 is estimated based on equation (18) but both f and g need not be separately estimated, but only the value f*g, which is derived from equation (13). By reorganizing the equation (13), we have

$$f * g = b 1 * z 1 \qquad ( 20 )$$

where z1 is the position of human figure selected in physical world to align its 2D projection in focal plane with the 3D virtual world, and b1 is the 2D projection of foot plane estimation at the positions of z1.

Inserting equation (20) into equation (19), yields equation (21)

$$shift = b 1 * z 1 * d / ( z 1 * ( z 1 + d ) ) \qquad ( 21 )$$

Since we are able to estimate b1 and z1, we can then calculate the shift based on just the movement of d. Upon calculating the shift value to be applied in scaling the live captured images from the first camera system to the second camera system, real-time life HMD removal processing can be performed thereby allowing users to see one another in the VR environment without an HMD despite that the images used to generate those images are captured wearing the HMD and are captured in a camera system different from the camera system of the VR device in which they are viewing the images.

### Section 12: Network Based Alpha Channel Transmission to Enable HMD Removal Processing

There are various application programmer interfaces (APIs) used to transmit media data between applications over an internet connection. However, some APIs are limited in that only the red, green and blue (RGB) color channels can be transmitted over the network. In order to utilize full or partial transparency within a video an alpha channel is needed.

Consider a rasterized video frame that is h units tall and w units wide with four dimensions (r,g,b a). Each of these dimensions represents is a value between 0-255 that represents the color value for the r,g,b dimensions and the transparency for the a dimension, herby referred to as alpha value. In this scenario, there are two devices on the network: the source, which produces the video frames and does the majority of the visual processing and the receiver device, which receives the video frames and does relatively little visual processing. The API in this scenario is limited to RGB, so a method of transmitting transparency data across the network is desirable to enable the above described processing.

### Chroma Key Method

A first method of transmitting transparency data across a network is using a chroma key transfer method. A way of transmitting transparency data within a RGB image is to encode the transparency data within the RGB color space itself. The receiving device on the network renders pixels with that color encoding as transparent. On a source image frame, all pixel values are designated with an alpha value below a certain threshold to be transparent and pixels with alpha values above the threshold as foreground. These foreground pixels are scaled down by a percentage S∈[0,1]. The foreground pixel scaling ensures that the transparent color space and the foreground color space does not overlap. Foreground pixel values are now clamped between [0,S×255]. The transparent pixel RGB values are now set at 255 for r,g,b pixel values. The alpha channel is then discarded and the RGB frame is sent over the network. On the receiving device, the pixel RGB values are examined individually. When they are within the foreground pixel range [0,S×255] they are rescaled by dividing them by the scale factor S and rendering them as is. If the RGB pixel values are all between [(1−S)×255,255] then they are rendered as transparent. The reason for this range rather than 255 directly is that lossy compression methods (RGB->YCrCb->RGB) when the frame sent over network can change the pixel values slightly.

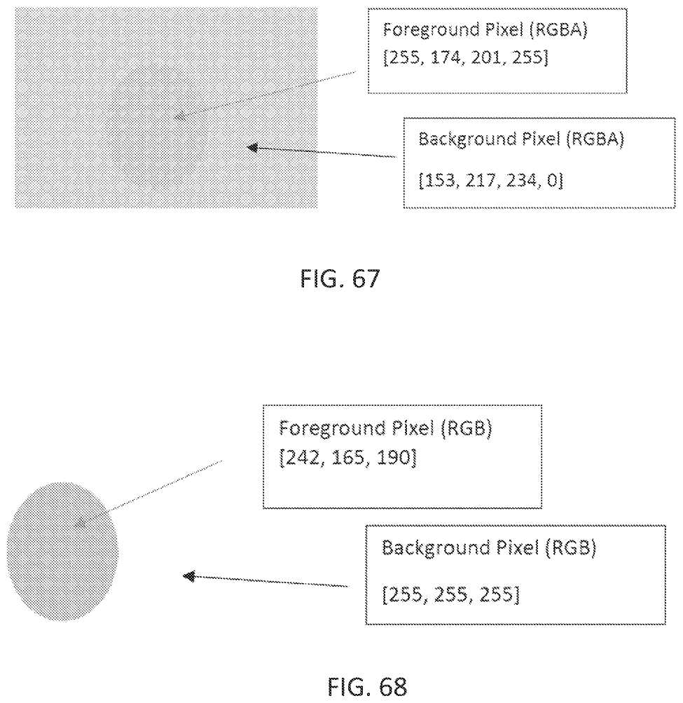

In this example foreground pixel scaling is selected as S=0.95. Therefore, the RGB range of foreground pixel value is [0,242] and background pixel RGB values are all set to 255. An initial image frame prior to alpha color encoding is shown in FIG. 67 whereas FIG. 68 illustrates the frame after alpha color encoding. Once on the receiver device all pixels that are not 255 are divided by 0.95 to return them to their original colors and render the pixels whose RGB values are 255 and render them as transparent.

### Data Channel

Another method of enabling transparency over media networks without an alpha channel is to utilize another data channel. Some real time communication (RTC) protocols have data channels in addition to the media channels used for video and audio data. In our original frame, RGBA frame may be split into two tensors: the RGB tensor and the Alpha tensor. The RGB tensor contains original RGB data and can be sent across the network with no issues. The Alpha tensor is then sent across the data channel. However, there are some challenges with using the data channel which are remedied by the method described below.

As two data streams are being sent by a source device across the network, synchronizing the correct RGB tensor with its component alpha tensor becomes a challenge. The network is subject to latency which will change the timing of when each tensor arrives. The underlying network API can also buffer data packets together for optimal signaling. This buffering scheme can be different between the video channel and data channel, further disrupting the RGB tensor and alpha tensor timing. Another constraint of using a non-media channel is bandwidth. These data channels often have limited bandwidth compared to the media channels so the important to utilize effective so that the alpha tensor can be transmitted without issue. Consider a 1080p frame. An alpha tensor segmented from this frame is over 259 kilobytes in size. At a target frame rate of 30 per second the bandwidth requirements balloons to over 7 megabytes per second. These values can increase the larger the frame is and the faster the target frame rate. This is particularly problematic in the above described HMD removal processing that is time sensitive.

### Syncing

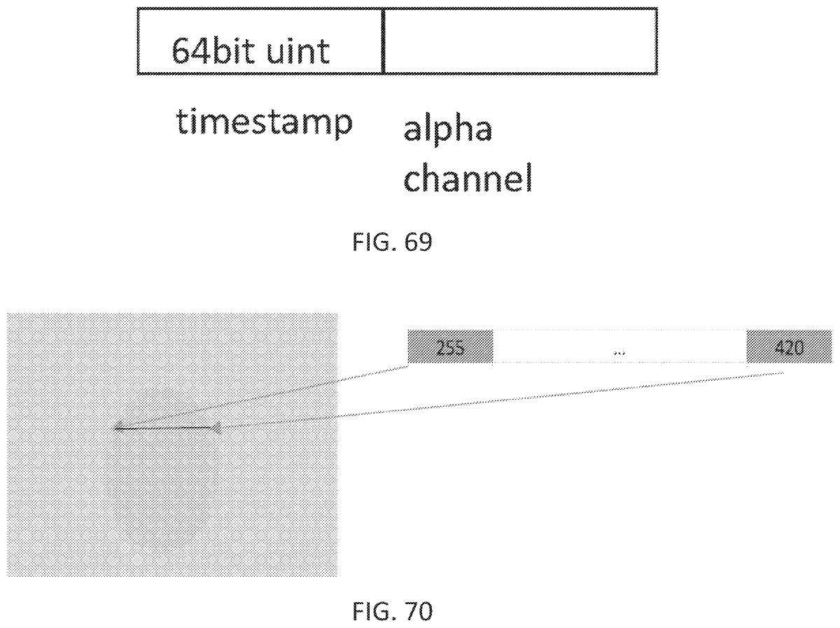

One method of synchronizing the RGB frame with its component alpha frame is to append a timestamp to the alpha layer. On the source device, once the RGBA frame is created, a timestamp value, in this case a 64 bit unsigned integer, is associated with the frame. Once the frame is split into its RGB and alpha tensors, the timestamp is attached to both tensors. As the RGB tensor is being sent over a video channel, the timestamp is already attached to the frame. For the alpha tensor, the data must be first serialized into a binary string and the timestamp value is also serialized into binary and appended on the alpha tensor binary string. This is shown in FIG. 69 which illustrates the serialization. On the receiver device, once the alpha tensor is received, it is caused to be stored it in a hash map type data structure with the timestamp as a key. Once the RGB frames are received, can match it with its component alpha tensor utilizing the timestamp thereby synchronizing the alpha tensor with its correct RGB frame.

The alpha tensor must be properly compressed due to bandwidth constraints. Two aspects about the alpha tensor will dictate the described compression method. The alpha tensor is generally sparse, which means most of the data is zero and the data is binary (true or false). Because this is binary data, the bytes of the alpha tensor are packed into single bits. This compresses the alpha tensor by a factor of eight. The sparsity of the data is also particularly advantageous. On the receiving device, when the RGB tensor is aligned with its component alpha tensor, their data values are scanned, pixel by pixel. However, a slight optimization can be performed by reading the first byte of the alpha tensor as 0, it is known that this first byte actually describes the transparency of the eight bytes of the RGB frame. Therefore, the algorithm moves ahead eight steps without performing any operations. As most of the alpha tensor is zero, this results in a significant increase in processing speed.

An additional method is to also store the indexes of when the alpha values change. Instead of storing the values of each individual pixel, the index of when the values change is stored instead. These index values are stored as 16 bit unsigned integers. We reserve the values 25535 as new lines. In this encoding scheme, we start with the first row of the RGB frame. The first value in the alpha tensor describes the first foreground pixel, the second value describes the start of the background pixels. A value of 25535 moves to the next row. With this compression method, the size of the alpha tensor will change which requires that this value be sent with the tensor. An illustration of when Index values of when the alpha tensor ends and starts is shown in FIG. 70

It should be noted that both alpha channel transmission methods are not mutually exclusive and can be utilized simultaneously, baring network bandwidth and computational constraints. In one embodiment, the data channel method of transmitting transparency data primarily used but other embodiments, encode transparency data within the color space of the RGB frame and utilize Chroma key method as a fallback in case of dropped alpha tensor frames.

The above described algorithms represent one or more embodiments of a head mount display removal processing. These embodiments may be individually performed and combined with one another. The described methods are understood to represent steps stored in a memory that, when executed by a processing device, configures the processing device to perform the described steps.

Some embodiments of a method comprise receiving first images of a user during a precapture process, receiving second images of a user, the second images of the user having a portion thereof blocked by a wearable device, determining orientation and position of the wearable device to identifying a location of the wearable device in the received second images; obtaining a three dimensional model of the user and the wearable device; performing region swapping on the second images by replacing the blocked portion of the user with corresponding regions obtained from the first images; and generating, for output to a display on the wearable device, third images comprised of the second images and the first images.

Some embodiments of a method comprise: obtaining an image of an object; detecting landmarks in the image; obtaining landmarks of a reference object; and aligning the landmarks in the image to the landmarks of the reference object. And some embodiment of the method further comprise generating features based on the aligned landmarks, and some embodiments further comprise inputting the features into a machine-learning model. And some embodiment further comprise generating the landmarks of the reference object based on a collection of images of the reference object.

Some embodiments of a method comprise: obtaining, from a sequence of images of a face, information representing positions of an upper eye and lower eye lid; obtaining, from the sequence of images of the face, information representing a position of an upper face and a lower face to determine a height of the face; determining an occurrence of a blink by a user in the sequence of images based on a relative positions of the upper eyelid and lower eye relative to the height of the face; extracting, from the sequence of images, first frames that include a blink and second frames that do not include a blink; and replacing, in a second sequence of images, regions of the face with first or second frames based on predetermined replacement rules.

Some embodiments of a method comprise: receiving position and orientation information from a wearable device being worn by a user having a first time signatures; capturing images of the user wearing the wearable device using an image capture device having a second time signature; determining an offset between the first and second time signature using the position and orientation information of the wearable device and orientation and position of the wearable device from the captured images; and using the determined offset as a reference time to sync the time signature between the image capture device and the wearable device.

Some embodiments of a method comprise: receiving a series of images of a user wearing a wearable device; determining a position of the wearable device based on position and orientation information obtained from one or more sensors of the wearable device and a location of the wearable device determined from the received series of images; and estimating a pose of the user in the received series of images based on the determined position.

Some embodiments of a method comprise: obtaining a source image; obtaining a target image; obtaining a reference image; converting the source image from a first color space to a second color space; converting the target image from the first color space to the second color space; converting the reference image from the first color space to the second color space; performing a color transfer on a region of the target image in the second color space based, at least in part, on the reference image in the second color space; and performing a color transfer on a region of the source image in the second color space based, at least in part, on the reference image in the second color space.

Some embodiments of a method comprise: obtaining a collection of training images that depict a head-mounted display, wherein the head-mounted display includes one or more cameras; inputting the training images into a machine-learning model that outputs respective locations of the one or more cameras; and modifying the machine-learning model based on the respective locations that were output by the machine-learning model and on labeled locations of the one or more cameras. In some embodiments of the method, the modifying is performed based on a loss function. Also, in some embodiments, the machine-learning model has at least one convolutional backbone and at least one convolutional branch that retains full-resolution spatial information from any input image. And some embodiments include preprocessing of the training images, wherein the preprocessing includes removing a background, identifying an image region that includes the head-mounted device, or generating a bounding box around the head-mounted device.

Some embodiments of a method comprise: obtaining a model of a face; obtaining a model of a head-mounted display; obtaining an image of a face that is wearing a head-mounted display; obtaining an orientation of the face in the image; generating a first bounding box of the face in the image; projecting the model of the face and the model of the head-mounted display onto an image plane; generating a second bounding box of the projected model of the head-mounted display; generating a transform based on the first bounding box and the second bounding; and inferring landmarks in the image of the face based on the transform. And some embodiment further comprise inpainting the head-mounted display in the image with a previously-captured image of the face; detecting landmarks in the inpainted face; and correcting the inferred landmarks based on the detected landmarks in the inpainted face.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

1-45. (canceled)

46. An apparatus comprising:
one or more memories storing instructions; and
one or more processors that, upon execution of the instructions, are configured to:
receive position and orientation information from a wearable device being worn by a user having a first time signatures;
capture images of the user wearing the wearable device using an image capture device having a second time signature;
determine an offset between the first and second time signature using the position and orientation information of the wearable device and orientation and position information extracted from the captured images; and
use the determined offset as a reference time to sync the timing between the image capture device and the wearable device.

47. The apparatus according to claim 46, wherein execution of the stored instructions further configures the one or more processors to
generate, for each of the captured images of the user wearing the wearable device, a bounding box surrounding the wearable device in the capture images;
obtain coordinates of the generated bounding box within the capture images; and
determine the offset using the received position and orientation information from the wearable device and the obtained coordinates of the bounding box in the capture images.

48. The apparatus according to claim 46, wherein execution of the stored instructions further configures the one or more processors to
determine the offset by performing a cross-correlation processing using the received orientation information of the wearable device and the position information of the wearable device within the captured images.

49. The apparatus according to claim 48, wherein the orientation information is first orientation information of the wearable device and the position of the wearable device within the captured image is based on a particular coordinate associated with a bounding box surrounding the wearable device in the captured images.

50. The apparatus according to claim 49, wherein first orientation information of the wearable device is a pitch value of the wearable device and the particular coordinate associated with the bounding box within the captured image is the Y-coordinate value.

51. The apparatus according to claim 49, wherein first orientation information of the wearable device is a yaw value of the wearable device and the particular coordinate associated with the bounding box within the captured image is the X-coordinate value.

52. The apparatus according to claim 46, wherein execution of the stored instructions further configures the one or more processors to
generate, over a predetermined number of captured image frames, a cross correlation coefficient between a signal representing the received position and orientation information from the wearable at the first time stamp and the captured images of the user wearing the wearable at the second time stamp; and
use the generated cross correlation coefficient as the offset value to sync the time stamps.

53. The apparatus according to claim 46, wherein execution of the stored instructions further configures the one or more processors to
shift frames of the captured images a predetermined number of frames forward or a predetermined number of frames backwards based on the determined offset.

54. The apparatus according to claim 46, wherein execution of the stored instructions further configures the one or more processors to
determine the offset by performing a mutual correlation processing using a plurality of received position and orientation information items of the wearable device and a plurality of position information items of the wearable device within the captured images.

55. The apparatus according to claim 54, wherein the plurality orientation information items include at least two or more of pitch value, yaw value, roll value, X-value, Y-value and Z-value received from the wearable device and the plurality of position items of the wearable device within the captured image is based on at least two coordinate values associated with a bounding box surrounding the wearable device in the captured images, and wherein execution of the stored instructions further configures the one or more processors to
generate a first data set including the plurality of received position and orientation data items having a single dimension;
generate a second data set including the at least two position items of the wearable device within the captured image having a single dimension;
determine a relative entropy between the first and second data sets and
obtain the offset values based on the highest determined relative entropy values.

56. A method comprising:
receiving position and orientation information from a wearable device being worn by a user having a first time signatures;
capturing images of the user wearing the wearable device using an image capture device having a second time signature;
determining an offset between the first and second time signature using the position and orientation information of the wearable device and orientation and position information extracted from the captured images; and
using the determined offset as a reference time to sync the timing between the image capture device and the wearable device.

57. The method according to claim 56, further comprising
generating, for each of the captured images of the user wearing the wearable device, a bounding box surrounding the wearable device in the capture images;
obtaining coordinates of the generated bounding box within the capture images; and
determining the offset using the received position and orientation information from the wearable device and the obtained coordinates of the bounding box in the capture images.

58. The method according to claim 56, wherein execution of the stored instructions further configures the one or more processors to determine the offset by performing a cross-correlation processing using the received orientation information of the wearable device and the position information of the wearable device within the captured images.

59. The method according to claim 56, wherein the orientation information is first orientation information of the wearable device and the position of the wearable device within the captured image is based on a particular coordinate associated with a bounding box surrounding the wearable device in the captured images.

60. The method according to claim 59, wherein first orientation information of the wearable device is a pitch value of the wearable device and the particular coordinate associated with the bounding box within the captured image is the Y-coordinate value.

61. The method according to claim 59, wherein first orientation information of the wearable device is a yaw value of the wearable device and the particular coordinate associated with the bounding box within the captured image is the X-coordinate value.

62. The method according to claim 56, further comprising
generating, over a predetermined number of captured image frames, a cross correlation coefficient between a signal representing the received position and orientation information from the wearable at the first time stamp and the captured images of the user wearing the wearable at the second time stamp; and
using the generated cross correlation coefficient as the offset value to sync the time stamps.

63. The method according to claim 56, further comprising
shifting frames of the captured images a predetermined number of frames forward or a predetermined number of frames backwards based on the determined offset.

64. The method according to claim 56, further comprising
determining the offset by performing a mutual correlation processing using a plurality of received position and orientation information items of the wearable device and a plurality of position information items of the wearable device within the captured images.

65. The method according to claim 64, wherein the plurality orientation information items include at least two or more of pitch value, yaw value, roll value, X-value, Y-value and Z-value received from the wearable device and the plurality of position items of the wearable device within the captured image is based on at least two coordinate values associated with a bounding box surrounding the wearable device in the captured images.

66. The method according to claim 65, further comprising
generating a first data set including the plurality of received position and orientation data items having a single dimension;
generating a second data set including the at least two position items of the wearable device within the captured image having a single dimension;
determining a relative entropy between the first and second data sets; and
obtain the offset values based on the highest determined relative entropy values.

67. A non-transitory computer readable storage medium that stores instructions which, when executed, configure an apparatus to perform the method according to any of claim 56.

68-121. (canceled)
